(19) United States
(12) Patent Application Publication
(10) Pub. No.: US 2023/0150756 A1
(43) Pub. Date: May 18, 2023

(54) Rapidly Cooling Food and Drinks

(71) Applicant: ColdSnap, Corp., Billerica, MA (US)

(72) Inventors: John Heymans, Hampstead, NH (US); Benjamin Fichera, Newburyport, MA (US); Nicholas Fonte, Sudbury, MA (US); Jonathan Watson, Hollis, NH (US); James Lynch, Georgetown, MA (US); Dong Hua, Newton, MA (US); Richard Bernard Streeter, Andover, MA (US); Samuel D. J. Brown, Somerville, MA (US); George Nieves, SR., Dunstable, MA (US); Kevin Stillerman, Medford, MA (US); Mehmet H. Duymazlar, Nashua, NH (US); Matthew Fonte, Billerica, MA (US)

(21) Appl. No.: 17/987,432

(22) Filed: Nov. 15, 2022

Related U.S. Application Data
(60) Provisional application No. 63/280,492, filed on Nov. 17, 2021.

(51) Int. Cl. B65D 85/804; A23G 9/12; A23G 9/22; A23G 9/28

(52) U.S. Cl. CPC B65D 85/8055; A23G 9/12; A23G 9/224; A23G 9/281; B65D 85/8052

(57) ABSTRACT

Systems and methods have demonstrated the capability of rapidly cooling the contents of pods containing the ingredients for food and drinks.

### RELATED APPLICATIONS

This patent application claims the benefit of priority under 35 USC § 119(e) to U.S. Patent Application Ser. No. 63/280,492, filed on Nov. 17, 2021, the entire contents of which are hereby incorporated by reference.

### TECHNICAL FIELD

This disclosure relates to systems and methods for rapidly cooling food and drinks.

### BACKGROUND

Beverage brewing system have been developed that rapidly prepare single servings of hot beverages. Some of these brewing systems rely on single use pods to which water is added before brewing occurs. The pods can be used to prepare hot coffees, teas, and cocoas.

Home use ice cream makers can be used to make larger batches (e.g., 1.5 quarts or more) of ice cream for personal consumption. These ice cream maker appliances typically prepare the mixture by employing a hand-crank method or by employing an electric motor that is used, in turn, to assist in churning the ingredients within the appliance. The resulting preparation is often chilled using a pre-cooled vessel that is inserted into the machine. Some electric ice cream machines take 20 to 60 minutes to make a batch of ice cream and require time consuming clean up.

### SUMMARY

This specification describes systems and methods for rapidly cooling food and drinks. Some of these systems and methods can cool food and drinks in a container inserted into a counter-top or installed machine from room temperature to freezing in less than two minutes. For example, the approach described in this specification has successfully demonstrated the ability make soft-serve ice cream from room-temperature pods in approximately 90 seconds. This approach has also been used to chill cocktails and other drinks including to produce frozen drinks. These systems and methods are based on a refrigeration cycle with low startup times and a pod-machine interface that is easy to use and provides extremely efficient heat transfer.

Some pods include a body having a sidewall that extends from a first end of the body to a second end of the body to define an interior of the pod. The pod includes ingredients disposed within the interior of the pod for producing a single serving of a cooled food or drink. The pod includes a mixing paddle or impeller disposed within the interior of the pod and rotatable relative to the body along a longitudinal axis of the body, a cross-section of the mixing paddle taken perpendicular to a longitudinal axis of the mixing paddle having at least one curved or non-linear section.

Some pods include one or more of the following features, and/or one or more of the features described elsewhere in this disclosure.

In some cases, the at least one curved or non-linear section defines a C-shape, an S-shape, a wavy-shape, an undulating-shape, or a non-linear shape.

In some cases, the at least one curved or non-linear section defines a scoop-shaped section for scooping the ingredients within the pod when the mixing paddle rotates relative to the body of the pod.

In some cases, the cross-section has a pair of concave features each spaced approximately equidistant from the longitudinal axis of the mixing paddle, the concave features being concave with respect to a rotational direction of the mixing paddle used to mix the ingredients disposed within the interior of the pod to produce the single serving of the cooled food or drink.

In some cases, the concave features span a majority of the cross-section of the mixing paddle. In some cases, the cross-section has two radial end portions that are curved in an opposite direction relative to the concave features. In some cases, the two radial end portions contact the sidewall of the body of the pod at one or more rotational positions of the mixing paddle within the pod. In some cases, the two radial end portions maintain contact with the sidewall of the body of the pod during a complete revolution of the mixing paddle about the longitudinal axis of the mixing paddle. In some cases, at least a portion of each of the two radial end portions is tangent to the inner surface of the sidewall of the pod at the one or more rotational positions of the mixing paddle within the pod.

In some cases, a radius of the concave features is between 0.6 and 1.2 inches. In some cases, a radius-to-thickness ratio defined by a radius of the concave features of the mixing paddle divided by a thickness the cross-section of the mixing paddle is between 1.0 and 10.0. In some cases, the radius-to-thickness ratio is between 3.0 and 6.0. In some cases, a thickness of the cross-section of the mixing paddle is between 0.10 and 0.30 inches.

In some cases, the at least one curved or non-linear section provides an increased bending, flexural, or torsional stiffness to the mixing paddle to resist deflection of the mixing paddle as the mixing paddle rotates within the pod.

In some cases, the mixing paddle is concentrically disposed within the interior of the pod such that the longitudinal axis of the body of the pod is coincident with the longitudinal axis of the mixing paddle.

In some cases, the mixing paddle has one or more windows passing through it.

In some cases, the mixing paddle is longitudinally helical along a longitudinal axis of the mixing paddle. In some cases, the helical mixing paddle has a constant helical pitch between 40 and 60 degrees/inch. In some cases, the helical mixing paddle has a constant helical pitch of 52 degrees/inch.

In some cases, the sidewall of the pod and the mixing paddle are formed of a metallic alloy.

In some cases, the mixing paddle is coated. In some cases, the coated mixing paddle is electrostatically coated.

In some cases, the sidewall of the pod is coated with a layer of coating and the mixing paddle contacts the layer of coating for one or more rotational positions of the mixing paddle within the pod. In some cases, the layer of coating is a layer of PET laminated coating.

Some devices located in a hermetically-sealed pod containing liquid food or drink ingredients include a body having a longitudinal mixing paddle. The body has a cross-section along a direction perpendicular to the longitudinal axis of the body. At least a portion of the cross-section is S-shaped. The body has at least two windows passing through the cross-section of the body. The body being sized and shaped such that, when the device is rotated within the pod while the pod is cooled: (i) edges of the device scrape an inner surface of the pod to remove built-up frozen ingredients located on the inner surface of the pod, (ii) the S-shaped portion of the body forces ingredients in an axial direction in the pod and through the at least two windows, and (iii) the device forces frozen confection out of the pod after the pod is opened.

Some devices include one or more of the following features, and/or one or more of the features described elsewhere in this disclosure.

In some cases, the mixing paddle has a helical-shape.

In some cases, the helical shape has a constant pitch between 40 and 60 degrees/inch. In some cases, the constant pitch is 52 degrees/inch.

In some cases, edges are in contact with a sidewall of the pod for a majority of angular orientations of the device within the pod.

In some cases, the at least two windows are positioned radially along the S-shaped section of the body.

In some cases, the cross-section has a pair of concave features each spaced approximately equidistant from a longitudinal axis of the body, the concave features being concave with respect to the direction in which the device is rotated within the pod while the pod is cooled.

In some cases, the S-shaped cross-section spans a majority of the cross-section of the body.

In some cases, the edges of the device are two helically-extending edges located at opposite radial ends of the cross-section.

In some cases, the cross-section provides an increased bending, flexural, or torsional stiffness to the body to resist deflection of the body as the body rotates within the pod.

Some systems include a pod and a machine. The pod includes a body having a sidewall that extends from a first end of the body to a second end of the body, the body having an interior that contains ingredients for producing a single serving of a cooled food or drink. A mixing paddle is disposed within the body and rotatable relative to the body along a longitudinal axis of the body, a cross-section of the mixing paddle taken perpendicular to a longitudinal axis of the mixing paddle having at least one curved or non-linear section. The machine has a recess sized to receive the pod. The machine includes a refrigeration system operable to cool the ingredients within the pod when the pod is inserted into the recess of the machine. The machine includes a mixing motor operable to rotate the mixing paddle to mix the ingredients within the pod while the ingredients are being cooled to produce the single serving of the cooled food or drink.

Some systems include one or more of the following features, and/or one or more of the features described elsewhere in this disclosure.

In some cases, the machine includes an evaporator that defines the recess.

In some cases, the at least one curved or non-linear section defines a C-shape or an S-shape.

In some cases, the mixing paddle cross-section defines a wavy, undulating shape, or non-linear shape.

In some cases, the mixing paddle cross-section has a pair of concave features each spaced approximately equidistant from the longitudinal axis of the mixing paddle, the concave features being concave with respect to the direction in which the mixing motor rotates the mixing paddle to mix the ingredients within the interior of the pod to produce the single serving of the cooled food or drink.

In some cases, the mixing paddle cross-section has two radial end portions that are curved in an opposite direction relative to the concave features.

In some cases, the machine is operable to rotate the mixing paddle such that edges of the mixing paddle scrape an inner surface of the pod to remove built-up frozen ingredients located on the inner surface of the pod.

In some cases, the machine is operable to rotate the mixing paddle to force the ingredients in an axial direction of the pod and through at least two windows of the mixing paddle.

In some cases, the machine is operable to rotate the mixing paddle to force the produced single serving of the cooled food or drink out of the pod after the pod is opened.

In some cases, the at least one curved or non-linear section provides an increased bending, flexural, or torsional stiffness to the body to resist deflection of the mixing paddle as the mixing paddle rotates within the pod.

In some cases, the sidewall of the pod is coated with a layer of coating and the mixing paddle contacts the layer of coating as the mixing paddle is rotated within the pod. In some cases, the layer of coating is a layer of a PET laminated coating. In some cases, the layer of coating has a thickness that remains substantially constant as the single serving of the cooled food or drink is produced.

Some methods for producing a single serving of a cooled food or drink include disposing a pod within a recess of a machine, the pod containing ingredients for producing the single serving of the cooled food or drink. The method includes rotating a helical mixing paddle within the pod about a longitudinal axis of a pod such that: (i) edges of the mixing paddle scrape an inner surface of the pod to remove built-up frozen ingredients located on the inner surface of the pod; (ii) the helical shape forces the ingredients within the pod in an axial direction and through at least two windows that extend through a cross-section of the mixing paddle; and (iii) the helical shape forces frozen confection out of the pod after the pod is opened. The mixing paddle has a cross-section along a direction perpendicular to the longitudinal axis of the body, and at least a portion of the cross-section is S-shaped.

Some methods include one or more of the following features, and/or one or more of the features described elsewhere in this disclosure.

In some cases, the method includes maintaining contact between the edges of the mixing paddle and the inner surface of the pod while the mixing paddle is being rotated to mix the ingredients. In some cases, the method includes cooling a sidewall of the pod to cool the ingredients within the pod to produce the single serving of the cooled food or drink while the mixing paddle is being rotated to mix the ingredients. In some cases, the method includes cooling the mixing paddle via the maintained contact between the mixing paddle and the sidewall of the pod. In some cases, the method includes using the cooled mixing paddle to cool the ingredients.

Some pods for a single serving of a cooled food or drink include a body having a sidewall and a base attached to the sidewall, the base and the sidewall together defining an interior of the pod. The pods include a cap attached to the body, the cap extending over at least part of the base and rotatable relative to the base, the cap having a plurality of axially extending protrusions defining a plurality of recesses of the cap that are disposed circumferentially around the cap, the plurality of axially extending protrusions having a thickness that varies along an axial direction.

Some pods include one or more of the following features, and/or one or more of the features described elsewhere in this disclosure.

In some cases, the plurality of axially extending protrusions have a height that varies along a circumferential direction, the height being along an axial direction. In some cases, the height of the plurality of axially extending protrusions varies along a radial direction. In some cases, the height of the plurality of axially extending protrusions varies along the circumferential direction due to one or more radiussed or bevelled surfaces of the axially extending protrusions.

In some cases, the plurality of axial extending protrusions are characterized by radiussed or bevelled sidewalls when projected in a radial direction.

In some cases, thickness of the tops of the axially extending protrusions is less than spacing between the respective tops of the axially extending protrusions. In some cases, each axially extending protrusions has substantially the same profile when projected in a radial direction. In some cases, the spacing between the each respective axially extending protrusions is substantially the same.

In some cases, an axially-projected surface area of the plurality of recesses of the cap is greater than an axially-projected surface area of the plurality of axially extending protrusions.

In some cases, the plurality of axially extending protrusions have curved surfaces that face into the plurality of recesses of the cap.

In some cases, the plurality of recesses of the cap are substantially the same shape and size.

In some cases, the cap has an opening that extends axially through the cap. In some cases, the opening is located centrally on the cap and located radially inward of the plurality of axially extending protrusions.

In some case, the cap includes an insert attached to the cap. In some cases, the insert is formed of metal and the cap is formed of plastic. In some cases, the insert includes a surface configured to engage a protrusion of the base of the pod to open the pod.

In some cases, the pod contains ingredients for producing the single serving of the cooled food or drink.

Some systems for producing a single serving of a cooled food or drink include a pod and a machine. The pod includes a body having a sidewall and a base attached to the sidewall, the base and the sidewall together defining an interior of the pod, the interior of the pod containing ingredients for producing the single serving of the cooled food or drink. The pod includes a cap attached to the body, the cap extending over at least part of the base and rotatable relative to the base, the cap having a plurality of axially extending protrusions defining a plurality of recesses of the cap that are disposed circumferentially around the cap, the plurality of axially extending protrusions having a thickness that varies along an axial direction. The machine has a recess sized to receive the pod. The machine includes an annular member rotatable relative to a longitudinal axis of the pod when the pod is received in the recess of the machine, the annular member comprising a plurality of radially-extending pins configured to be inserted into at least a subset of the plurality of recesses of the cap when the pod is received in the recess of the machine. The machine includes a refrigeration system operable to cool the ingredients within the pod when the pod is received in the recess of the machine.

Some systems include one or more of the following features, and/or one or more of the features described elsewhere in this disclosure.

In some cases, receiving the plurality of radially-extending pins into at least the subset of the plurality of recesses of the cap rotationally couples the cap to the annular member.

In some cases, each radially-extending pin extends in a radially inward direction from an inner cylindrical surface of the annular member.

In some cases, each radially-extending pin has at least one angled surface. In some cases, each angled surface contacts at least a subset of the plurality of axially extending protrusions to cause the cap to rotate relative to the annular member when the pod received in the recess of the machine.

In some cases, each radially-extending pin has at least one curved surface.

In some cases, the plurality of radially-extending pins are cylindrical pins. In some cases, each cylindrical pin is rotatable along a respective longitudinal axis of the cylindrical pin.

In some cases, the plurality of radially-extending pins are four radially-extending pins that are substantially equally spaced around the circumference of the annular member.

In some cases, the machine includes a motor rotationally coupled to the annular member, and the motor is operable to rotate the annular member. In some cases, the motor is operable to rotate the annular member to assist in receiving the plurality of radially-extending pins within at least the subset of the plurality of recesses of the cap.

Some methods for producing a single serving of a cooled food or drink include inserting a pod into a recess of a machine, the pod containing ingredients for producing the single serving of the cooled food or drink and comprising a cap attached to a base of the pod and rotatable relative to the base of the pod, the cap having a plurality of axially-extending protrusions that define a plurality of recesses. The machine includes an annular member with a plurality of radially-extending pins. Inserting the pod into the recess of the machine causes the plurality of radially-extending pins of the annular member to contact at least a subset of the plurality of recesses in the cap to seat the pod into the machine and rotationally couple the cap to the annular member.

Some methods include one or more of the following features, and/or one or more of the features described elsewhere in this disclosure.

In some cases, inserting the pod into the recess of the machine causes the plurality of radially-extending pins of the annular member to contact at least a sub-set of the plurality of recesses in the cap to seat the pod into the machine and rotationally couple the cap to the annular member without the need for additional user intervention (e.g., a user does not need to handle or manipulate the pod after insertion).

In some cases, the method includes contacting the plurality of radially-extending pins of the annular member with at least a subset of top surfaces of the plurality of axially-extending protrusions of the cap. In some cases, after contacting the plurality of radially-extending pins with at least the subset of the tops of the plurality of axially-extending protrusions, the method includes rotating the cap relative to the annular member (or rotating the annular member relative to the cap. In some cases, after rotating the cap relative to the annular member, the method includes axially moving the pod towards the plurality of radially-extending pins. For example, the pod essentially moves itself downward due to the force of gravity. In some cases, the pod is seated into the machine after the cap is rotated relative to the annular member. In some cases, after contacting the plurality of radially-extending pins with at least the subset of the tops of the plurality of axially-extending protrusions, the weight of the ingredients in the pod and the at least one angled or one curved surface of the radially-extending pins facilitates a downward axially motion of the pod and causes the radially-extending pins of the annular member to contact bottom surfaces of the subset of the plurality of recesses of the cap without the need for additional user intervention.

In some cases, inserting the pod into the recess of the machine causes the plurality of radially-extending pins of the annular member to contact bottom surfaces of the subset of the plurality of recesses of the cap.

In some cases, the method includes cooling the ingredients within the pod using a refrigeration system of the machine when the pod is seated into the recess of the machine.

In some cases, the method includes mixing the ingredients within the pod while cooling the ingredients using the refrigeration system to produce the single serving of a cooled food or drink.

In some cases, the method includes rotating an insert of the cap relative to the base of the pod to form or expose an opening in the base of the pod. In some cases, rotating the insert of the cap relative to the base of the pod includes moving a dispensing port of the insert circumferentially around the cap. In some cases, the method includes dispensing the produced single serving of the cooled food or drink through the opening of the base of the pod and the dispensing port of the insert of the cap.

The systems and methods described in this specification can provide various advantages.

The mixing paddles described in this disclosure maintain contact with the interior sidewall of the pod to reduce the preparation time of making the cooled food or drinks. Some mixing paddles have the same metallic material (e.g., aluminum) as the pod to improve heat transfer and allow the mixing paddle to assist in cooling the ingredients in the pod. Maintaining contact between the mixing paddle and the sidewall of the pod improves the conductive heat transfer to the evaporator.

The mixing paddles described in this disclosure include a cross section that includes at least one curved or non-linear section. This curved or non-linear section provides additional flexural, bending, and torsional stiffness to the mixing paddle to reduce situations where the mixing paddle flexes while mixing the cooled food or drink. Flexure is generally bad because it can negatively affect the cooling time because the mixing paddle may cease to make contact with the sidewall of the pod and may not effectively scrape frozen ingredients from the sidewall—thereby building up a layer of frozen product on the inside of the pod which impedes heat transfer to the remaining product within the pod.

The drive heads described in this disclosure form a reversible seal with the pod to substantially seal the pod while the pod is in storage and to break the seal during mixing to allow ambient air to be sucked into the pod (e.g., by the whipping action of the mixing paddle) to produce overrun and to assist with dispensing. The drive heads also axially move the mixing paddle within the pod to seat the mixing paddle on a rim of the pod so the mixing paddle maintains concentricity with the pod while mixing and dispensing.

The self-seating system described in this disclosure enables pods to be correctly and completely seated in the machine with minimal user assistance. The caps are specially designed with a plurality of curved recesses to help rotate the pod into position in the machine. In some cases, all the user has to do is drop the pod into the machine and the self-seating system and the weight of the contents in the pod will automatically reposition the pod within the machine to properly and fully seat the pod.

The QR imaging system described in this disclosure provides a fast and accurate reading of QR labels on pods. The machines use information from the QR labels to determine one or more settings for producing the cooled food or drink rather than prompting the user to manually input information about the pod during each use. The QR imaging system reads the label while the sliding lid of the machine is in motion. The QR imaging system improves the user experience and reduces the chance of the product being mixed improperly due to an incorrect entry by the user.

The alternate protrusions described in this disclosure (e.g., clinched protrusions, riveted protrusions, peel-back protrusions) allow the lid of the pod to be manufactured without the large amounts of mechanical cold work required to form an integrally formed protrusion that is sheared off to form an opening in the pod. Reducing the amount of cold work experienced by the lid during manufacturing helps to maintain the original (e.g., annealed) mechanical properties of the lid. This is important since in some cases protrusions would fail prematurely due to material strength issues. Since the clinched and riveted protrusions are formed separately from the lid, they can be manufactured to be thicker than the lid to increase reliability of the protrusion shearing process. They can also be formed of different shapes more easily to increase the contact area with the cap and the reliability of the protrusion shearing process. They also allow the protrusions to be mechanically secured to the lid, obviating the need for glue.

The domed shearing lid and cap design described in this disclosure helps to reduce premature failure of the protrusion. For example, the lids on some pods naturally bow when an inert gas (e.g., liquid nitrogen) is introduced into the pod and then the pod is seamed (e.g., the lid of the pod is seamed to the body of the pod). Trying to attach a planar cap on a domed lid can cause the protrusion to jam onto the cap causing premature failure of the protrusion or causing difficulty in getting the protrusion to seat in its proper starting position on the ramp for a reliable shearing process. The domed cap improves this assembly process because the domed cap is contoured to the shape of the domed lid and does not force the protrusion or lid into its planar shape when the cap is attached to the pod. Specifically designing the cap to include a pre-determined bow can help to increase reliability of the protrusion shearing process and reduce the chances that an end user would experience an issue with the machine malfunctioning. The domed cap also provides an initial force on the protrusion when the internal pod pressure is released, requiring less of a “lift” by the ramp.

The food science that goes into the ingredients of the pod and the sterilization process that the pod undergoes allows the pods to be shelf-stable for months without requiring refrigeration while providing a consistent and delicious product when consumed. The frozen confections are produced with ice crystals having a size less than 50 microns which is associated with the smoothest ice creams in the world. Example shelf-stable pods include ice cream (dairy and non-dairy and alcohol-infused), frozen yogurt, frozen smoothies, frozen sorbets, frozen protein shakes (e.g., with whey), frozen coffee, and frozen cocktails (e.g., with alcohol). Each of these are also provided in various flavors. The machines described in this disclosure produce all of these products from a shelf-stable pod to a bowl or cone in less than a few minutes.

For ease of description, terms such as “upward”, “downward” “left” and “right” are relative to the orientation of system components in the figures rather than implying an absolute direction. For example, movement of a driveshaft described as vertically upwards or downwards relative to the orientation of the illustrated system. However, the translational motion of such a driveshaft depends on the orientation of the system and is not necessarily vertical.

The details of one or more embodiments of these systems and methods are set forth in the accompanying drawings and the description below. Other features, objects, and advantages of these systems and methods will be apparent from the description and drawings, and from the claims.

### DESCRIPTION OF FIGURES

FIGS. 1A and 1B are views of a machine for rapidly producing a chilled or frozen food or drink.

FIG. 2 is a cross section view of a pod for use in the machine.

FIG. 3 is a schematic showing the flow of ingredients within the pod during a mixing cycle.

FIG. 4 is a view of the machine with a top cover removed.

FIGS. 5A and 5B are views of the machine with a top cover of the sliding lid assembly removed.

FIGS. 6A and 6B are views of a dagger assembly of the machine with the drive shaft in a retracted position.

FIGS. 7A and 7B are views of the dagger assembly of the machine with the drive shaft in an engaged position.

FIG. 8 is a cross-sectional view of a QR-scanning system of the machine.

FIGS. 9A and 9B are perspective views of a pod with a QR barcode for use with the QR-scanning system.

FIGS. 10A and 10B is a perspective view of a machine for rapidly producing a chilled or frozen food or drink showing an evaporator mounted in the machine.

FIG. 11 is a perspective view of an evaporator of the machine.

FIG. 12 is a perspective view of an evaporator with a piano hinge.

FIG. 13 is a perspective view of an evaporator with a resilient hinge.

FIGS. 14A and 14B are perspective and cross-sectional views of a collet evaporator.

FIGS. 14C and 14D are perspective and cross-sectional views of a drill chuck.

FIG. 15 is a schematics of a refrigeration system of the machine.

FIG. 16 is a plot of a freezing cycle for producing the cooled food or drink with the machine.

FIG. 17 is a schematic of a refrigeration system with a refrigerant tank.

FIG. 18 is a view of a first end of a pod with its cap spaced apart from its base for ease of viewing.

FIG. 19 is a plan view of various embossments for the base of the pod.

FIGS. 20A-20G illustrate rotation of the cap around the first end of the pod to remove a protrusion to open an aperture extending through the base.

FIGS. 21A-21C are views of a base of the pod with a protrusion.

FIGS. 22A-22D are perspective views of a base of the pod having a clinched protrusion.

FIGS. 23A-23C are schematics of tools for forming a clinched protrusion. [0108] FIGS. 24A and 24B are cross-sectional views of a base of the pod with a rivet protrusion.

FIG. 25 is a perspective view of a base of a pod with a protrusion shaped as a ski-type feature.

FIGS. 26A-26D are views of a domed lid and mating shear drive assembly.

FIGS. 27A and 27B are perspective views of peel back lid for a pod.

FIGS. 28A-28C are a sequence of views illustrating the engagement between the peel back lid and a shearing cap.

FIGS. 29A-29D are schematics of an alternative peel back lid having a raking surface with a cavity.

FIGS. 30A-30D are perspective views of a two-piece shearing cap for a pod.

FIGS. 31A-31C are perspective views of a shearing cap with various size orifices.

FIGS. 32A-32E are perspective views of a three-piece shearing cap for a pod.

33A and 33B are perspective views of a shearing cap with a rubber seal insert.

FIGS. 34A-34C are views of a two-piece shearing cap with tangs integrally formed with the body of the cap.

FIG. 35 is an image of product being dispensed from a machine.

FIGS. 36A and 36B are images of a prototype shearing cap.

FIGS. 37A and 37B are images of a pod with a prototype shearing cap showing residual product on the cap.

FIGS. 38A and 38B are images of a pod with a prototype shearing cap showing less residual product on the cap.

FIGS. 39A-39D are perspective views of an over-molded shearing cap for a pod.

FIGS. 40A-40C are views of a prototype shearing cap.

FIGS. 41A-41C are views of a prototype shearing cap.

FIGS. 42A-42E are perspective views of a shearing cap with a dimple.

FIGS. 43A-43D are views of a cap shearing system of a machine.

FIGS. 44A-44E are views of a cap shearing system of a machine.

FIGS. 45A-45C are views of a pod with a cap for use in a self-seating system of the machine.

FIGS. 46A and 46B are views of an annular member of the machine for as a part of the self-seating system of the machine.

FIG. 47 is a cross-sectional view of a pod inserted into the self-seating system of the machine.

FIGS. 48A-48C are views of a prototype self-seating pod system for a machine.

FIG. 49 are views of an alternate self-seating pod system of a machine.

FIGS. 50A and 50B are view of a pod with a prototype cap for the self-seating system.

FIGS. 51A-51C are perspective and cross-sectional views of a mixing paddle with ribbed edges.

FIGS. 52A-52C are perspective and cross-sectional views of a mixing paddle having a cross-section with convex features oriented in the mixing direction.

FIGS. 53A-53C are perspective and cross-sectional views of a mixing paddle having a cross-section with concave features oriented in the mixing direction.

FIGS. 53D and 53E are views of curved radial ends of a mixing paddle.

FIGS. 54A and 54B are perspective views of a prototype mixing paddle.

FIGS. 55A-55C are views of a mixing paddle with a notch for engaging a lip of a pod.

FIGS. 56A and 56B are views of a mixing paddle with a perpendicular shoe.

FIGS. 57A-57C are views of a threaded drive head for a mixing paddle.

FIGS. 58A-58D are views of a threaded drive head for a mixing paddle.

FIG. 59 is a perspective view of a foam structure for diffusing gas and liquid spray.

Like reference symbols in the various drawings indicate like elements.

### DETAILED DESCRIPTION

This specification describes systems and methods for rapidly cooling food and drinks. Some of these systems and methods use a counter-top or installed machine to cool food and drinks in a container from room temperature to freezing in less than three minutes. For example, the approach described in this specification has successfully demonstrated the ability make soft-serve ice cream, frozen coffees, frozen smoothies, and frozen cocktails, from room temperature pods in approximately 90 seconds. This approach can also be used to chill cocktails, create frozen smoothies, frozen protein and other functional beverage shakes (e.g., collagen-based, energy, plant-based, non-dairy, and CBD shakes), frozen coffee drinks and chilled coffee drinks with and without nitrogen in them, create hard ice cream, create milk shakes, create frozen yogurt and chilled probiotic drinks. These systems and methods are based on a refrigeration cycle with low startup times and a pod-machine interface that is easy to use and provides extremely efficient heat transfer. Some of the pods described can be sterilized (e.g., using retort sterilization or aseptic filling) and used to store ingredients including, for example, dairy products at room temperature for up to 18 months.

These machines, pods, and refrigeration systems are described in detail in U.S. patent application Ser. No. 15/625,690 (attorney docket number 47354-0003001) filed Jun. 16, 2017, U.S. patent application Ser. No. 16/104,758 (attorney docket number 47354-0004001) filed Aug. 17, 2018, U.S. patent application Ser. No. 16/459,388 (attorney docket number 47354-0006001) filed Jul. 1, 2019, U.S. patent application Ser. No. 16/459,176 (attorney docket number 47354-0009001) filed Jul. 1, 2019, U.S. patent application Ser. No. 16/459,322 (attorney docket number 47354-0010001) filed Jul. 1, 2019, U.S. patent application Ser. No. 16/824,616 (attorney docket number 47354-0036001) filed Mar. 19, 2020, U.S. patent application Ser. No. 16/844,781 (attorney docket number 47354-0012001) filed Apr. 9, 2020, and U.S. patent application Ser. No. 17/335,891 (attorney docket number 47354-0037001) filed Jun. 1, 2021, all of which are incorporated herein by reference in their entirety.

A significant challenge in the design of ice cream machines is the ability to cool a pod from room temperature to the draw temperature as quickly as possible, preferably within two minutes. Some machines reduce the residence time the ice cream remains in the ice cream machine by reaching the draw temperature as quickly as possible. This can be achieved by mixing and cooling as quickly as possible.

The machines and processes described in this specification create ice cream with the majority of the ice crystals below 50 μm and often the majority is below 30 μm in a single serve pod. In order to still be able to dispense the ice cream out of the pod into a bowl or dish without the ice cream contacting the machine, a draw temperature or dispensing temperature of the ice cream should be between −3° to −8° C. (26.6° F. to 17.6° F.) and preferably between −3° to −6° C. (26.6° F. to 21.2° F.).

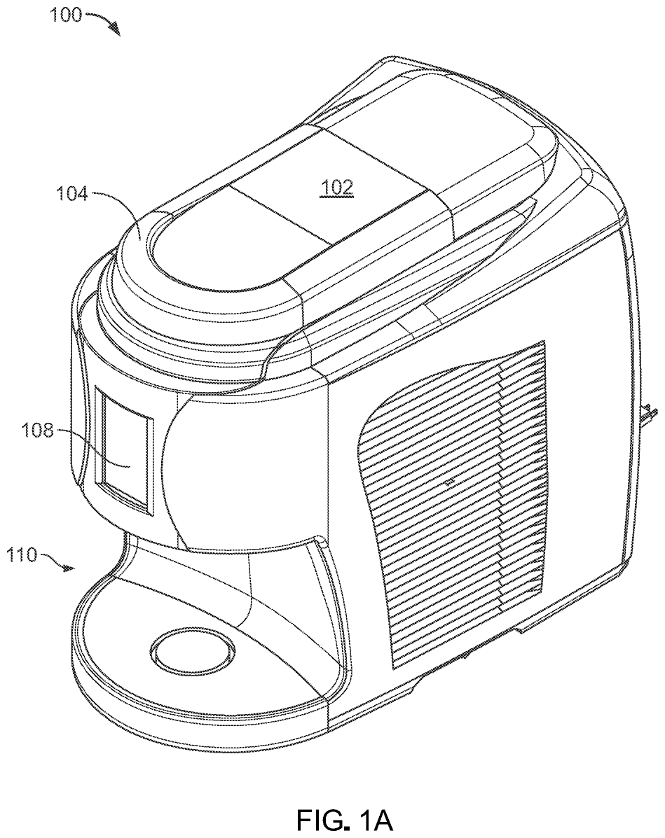

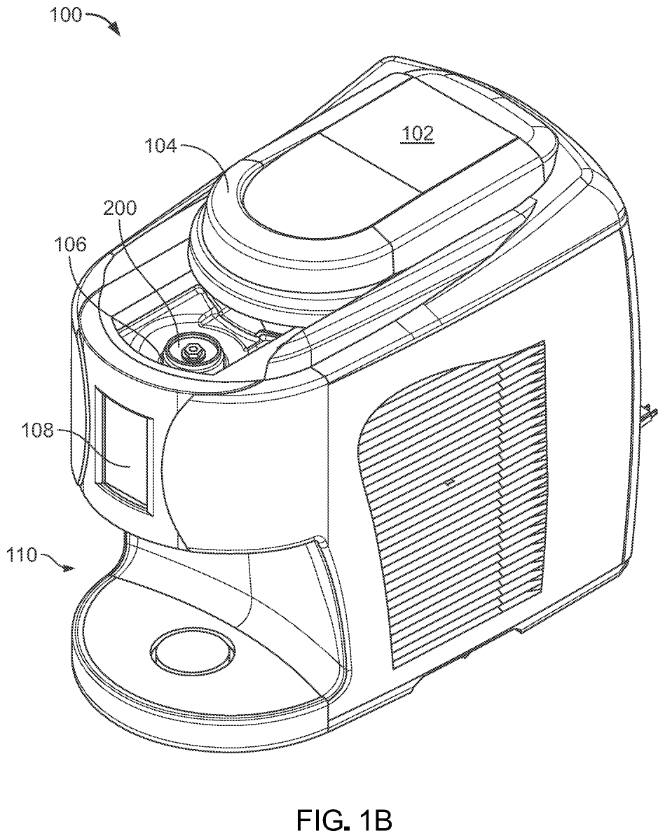

FIGS. 1A and 1B show a machine 100 for producing a chilled or frozen food or drink. FIG. 1A shows the machine 100 in a closed configuration and FIG. 1B shows the machine 100 in an open configuration. A user pushes and pulls a sliding lid 102 (e.g., by grasping a handle 104) to move the machine 100 between the closed and open configurations. Some machines have an automated system (e.g., one or more motors or actuators) to open and close the sliding lid 102 without user assistance.

The sliding lid assembly 102 reduces the overall height of the machine 100 compared to machines with lid assemblies that open upward (e.g., pivoting designs). In some examples, machine 100 is compact and able to fit on kitchen countertops underneath cupboards. Machine 100 has a height (top to bottom) of about 17.5 inches, a depth (front to back) of about 20 inches, and a width (side to side) of about 12 inches. Some machines have other dimensions. Some machines have a height of less than 20 inches (e.g., between 16 and 20 inches), a depth of less than 24 inches (e.g., between 18 and 24 inches), and a width of less than 16 inches (e.g., between 10 and 16 inches). Some machines are larger to accommodate larger more powerful compressors.

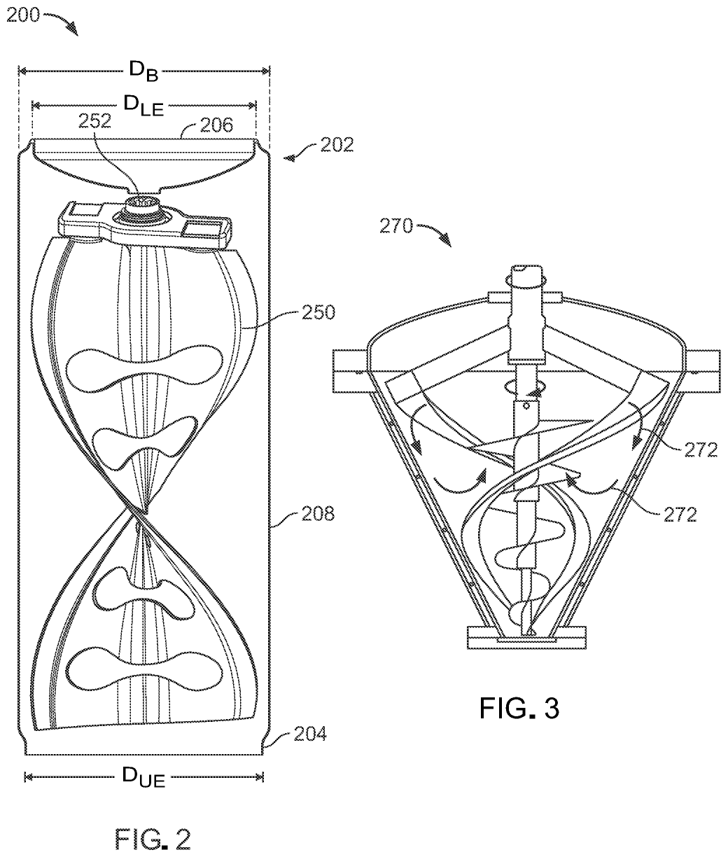

In the open configuration shown in FIG. 1B, a user (e.g., a consumer) inserts a pod 200 into a receptacle 106 of the machine 100. The receptacle 106 is defined by one or more surfaces of an evaporator of the machine 100. An example pod 200 is shown inserted into the receptacle 106 and described with reference to FIG. 2. The machine 100 reduces the temperature of ingredients in the pod 200 to produce a single serving of a cooled food or drink.

FIG. 2 is a schematic side view of an example pod 200 for use in machine 100. The pod 200 includes a body 202 that extends from a first end 204 at an open end or base of the pod 200 to a second end 206 at a closed end of the pod 200. The pod 200 is cylindrical and has a circular cross-section. A sidewall 208 connects the first end 204 to the second end 206. The first end 204 has a diameter D_{UE} that is slightly larger than the diameter D_{LE} of the second end 206. The sidewall 208 has a circular cross-section with a diameter D_{B}. The diameter D_{B} is larger than both the diameter DUE of the first end 204 and the diameter D_{LE} of the second end 206. This configuration of the pod 200 provides a balance between reducing material usage (e.g., aluminum) while increasing the columnar strength of the pod and facilitates stacking multiple pods 200 on top of one another with the first end 204 of one pod receiving the second end 206 of another pod.

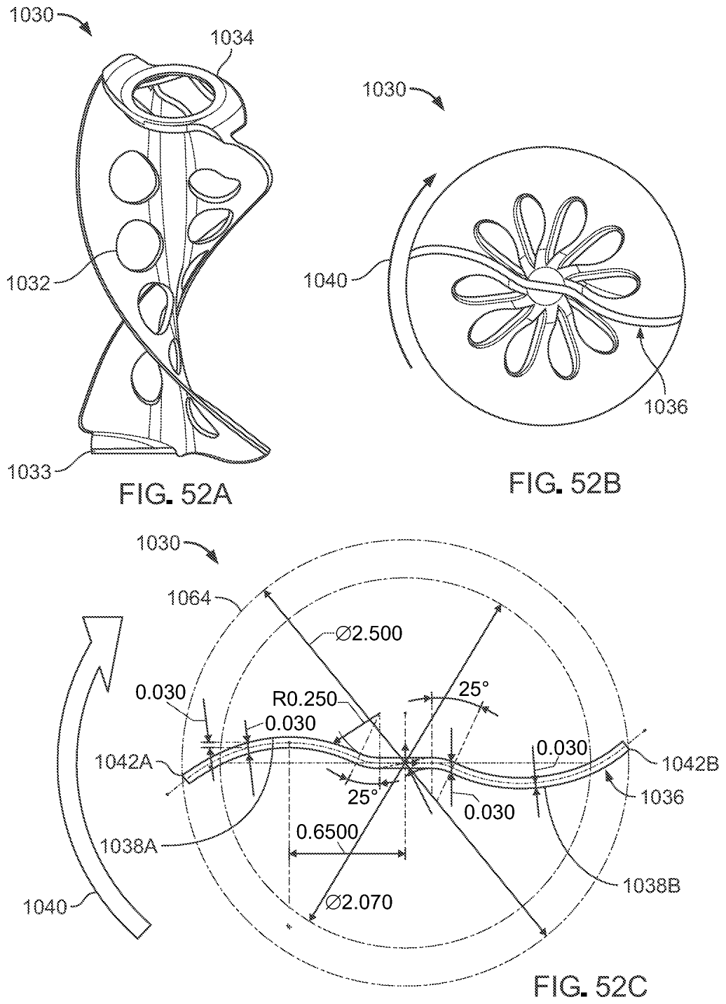

The pod 200 includes a mixing paddle 250 disposed within the body 202 of the pod 200. In some examples, the mixing paddle is referred to as an impeller or a blade. The mixing paddle 250 is rotatable within the pod 200 and is concentrically disposed within the pod 200. The mixing paddle 250 includes a drive head 252 with a receptacle for engaging a drive shaft of the machine 100 for driving the mixing paddle 250 within the pod 200 to produce the serving of the cooled food and drink. Further details about mixing paddle 250 are described with reference to FIGS. 52A-52C.

Some pods are sized to provide a single serving of the food or drink being produced. Some pods have a volume between 6 and 18 fluid ounces. Pod 200 has a volume of approximately 8.5 fluid ounces. Some pods are filled with all of the ingredients needed to produce the cooled food or drink (except that ambient air is sucked into the pod from the atmosphere while producing the cooled food or drink). Some pods are filled approximately half-way (e.g., between 40% and 60% fill by volume) with the ingredients and the remaining headspace being pressurized with an inert gas (e.g., nitrogen) before the pod is sealed. Some pods are filled ⅓ of the way (e.g., 33% by volume), and some pods are filled ⅔ of the way (e.g., 66% by volume). The remaining head space in the pod allows the ingredients to slosh around during a retort sterilization process which improves heat transfer. The headspace also provides room in the pod for the ingredients to expand (e.g., foam or create overrun) in the pod 200 while the cooled food or drink is produced (e.g., when the mixing paddle 250 whips the ingredients at large RPMs (e.g., over 50 RPM, over 100 RPM, over 200 RPM, etc.) while drawing air into the pod 200 to produce overrun). Some pods do not need to introduce air and can rely on the inert gas (e.g., nitrogen) in the pod. In these cases, the pod can remain sealed during at least part of the mixing process. In some cases, air can be introduced during the mixing process.

The thickness and material of the sidewall 208 of the pod 200 enables the pod 200 to provide fast and efficient heat transfer between the evaporator of the machine 100 and the ingredients within the pod 200. Some pods have a sidewall 208 that is formed of aluminum or an aluminum alloy and is between 5 and 50 microns thick.

Some mixing paddles 250 are formed of the same material as the sidewall 208 of the pod 200 to provide even better heat transfer between the evaporator of the machine 100 and the ingredients within the pod 200. For example, some pods have a sidewall 208 formed of an aluminum alloy, and the mixing paddle 250 is also formed of an aluminum alloy (e.g., the aluminum alloy need not be the exact same). Some evaporators include an aluminum inner surface that defines the receptacle 106 so the material is the same between the evaporator, the pod 200, and the mixing paddle 250. Since the materials are the same, or substantially the same, the thermal expansion and thermal conductivity are also the same, or substantially the same. This means that during cooling, the evaporator, the sidewall 208, and the mixing paddle 250 all conduct heat at the same rate and expand or shrink at the same rate. This allows the engagement and contact pressure between these three components to be the same. This further improves heat transfer and reduces the time required to produce the cooled food or drink.

The bodies of some pods and mixing paddles are made of other materials, for example, tin, stainless steel, and various polymers such as polyethylene terephthalate (PET). Some pods are made of different materials to assist with the manufacturability and performance of the pod. For example, the pod walls and the second end 206 may be made of 3000-series Aluminum (e.g., 3104) while the base may be made of 5000-series Aluminum (e.g., 5182). Some pods include different series of Aluminum (e.g., 2000-series, 6000-series, etc.).

In some pods, the internal surfaces of the pod are coated with a lacquer to prevent corrosion of the pod as it comes into contact with the ingredients contained within pod. This lacquer also reduces the likelihood of “off notes” of the metal in the food and beverage ingredients contained within pod. For example, a pod made of aluminum may be internally coated with one or a combination of the following coatings: Sherwin Williams/Valspar V70Q11, V70Q05, 32SO2AD, 40Q60AJ; PPG Innovel 2012-823, 2012-820C; and/or Akzo Nobel Aqualure G1 50. Other coatings made by the same or other coating manufacturers may also be used. Some pods are internally coated with a layer of coating and the mixing paddle is sized to contact the layer of coating as the mixing paddle is rotated within the pod. In some examples, the layer of coating is a layer of a PET laminated coating. In some examples, the layer of coating has a thickness that remains substantially constant as the single serving of the cooled food or drink is produced (e.g., the coating does not rub off).

Some mixing paddles are made of the same or similar aluminum alloys and coated with similar lacquers/coatings. For example, Whitford/PPG coating 8870 may be used as a coating for mixing paddles. The mixing paddle lacquer may have additional non-stick and hardening benefits for the mixing paddle. Some mixing paddles are electrostatically coated. Some mixing paddles are made of AL 5182-H48 or other aluminum alloys. Some mixing paddles exhibit a tensile strength of 250-310 MPa minimum, a yield strength of 180-260 MPa minimum, and an elongation at break of 4%-12%.

Some mixing paddles are reusable by removing them from the pod, washing them, and reusing them in the same or another pod. In some cases, the pod and the mixing paddle are both formed of aluminum and are both recyclable without having to take apart the pod and separate the mixing paddle from the pod (e.g., removal of the mixing paddle from the pod is generally difficult for a consumer to do and not necessary).

FIG. 3 is a schematic 270 of the flow of ingredients during mixing. In this illustration, the pod and the mixing paddle are frustoconical in shape but this flow of ingredients is also present for the cylindrical pods such as pod 200 and mixing paddle 250. As the mixing paddle rotates within the pod, the helical shape of the mixing paddle draws the ingredients from the sidewall of the pod to the center of the pod and upward in an axial direction (e.g., as denoted by arrows 272). The ingredients also pass through one or more openings of the mixing paddle. The ingredients make significant contact with the mixing paddle during the mixing process and having a cooled mixing paddle allows the mixing paddle to aid in the freezing process. This is an advantage in cases where the mixing paddle is metal (e.g., aluminum) or otherwise has a large thermal conductivity.

Edges of the mixing paddle 250 continuously contact and scrape the sidewall 208 of the pod 200 to remove ice and frozen ingredients off of the sidewall 208. The mixing paddle 250 moves the scraped ingredients to the center of the pod 200 so the cooler ingredients at the sidewall are mixed with the ingredients in the warmer center to improve heat transfer and cool faster. The mixing paddle 250 maintains contact against the sidewall 208 for all rotational positions of the mixing paddle 250 (e.g., as the mixing paddle 250 revolves about 360 degrees within the pod 200). Pods with a sidewall that is the same material as the mixing paddle makes this process more efficient since the thermal expansion and thermal conductivity are the same. Some machines oscillate and/or vibrate the mixing paddles to help remove product sticking to the mixing paddle and/or sticking to the sidewall of the pod.

Some pods are formed from commercially available can sizes, for example, “slim” cans with diameters ranging from 2.080 inches-2.090 inches and volumes of 180 milliliters (ml)-300 ml, “sleek” cans with diameters ranging from 2.250 inches-2.400 inches and volumes of 180 ml-400 ml and “standard” size cans with diameters ranging from 2.500 inches-2.600 inches and volumes of 200 ml-500 ml. The machine 100 is configured to use pods with 2.085±0.10 inches outer diameter. Some pods have an inner diameter of 2.065 inches to 2.075 inches to allow mixing paddles with a diameter of 2.045 to 2.055 inches, respectively, to rotate at an RPM of 100 to 1,500 RPM, resulting in 6,000 to 93,000 square inches scraped per minute.

With an inner diameter of about 2.085 inches, the pod can accommodate a mixing paddle with a diameter of about 2.065 inches to 2.085 inches (i.e., some mixing paddles have the same diameter as the pod). The mixing paddle can revolve in the pod at rotational speeds ranging between 100 RPM and 1,500 RPM. During this time the blade edges of the mixing paddle scrape the internal walls of the pod at rates ranging from 3,100 to 46,500 square inches per minute. The scraped area per minute multiplies with each scraping edge on the mixing paddle (i.e., a mixing paddle with two edges would scrape approximately 6,200 to 93,000 square inches per minute). This scraping and mixing process helps distribute the ice crystals that form at the wall of the pod to the interior of the pod.

Some pods have a decorative external coating of no more than 10-50 microns thickness (e.g., less than 50 microns). Some pods do not have an internal or external coating on the ends.

In addition to single-use pods, some pods are reusable. Some pods are used, washed, and reused. Some pods are purchased empty and filled before use. Some pods are purchased or acquired full, used, and refilled by a user or by the machine. Some pods are sterilized after use and sterilized after refill to enable room temperature storage (e.g., shelf-stable pods). Some pods include resealed features that allow the pod to be refilled and resealed. Some pods can be purchased empty and used with a home ice cream making kit with clean-label ingredients.

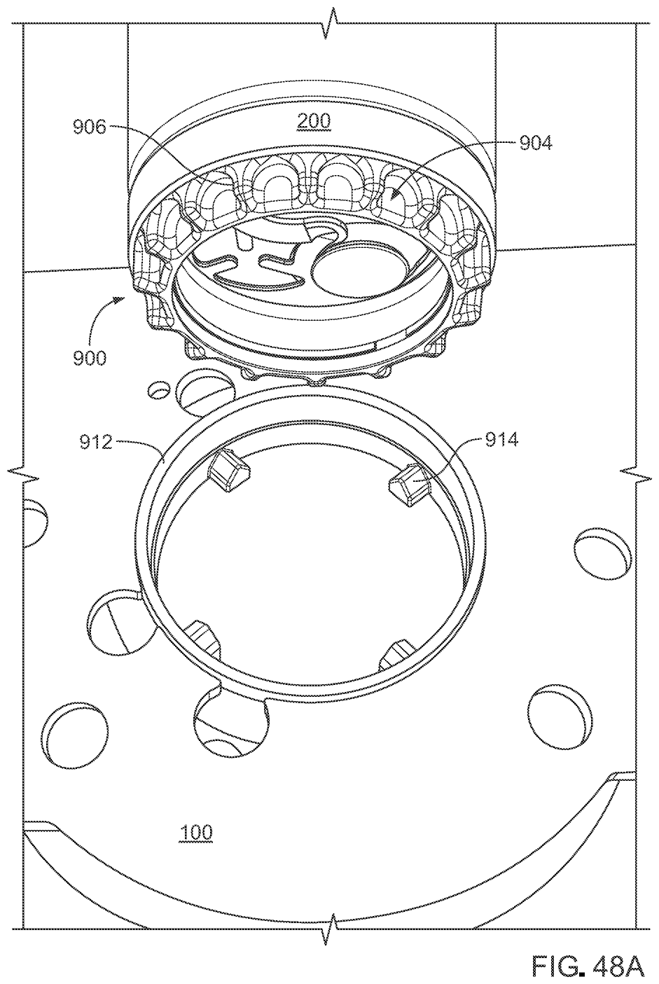

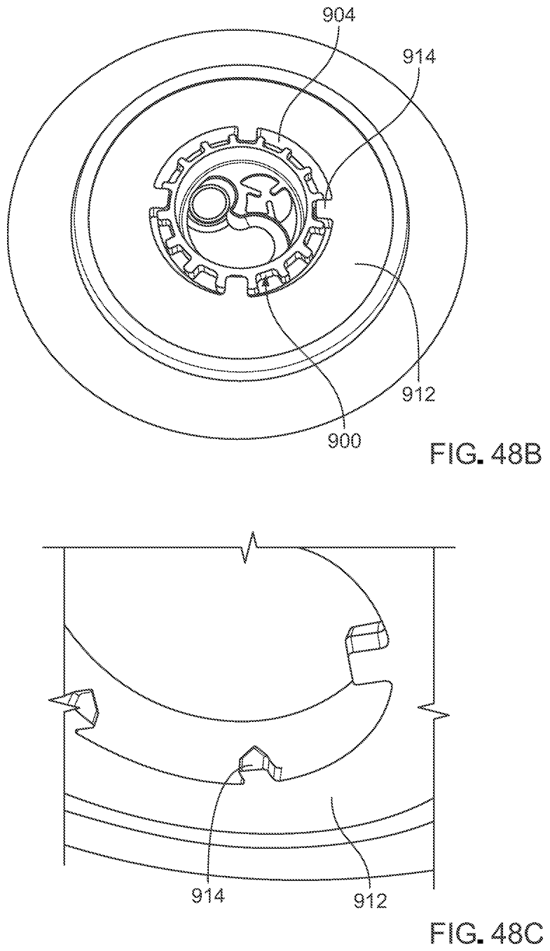

Additional examples of mixing paddles are described with reference to FIGS. 48A-53B. Other mixing paddles and pods that can be used with machine 100 are described in more detail in U.S. patent application Ser. No. 16/459,322 (attorney docket number 47354-0010001) filed Jul. 1, 2019, and U.S. patent application Ser. No. 16/824,616 (attorney docket number 47354-0036001) filed Mar. 19, 2020, both of which are incorporated herein by reference in their entirety.

The machine 100 includes a touch-screen user interface 108. A user engages with the user interface 108 to select/confirm one or more settings of the machine 111 (e.g., select the product to be produced, confirm the product, etc.), display an indication of time remaining during the process of producing the cooled food or drink (e.g., a circular display, a bar display, a digital clock, etc.), and display instructions for the user (e.g., ask the user to place their bowl or cone in the dispensing area 110 of the machine 100 to get ready for the product to be dispensed).

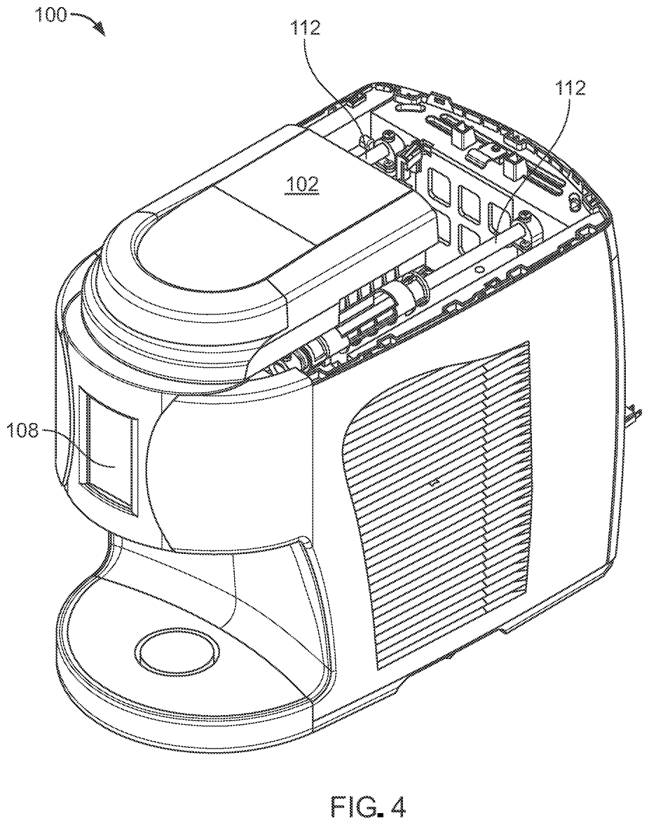

FIG. 4 is a perspective view of the machine 100 with the top cover of the machine 100 removed. The sliding lid 102 is mounted on a pair of cylindrical rails 112 and is linearly slidable back and forth to open and close the area where the pod 200 is inserted.

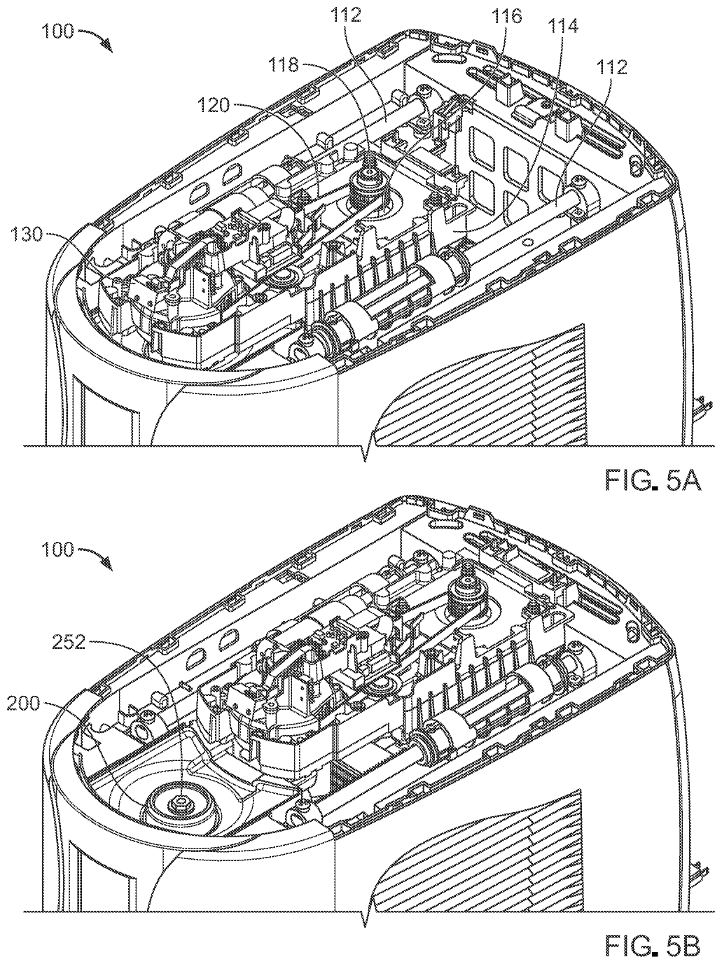

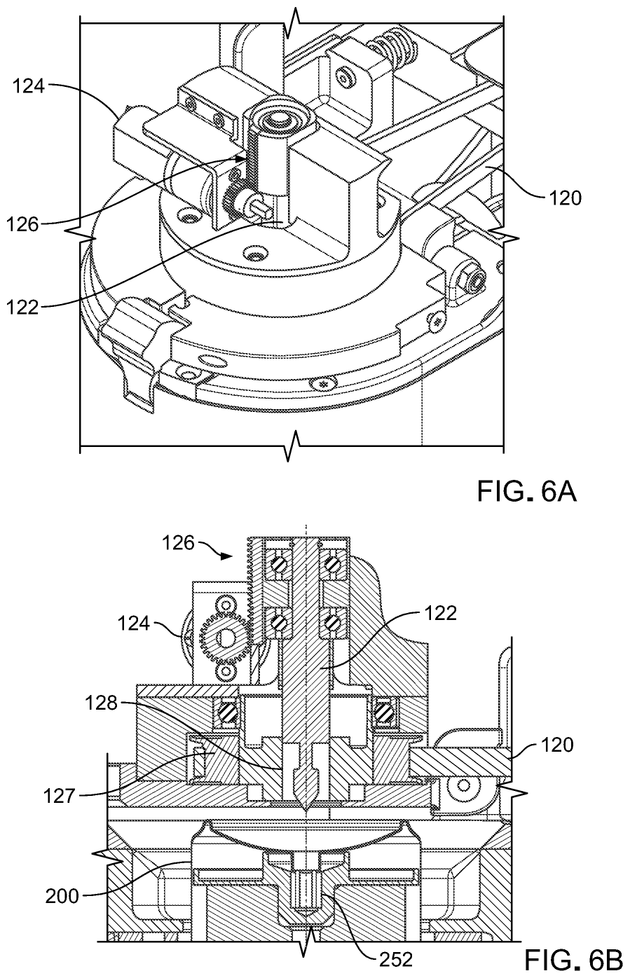

FIGS. 5A and 5B are perspective views of the machine 100 with the top cover of the machine 100 removed and the top cover of the sliding lid 102 removed. FIG. 5A shows the machine 100 in the closed configuration and FIG. 5B shows the machine in the open configuration. The sliding lid 102 includes a housing 114 that includes a drive motor 116 mounted on an underside of the housing 114. The drive motor 116 includes a motor shaft 118 that is rotationally coupled to the mixing paddle 250. The rotational coupling involves transferring torque from the drive motor 116, through a belt 120, to an axially movable drive shaft 122 (shown in FIGS. 6A and 6B).

In some machines, the motor provides at least 50 ozf-in (ounce-force inch) of torque at a rotational velocity of at least 100 RPM (rotations per minute) at the mixing paddle. For example, a torque of 100 ozf-in and a rotational speed of 750 RPM may be used. In some machines, the drive motor 116 provides a torque of up to 400 ozf-in and a rotational speed of up to 1,500 RPM. Some machines increase the mixing speed of the mixing paddle 250 to help mix air (or the inert gas in the pod) into the frozen confection to achieve improved overrun (preferably at least 30% overrun). Some machines increase the mixing speed of the mixing paddle 250 to provide enough velocity to extrude the ice cream out of the exit port of the pod 200 while achieving a constant flow (stream) of ice cream coming out of the pod.

Increasing the rotational velocity of the mixing paddle 250 increases the required electric current. The table below illustrates electrical currents of the current prototype machine that are used to drive the mixing paddle 250 as a function of RPM and time into the freezing process (which affects the viscosity of the ice cream).

| | Seconds from start of the freezing cycle | | | | | | | |
|---|---|---|---|---|---|---|---|---|
| | 3 | 15 | 30 | 45 | 60 | 75 | 90 | 105 |
| RPM of the mixing paddle | 275 | 275 | 275 | 315 | 435 | 558 | 800 | 1000 |
| Current on the motor that | 372 | 658 | 1202 | 1833 | 2738 | 4491 | 9192 | 13719 |
| drive the mixing paddle | | | | | | | | |
| (milliamps) | | | | | | | | |

The machine 100 raises and lowers the drive shaft 122 via a plunger motor 124 (shown in FIG. 6B) to axially and rotationally engage the drive shaft 122 to the receptacle of the drive head 252 of the mixing paddle 250. The drive motor 116 and the plunger motor 124 are mechanically attached to the sliding lid assembly 102 so they both translate with the sliding lid assembly 102. The belt 120 is under tension both when the lid is in its open position and when the lid is in its closed position. The belt 120 also translates with the sliding lid assembly 102. Some machines include a belt tensioning system to maintain the tension of the belt 120.

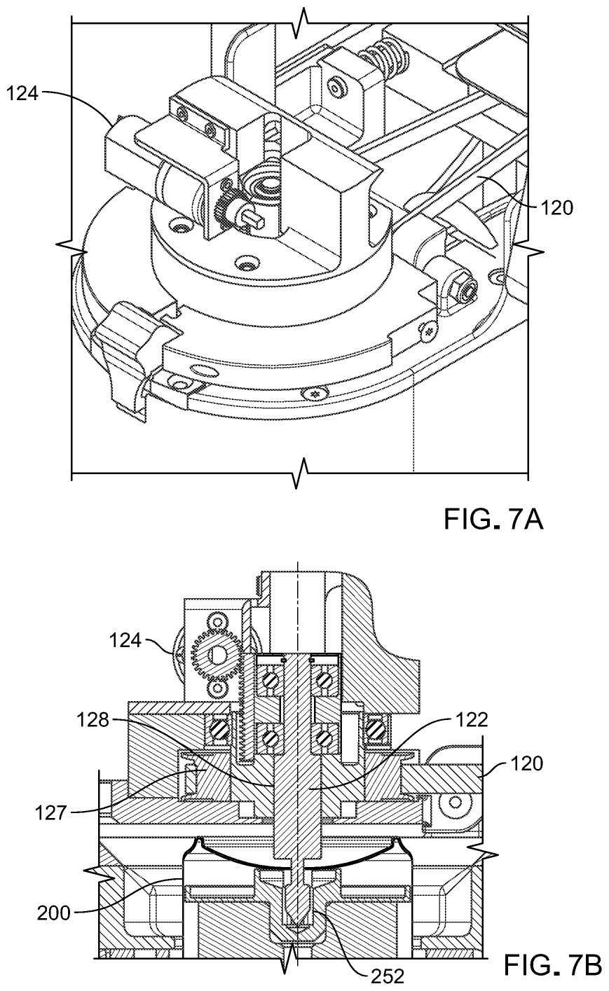

FIGS. 6A and 6B are views of the plunger assembly of the machine 100 in a disengaged configuration with the pod 200. The plunger motor 124 is axially coupled to the drive shaft 122 via a rack and pinion system 126. The plunger motor 124 translates the drive shaft 122 axially between the disengaged configuration (shown in FIGS. 6A and 6B) and an engaged configuration (shown in FIGS. 7A and 7B). A pulley 127 is rotationally coupled to the belt 120. The pulley 127 has a keyed bore 128 (e.g., a hexagonal-shaped bore) that slidably receives the similarly keyed drive shaft 122 and rotationally couples the torque of the drive motor 116 to the drive shaft 122.

In some machines, an onboard controller (or processor) monitors the axial position of the drive shaft 122 using an encoder (not shown) on the plunger motor 124 and a limit switch (not shown). For instance, when the user inserts the pod 200 into the machine 100 and presses the start button (e.g., via the user interface 108) or when the user inserts the pod 200 into the machine 100 and the QR system of the machine 100 reads the QR code on the pod 200, the evaporator closes around the pod 200 to clamp the pod 200 into the machine 100 and the drive shaft 122 plunges into the receptacle of the drive head 252 of the pod to rotatably couple the drive shaft 122 to the mixing paddle 250. Some machines wiggle and/or rotate the drive shaft 122 during the plunging process to ensure proper alignment with the receptacle of the drive head 252 before mixing and freezing would commence.

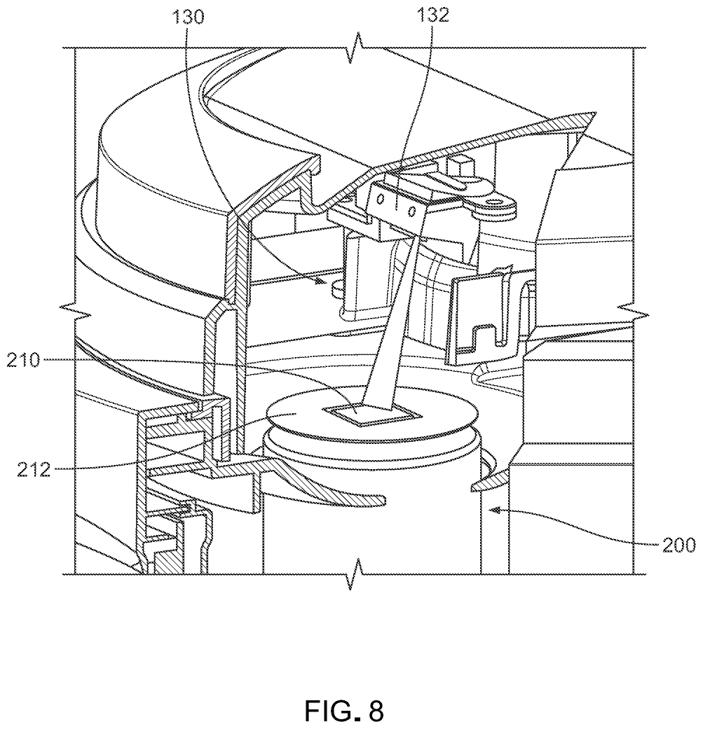

FIG. 8 is a perspective view of a QR scanning system 130 for the machine 100. The QR scanning system 130 is mechanically mounted to the housing 114 of the sliding lid 102. The QR scanning system 130 includes a camera scanner 132 that is operable to read a QR code 210 on a label of pod 200. In some examples, the QR code 210 is printed on a lid 212 or cover of the pod 200. In some examples, the QR code 210 is printed directly on the metal (e.g., aluminum) at an end of the pod 200.

The QR code 210 contains information to select parameters for preparation of the cooled food or drink. Examples of parameters include evaporator close pressure and sequence, mixing paddle rotation speed, cycle time, evaporant temperature, and cycle and dispense temperatures. Some QR codes 210 include information about the product (e.g., ice cream favor, alcoholic content, etc.). The information density of the QR code may be customized to fit the camera's detection window. In some cases, the QR code is single input which indicates a predetermined recipe in the built-in memory of the machine 100. In some cases, the memory of the machine 100 is updated by downloading new recipes and these recipes are compared against the information of the QR code 210 during use of the machine 100.

The QR scanner 132 moves with the opening and closing of the sliding lid 102. As the sliding lid 102 is pulled forward (e.g., to the closed position) after the user has inserted the pod 200, the scanner 132 reads the information on QR code 210 on top of the pod. The QR scanner 132 images the QR code 210 before the sliding lid 102 is moved to the closed configuration. This is because, when the machine 100 is in the closed configuration, the QR scanner 132 would have already passed by the pod 200 since the drive shaft 122 would be moved to a position where it is collinear with the longitudinal axis of the mixing paddle 250. The QR scanner 132 is designed to image the QR code 210 quickly and accurately during this short time window and while the sliding lid 102 is in motion.

In some cases, if no QR code is detected, the user is prompted to open and close the lid 102 again. The user may also bypass the QR code by manually entering the pod type through the user interface 108. The scanner 132 is oriented at a 15 degree angle relative to the horizontal plane of the foil label and QR code 210. Some scanners are oriented at a 12 degree angle to 17 degree angle. The scanner 132 has a resolution of 1280×800 pixels, a focal distance of 18 cm (7.0 in), a horizontal field of view of 48 degrees and a vertical field of view of 30 degrees. Some scanners may have a focal distance of 16 cm to 20 cm. The scanner 132 must be able to read the QR code 210 of the pod 200 while the scanner 132 is in motion as it slides between the opened and closed configuration. The scanner 132 needs the QR code 210 at an appropriate focal length and angle to be read.

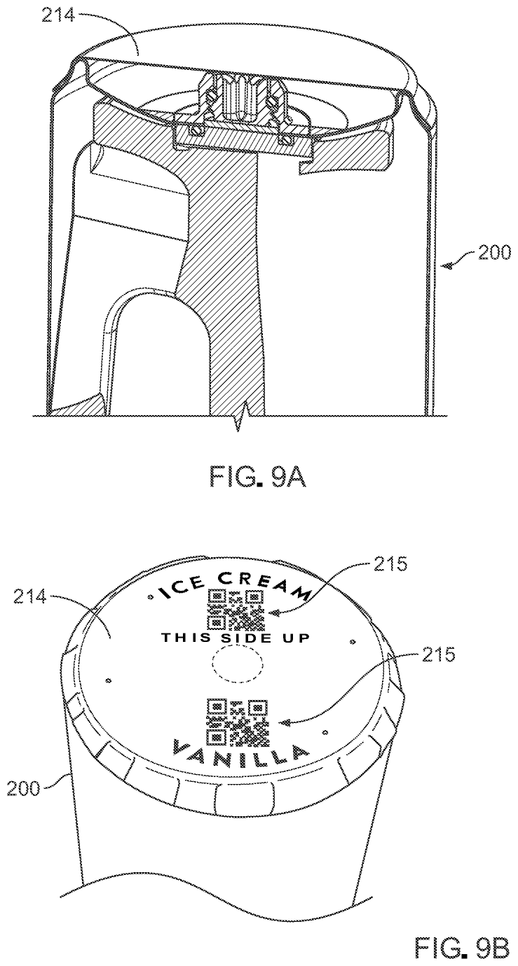

FIGS. 9A and 9B are perspective views of a pod with a dome foil 214. Dome foil 214 is made of an appropriate material to maintain the optimal balance of adhesion to the pod, strength and rigidity and limited reflectivity. The dome foil 214 includes one or more codes (e.g., QR codes, barcodes). In the example shown, the foil 214 includes two QR codes 215 offset from the center and diametrically opposite each other. The QR scanning system 130 reads at least one and sometimes both of the QR codes 215 on the dome foil 214. In some cases, the two QR codes 215 are the same codes to give the QR scanner 132 two opportunities to read information from the pod. In some cases, one of the codes 215 becomes damaged during shipping and handling of the pod while the other code 215 remains intact. In some cases, the codes 215 are different to communicate different information to the machine 100 (e.g., one code is used for half of the settings and the other code is used for the remaining half of the settings).

The identification information of the codes can also be used to facilitate direct to consumer marketing (e.g., over the internet or using a subscription model). Some machines use this approach to sell ice cream thru e-commerce because the pods are shelf stable. In such a subscription mode, customers pay a monthly fee for a predetermined number of pods shipped to them each month. The customers select their personalized pods from various categories (e.g., ice cream, healthy smoothies, frozen coffees or frozen cocktails, etc.) as well as their personalized flavors (e.g., chocolate or vanilla). In some cases, the machine itself can be rented using a subscription model. In some cases, reusable pods and mixing paddles can be rented as well.

The identification can also be used to track each pod used. In some systems, the machine is linked with a network and can be configured to inform a vendor as to which pods are being used and need to be replaced (e.g., through a weekly shipment). This method is more efficient than having the consumers go to the grocery store and purchase pods.

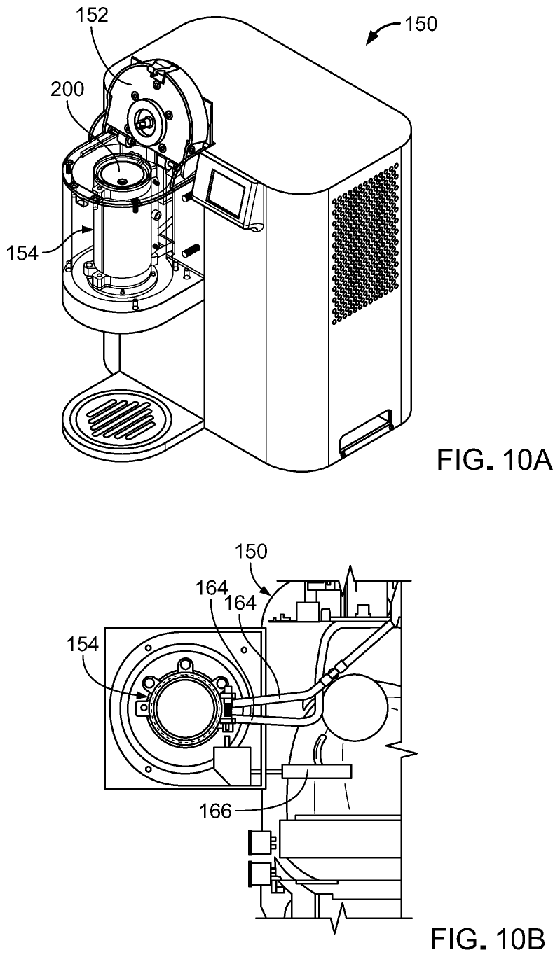

FIGS. 10A and 10B are perspective and cross-section views of a machine 150 for producing a single serving of a cooled food or drink. Machine 150 is similar to machine 100 but includes a pivoting lid 152 instead of the sliding lid 102 of machine 100. Both machine 100 and 150 include an evaporator 154 for cooling the pod 200 when the pod 200 is inserted into the respective machine. Additional evaporators for use with machines 100 and 150 are described in U.S. patent application Ser. No. 16/459,388 (attorney docket number 47354-0006001) filed Jul. 1, 2019, and U.S. patent application Ser. No. 16/824,616 (attorney docket number 47354-0036001) filed Mar. 19, 2020, both of which are incorporated herein by reference in their entirety.

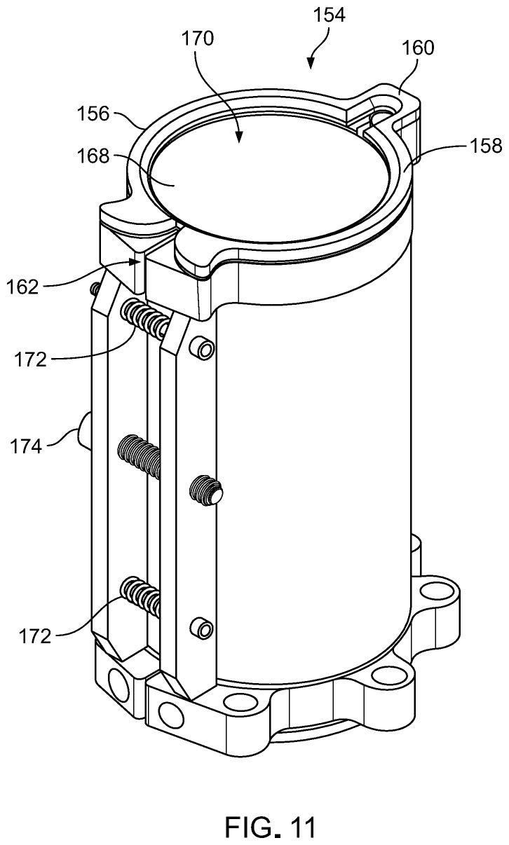

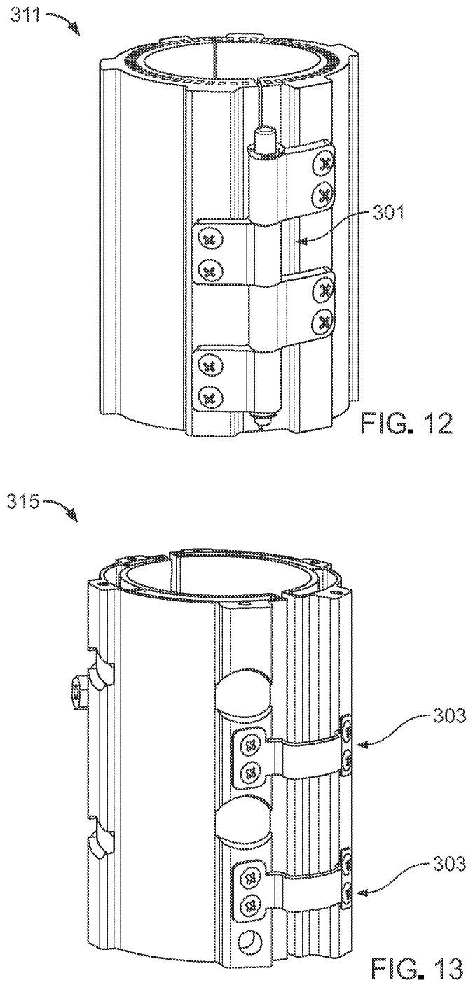

FIG. 11 is a perspective view of the evaporator 154 for cooling a pod. The evaporator 154 has a clamshell configuration with a first portion 156 attached to a second portion 158 by a living hinge 160 on one side and separated by a gap 162 on the other side. Inner surfaces 168 of the evaporator 154 define a receptacle 170 for receiving a pod (e.g., pod 200). Refrigerant flows to the evaporator 154 from other components of a refrigeration system of the machine 100 (e.g., a condenser) through fluid channels 164 (shown in FIG. 10B). The refrigerant flows through the evaporator 154 in internal channels through the first portion 156, the living hinge 160, and the second portion 158. In some evaporators, the first portion 156 and the second portion 158 are mechanically separate parts that are joined together by a hinge other than a living hinge 160 (e.g., a piano hinge (see FIG. 12) or a deformable hinge (see FIG. 13). In some evaporators, the first portion and second portion are not hinged at all (e.g., two separate halves are pushed together and pulled apart by one or more motors of the machine). Some evaporators have three or more sections (e.g., between 3-10 sections) that are hinged or forced together by one or more motors of the machine.

The evaporator 154 has an open position and a closed position. In the open position, the gap 162 opens to provide an air gap between the first portion 156 and the second portion 158. The inner diameter ID of the evaporator 154 is larger in the open position than in the closed position. Pods can be inserted into and removed from the evaporator 154 while the evaporator 154 is in its open position. Transitioning the evaporator 154 from its open position to its closed position after a pod is inserted tightens the evaporator 154 around the outer diameter of the pod to clamp the pod in place and limit rotational and axial movement of the pod via friction. For example, the machine 100 is configured to use pods with a 2.085 inches outer diameter. The evaporator 154 has an inner diameter of 2.115 inches in the open position and an inner diameter inner diameter of 2.085″ in the closed position. Some machines have evaporators sized and configured to cool other sized and shaped pods (e.g., frustoconical).

The closed position of evaporator 154 improves heat transfer between an inserted pod 200 and the evaporator 154 by increasing the contact area between the pod 200 and the evaporator 154 and reducing or eliminating an air gap between the sidewall 208 of the pod 200 and the inner surface of the evaporator 154. In some pods, the pressure applied to the pod by the evaporator 154 is opposed by the mixing paddle, pressurized gases within the pod, or both to maintain the casing shape of the pod. This ensures mechanical contact between the evaporator, the sidewall of the pod, and the mixing paddle to improve heat transfer while the evaporator 154 cools the pod and while the mixing paddle mixes the ingredients within the pod. In some examples, the portion of the evaporator in contact with the pod, the sidewall of the pod, and the mixing paddle are formed of the same material so that thermal expansion is the uniform across the evaporator, mixing paddle, and pod during the cooling and mixing process. In some examples, the evaporator, mixing paddle, and pod are all formed of one or more aluminum alloys for this purpose.

Machine 150 includes an evaporator motor 166 that is mechanically coupled to the evaporator 154 and rotates a bolt 174 to move the evaporator 154 between its open and closed configuration. Some machines include an evaporator motor that is directly attached to the evaporator 154 and bolt 174. The evaporator motor 166 controls the closure of the evaporator 154 against the bias of two springs 172 to provide a closure force against the pod 200 of approximately 10-50 lbf (pound-force) and an approximate torque clamping force of 1,000 to 1,500 ozf-in. In some examples, the evaporator motor 166 uses a feedback control system to know when the evaporator has reached the closed configuration. For example, when the voltage and/or current of the evaporator motor 166 reaches a threshold, the evaporator motor 166 determines that evaporator 154 is in the closed configuration and locks the evaporator 154 at the current position to maintain the clamping pressure on the pod 200. Some machines use a hard-stop system where the evaporator motor 166 stops when the evaporator reaches a particular amount of closure. Instead of an evaporator motor 166, some machines use “wedge system” such that a manual force applied by the user (e.g., when the sliding lid 102 is closed or when the pivoting lid 152 is closed) forces the evaporator 154 into the closed position (and vice versa).

FIG. 12 is a perspective view of an evaporator 311 that includes a piano hinge 301 instead of a living hinge. In some cases, using a piano hinge 301 reduces fatigue failure that can occur in the living hinge due to repeated open and close cycles. In evaporator 311, each half of the evaporator is fluidly disconnected from each other such that each half of the evaporator has an inlet and an outlet port (not shown in FIG. 12).

FIG. 13 is a perspective view of an evaporator 315 that includes a resilient or deformable hinge 303 instead of a living hinge. In some cases, using a deformable hinge 303 allows a highly resilient metal (e.g., spring steel) to be used for the deformable hinge 303 while the remainder of the evaporator is formed of aluminum (e.g., to match the body of the pod and the mixing paddle). It also focuses any failures to the discrete hinges 303 which can be easily replaced without having to discard or rework the entire evaporator (which may be the case if the living hinge failed). Similar to evaporator 311, in evaporator 315, each half of the evaporator is fluidly disconnected from each other such that each half of the evaporator has an inlet and an outlet port (not shown in FIG. 13).

In some examples, the feedback control system of the evaporator motor 166 is used to calibrate the evaporator closure and ensure that evaporators 154 close to the same fixed inner diameter upon every closure cycle. In one example, the feedback control system is used to determine the fully closed position of the evaporator 154, i.e., the smallest inner diameter. The evaporator 154 is then moved by the evaporator motor 166 to the fully open position, i.e., the largest inner diameter, and an encoder used to determine the number of counts between the fully closed and fully opened positions of the evaporator 154, which may correspond to rotations of the bolt 174. A calibration plug with a predetermined diameter approximating that of a pod (e.g., pod 200) is then inserted into the evaporator cavity of the evaporator 154 while the evaporator 154 is in the fully open position, and the feedback control system of the evaporator motor 166 is used again to determine the closed position of the evaporator 154, this time when closed on the plug (the calibrated close position).

The inner diameter of the evaporator 154 in the calibrated close position generally falls between the inner diameter of the evaporator 154 in the fully open position and the inner diameter of the evaporator 154 in the fully closed position. The encoder is used to determine the number of counts between the fully closed position and the calibrated close position. This data serves as a basis for opening and closing the evaporator 154 to fixed (e.g., constant) and repeatable inner diameters when operating the machine. This process is particularly useful for improving machine-to-machine reproducibility with evaporators 154 of slightly varying bore sizes.

In some machines, the feedback control system of the evaporator 154 monitors electrical current level of the evaporator motor 166 as the evaporator 154 reaches the closed positon to determine the travel limit of the evaporator 154. In some examples, an increase in electrical current corresponds to an increase in mechanical force applied to the pod 200. For example, the machine 100 measures the electrical current drawn by the evaporator motor 166 over time and compares this measured current to a current threshold. If the electrical current threshold is reached, then the machine 100 determines that the evaporator 154 has reached the closed position and controls the evaporator motor 166 to limit (or stop) closing the evaporator 154 to avoid crushing the pod 200 within the evaporator 154.

In some machines, the feedback control system of the evaporator 154 monitors the rotational velocity (RPM) of the evaporator motor 166 as the evaporator 154 reaches the closed positon to determine the travel limit of the evaporator 154. In some examples, a decrease in rotational velocity corresponds to an increase in mechanical force applied to the pod 200. For example, the machine 100 measures the rotational velocity at an output shaft of the evaporator motor 166 over time using an encoder and compares this measured rotational velocity to a velocity threshold. If the rotational velocity decreases below a rotational velocity threshold, then the machine 100 determines that the evaporator 154 has reached the closed position and controls the evaporator motor 166 to limit closing the evaporator 154 to avoid crushing the pod 200 within the evaporator 154.

In some examples, it is desirable that the evaporator 154 be shut and holding the pod 200 in a tightly fixed position before the sliding lid 102 closes or pivoting lid 152 closes and the drive shaft lowers to engage the mixing paddle 250 of the pod 200. This positioning can be important for shaft-mixing paddle engagement.

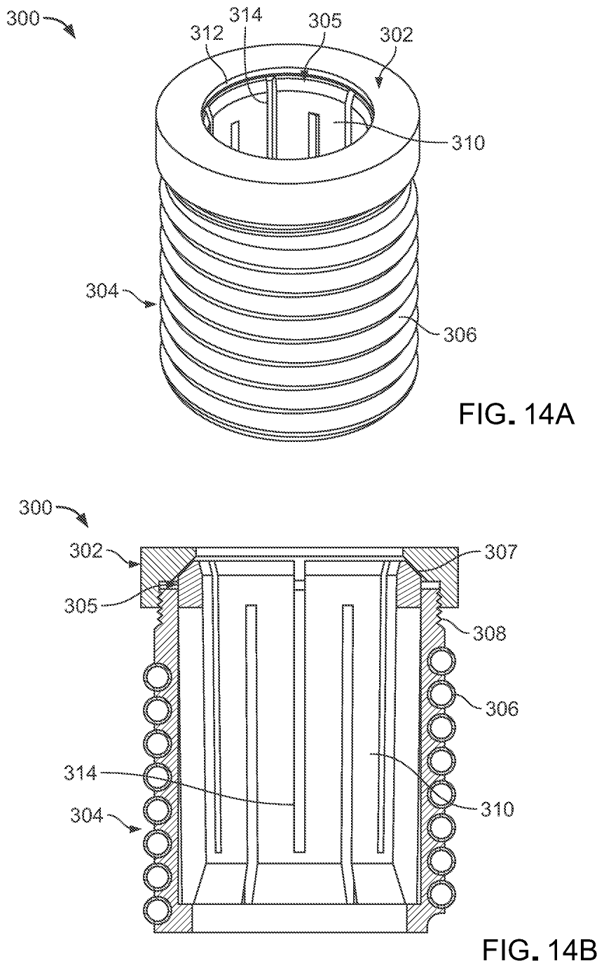

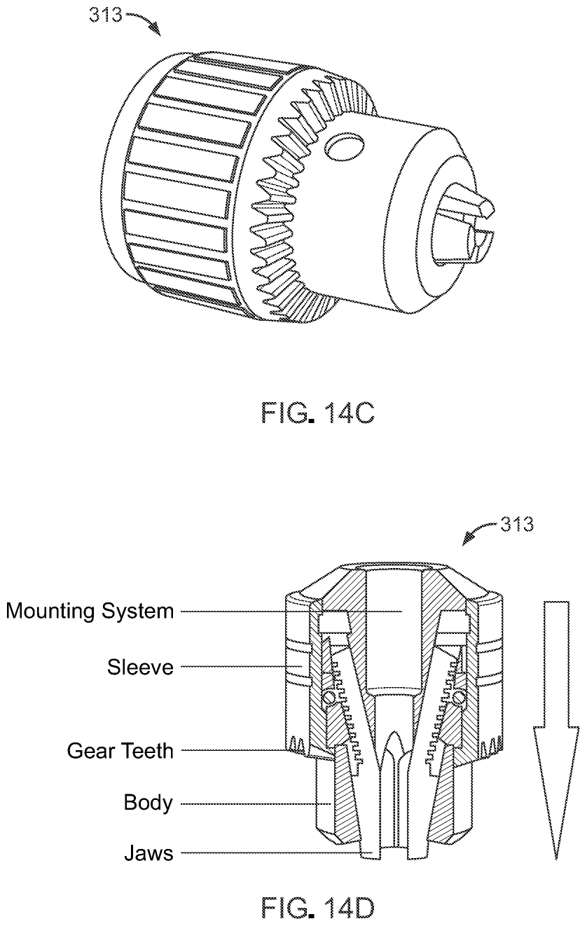

FIGS. 14A and 14B are views of a collet evaporator 300. In some cases, evaporator 154 encounters fatigue issues at the living hinge 160 and/or simply due to repeatedly opening and closing the evaporator during the life cycle of the machine. Some machines include the collet evaporator 300 instead of evaporator 154 to reduce fatigue issues. In some examples, the collet evaporator 300 functions like a collet device to secure a drill bit to a drill or to an end mill. In some examples, the collet evaporator 300 functions like the drill chuck 313 shown in FIGS. 14C and 14D.

Collet evaporator 300 includes three parts—an upper part 302, a lower part 304, and a collet 305. The lower part 304 is formed of metal (e.g., aluminum) and includes a helical recess to receive a helical refrigerant channel 306 (e.g., a copper tube) that spirals around the outer periphery of the lower part 304. The lower part 304 includes one or more threads 308 for threadably receiving one or more threads of the upper part 302. The upper part 302 is screwed into the lower part 304. An end portion of the collet 305 engages an annular ramped surface 307 of the upper part 302 to couple axially movement of the upper part 302 and the collet 305. The collet 305 includes an expanding/contracting portion 310 formed of metal (e.g., aluminum or stainless steel). The expanding portion 310 is flexible due to axial slits 314 on diametrically opposite sides.

A user inserts a pod 200 through the opening 312 of the upper part 302 and pushes the pod through the expanding portion 310 of the collet 305 into a position completely inside the upper part 302. The evaporator motor is repurposed to rotate the upper part 302 into the lower part 304 once the pod 200 is inserted into the upper part 302. The evaporator motor continues to drive the upper part 302 into the lower part 304 until torque, voltage, or current reaches a predetermined threshold. At this point, the expanding/contracting portion 310 radially contracts to generate a large frictional fit with the tapered sidewall 208 of the pod 200 to hold the pod 200 in place within the collet evaporator 300. The evaporator motor stops rotation of the upper part 302 relative to the lower part 304 and locks the pod 200 in place due to this friction. During a freezing cycle, the machine controls refrigerant to flow through the refrigerant channel 306 to exchange heat between the refrigerant and the pod to cool the ingredients within the pod to produce the food or drink.

Some systems include a multi-step clamping system due to a change of internal pressure in the pod during the process of making the cooled food or drink. In some of these systems, the evaporator clamps a first time when the pod is under positive pressure due to the pressurized gas in the pod (e.g., before the freezing cycle). During the freezing cycle, a vent port in the pod 200 opens to release the pressurized gas. When the gas is released, the pressure in the pod may drop substantially which can cause the sidewall 208 of the pod 200 to at least partially break free of the grip by the evaporator. The resulting air gap can interfere with heat transfer.

The machine controls the evaporator to release the grip and re-clamp on the pod again. This second clamp typically will eliminate any gap between the pod and the evaporator due to the change in internal pressure in the pod. This approach addresses the phenomena that the walls of the pod sometimes bulge slightly outwards when the pod is under positive pressure. As the pressurized gas is released, the pod may shrink to a smaller diameter causing the outer diameter of the pod to pull away from the inner surface of the evaporator. The clamp-and-release approach can reduce or eliminate such air gaps. Some machines control the evaporator to clamp the first time, and when the gas is released, the evaporator clamps further without releasing and then re-clamping.

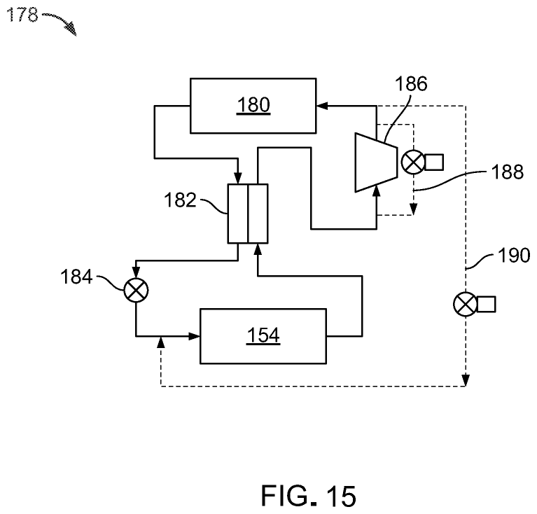

FIG. 15 is a schematic of a refrigeration system of machine 100. Additional refrigeration systems for machine 100 are described in more detail in U.S. patent application Ser. No. 16/459,388 (attorney docket number 47354-0006001) filed Jul. 1, 2019, U.S. patent application Ser. No. 16/824,616 (attorney docket number 47354-0036001) filed Mar. 19, 2020, and U.S. patent application Ser. No. 17/335,891 (attorney docket number 47354-0037001) filed Jun. 1, 2021, all of which are incorporated herein by reference in their entirety.

Refrigeration system 178 includes the evaporator 154, a condenser 180, a suction line heat exchanger 182, an expansion device 184, and a compressor 186. The expansion device 184 can include a valve or a capillary tube both of which could be used in the refrigeration system 178. High-pressure, liquid refrigerant flows from the condenser 180 through the suction line heat exchanger 182 and the expansion device 184 to the evaporator 154. The expansion device 184 restricts the flow of the liquid refrigerant fluid and lowers the pressure of the liquid refrigerant as it leaves the expansion device 184. The low-pressure liquid then moves to the evaporator 154 where heat is absorbed from a pod 200 and its contents in the evaporator 154 changes the refrigerant from a liquid to a gas. The gas-phase refrigerant flows from the evaporator 154 to the compressor 186 through the suction line heat exchanger 182. In the suction line heat exchanger 182, the cold vapor leaving the evaporator 154 pre-cools the liquid leaving the condenser 180. The refrigerant enters the compressor 186 as a low-pressure gas and leaves the compressor 186 as a high-pressure gas. The gas then flows to the condenser 180 where heat exchange cools and condenses the refrigerant to a liquid.

The refrigeration system 178 optionally includes a first bypass line 188 or valve and second bypass line 190 or valve. The first bypass line 188 directly connects the discharge of the compressor 186 to the inlet of the compressor 186. Disposed on both the first bypass line and second bypass line are bypass valves that open and close the passage to allow refrigerant bypass flow. Diverting the refrigerant directly from the compressor discharge to the inlet can provide evaporator defrosting and temperature control without injecting hot gas to the evaporator 154. The first bypass line 188 also provides a means for rapid pressure equalization across the compressor 186, which allows for rapid restarting (i.e., freezing one pod after another quickly). The second bypass line 190 enables the application of warm gas to the evaporator 154 to defrost the evaporator 154. The bypass valves may be, for example, solenoid valves or throttle valves. An additional bypass valve can be used (not shown) to direct warm air along the length of the mixing paddle 250 to help remove product sticking to the mixing paddle 250.

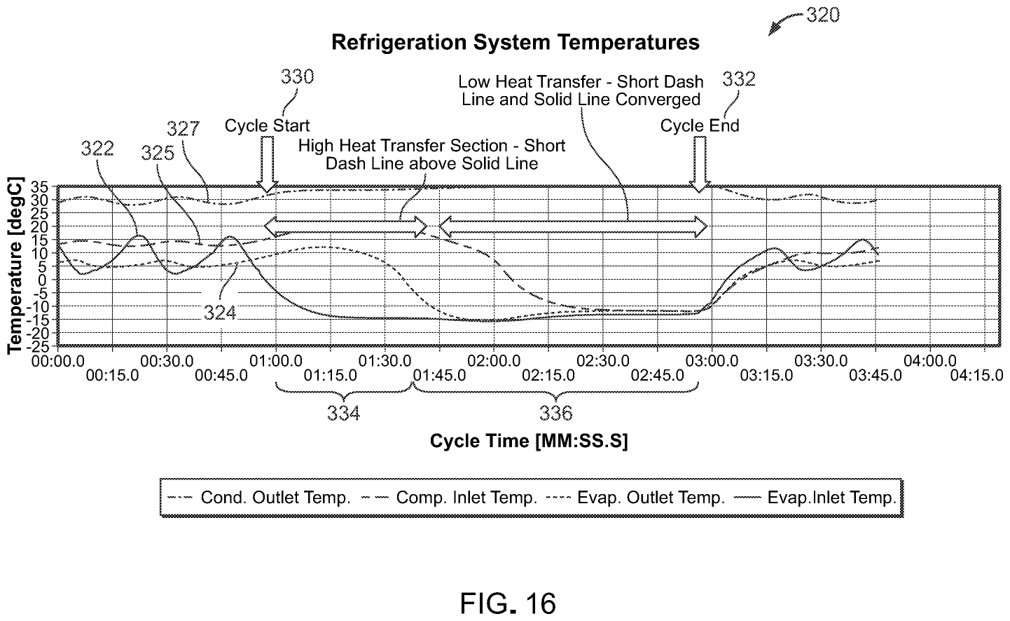

FIG. 16 is a plot of machine performance during a freezing cycle 320. The plot indicates condenser outlet temperature 327, compressor inlet temperature 325, evaporator outlet temperature 324, and evaporator inlet temperature 322 as a function of time. Specifically, FIG. 16 shows the machine performance for a duration of about 4 minutes and 15 seconds. The freezing cycle 320 begins at about 1 minute (marker 330) and ends at about 3 minutes (marker 332). During the freezing cycle 320, refrigerant flows through the evaporator 154 exchanging heat from the ingredients within the pod to the refrigerant while the pod 200 is placed in the evaporator 154. This causes temperature differences between the evaporator inlet and the evaporator outlet.

The first portion 334 of the freezing cycle 320 indicates high heat transfer (e.g., as the ingredients are quickly cooled). The second portion 336 of the freezing cycle 320 indicates low heat transfer (e.g., because the ingredients have already been cooled as indicated by the substantial decrease of the evaporator outlet temperature 324). During the second portion 336, the evaporator outlet temperature 324 and the evaporator inlet temperature 322 substantially converge. In some cases, this means that liquid refrigerant passes through the evaporator 154 and reaches the compressor 186 which is sometimes referred to as flood back. Machine 100 strikes a balance between cooling the pod as quickly as possible while reducing wear and tear on the compressor 186 by tolerating some flood back.

In some refrigeration systems, a capillary tube controlled cooling system cannot adjust for large changes in heat load. For example, in portion 334 the high heat transfer leads to high evaporator superheat and, in some cases, it is difficult for the machine to keep up with the heat transfer needed. In portion 336, the low heat transfer leads to low or no evaporator superheat as explained in the preceding paragraph.

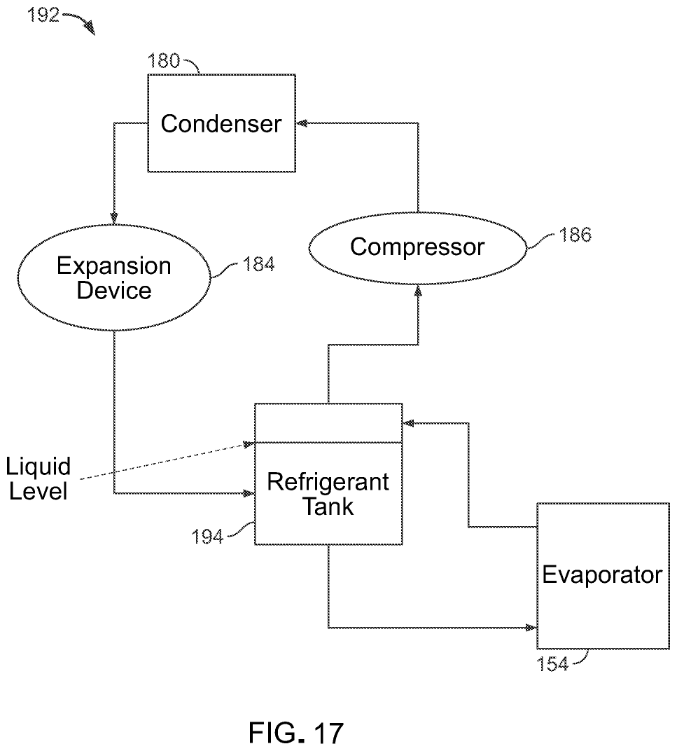

FIG. 17 is a schematic of a refrigeration system for machine 100 that includes a refrigerant tank. The machines described in this disclosure include refrigeration systems that include any combination of features described with reference to any of the disclosed refrigeration systems. In some examples, the machines use any combination of features of refrigeration system 178 and 192. Refrigeration system 192 is similar to refrigeration system 178 except that refrigeration system 192 includes a refrigerant tank 194 connected to the expansion device 184, the evaporator 154, and the compressor 186. The refrigerant tank 194 is fed by the expansion device 184 and refrigerant gas is drawn from the refrigerant tank 194 by the compressor 186. The refrigerant tank 194 is placed within the machine 100 such that the liquid level of the refrigerant tank 194 is higher (e.g., against gravity) than the evaporator 154. This means that the evaporator 154 will be filled with refrigerant. This flow arrangement has lower pressure drop (allowing higher flowrates and higher performance) since the compressor 186 does not need to push refrigerant through the evaporator 154. The evaporator 154 is gravity fed from the refrigerant tank 194. Refrigeration system 192 maintains a constant supply of refrigerant to boil off and freeze food or drink because the evaporator 154 is always flooded. This increase performance in the early part of a freezing cycle.

In some systems, the refrigeration system cools the pod with a compressor using a two-phase refrigerant fluid, such as R1270, R134A, R22, R600a, or R290. In some systems the compressor is a reciprocating compressor or a rotary compressor. Some machines use a cylindrical reciprocating compressor because it fits in the housing of the machine better. Direct Current (DC) compressors with a variable motor speed allow for increased displacement towards the beginning of the refrigeration cooling cycle of the pod (e.g., first 45 seconds of cooling the pod) and slow down the motor speed towards the end of the cooling cycle of the pod in order to increase the efficiency of the freezing process while maintaining the pressure drop. In some systems, the DC compressor can have a variable motor speed that is adjusted depending on the load on the machine's refrigeration cycle.

Some machines described in this disclosure have a compressor that is selected based on the maximum current draw permitted in most modern residential or commercial kitchens or pantries. For example, most modern outlets provide 115 volt and 20 amp service to counter top devices and some older kitchen outlets provide 115 volt and 15 amp service to counter top devices. Some machines use the most powerful compressor possible to achieve the lowest freeze times possible while avoiding current draw over the maximum current draw permitted in these typical outlets (e.g., to avoid tripping electrical circuits). In some examples, the compressor draws 13 amps maximum so that the machine can be powered via a standard wall outlet.

Some machines use compressors having a displacement between 10 and 50 cc. For example, some machines use a 13.5 cc compressor, a 16.8 cc compressor, a 33 cc compressor, a compressor with up to 48.6 cc displacement, or a compressor with up to 34.7 cc displacement Some machines use a capillary tube with between 0.05 and 0.07 inch ID (e.g., a 0.050 inch ID, a 0.059 inch ID, a 0.07 inch ID) and between 70 to 100 inches long (e.g., 70 inches long, 90 inches long, or 100 inches long). Some machines use these compressors to achieve a 60 second freeze time for cooled food or drink. The compressors are sized to fit within the housing of the machine, and in some machines, the housing is sized to fit on a kitchen counter and underneath kitchen cupboards.

Some machines described in this disclosure include an internal temporary power storage that accommodates any power surge produced when the machine starts up. This helps to avoid drawing current from the kitchen outlet that exceeds the maximum current draw permitted. For example, some machines include a capacitive power buffer to accommodate the start-up power draw of the compressor. When the compressor starts up, it can draw up to 40 amps, so a power storage buffer is advantageous to avoid overloading the circuit.

In order to produce consistent ice cream quality/temperatures the machine preferably detects how frozen the product is and ends the cycle at the appropriate time. The machines can use several methods for detecting the progression of the freezing process. One method for detecting progress of the freezing process is to measure the current draw or power used to turn the mixing motor. Thicker ice cream requires more current/power to mix at a given speed. This process however may not be sensitive enough, particularly for drinkable products, where the mixing motor current is relatively low. Several methods can be used to more precisely detect product quality/temperature.

One method is to use the PWM (pulse width modulation) speed signal sent to the motor. Some motors control speed by using an encoder and a closed loop motor controller to detect motor speed. For example, the controller reads the encoder speed and then sends a percent of full speed signal (PWM) to the motor to speed up or slow down to achieve the desired speed as detected by the encoder. When mixing products in the machine it is possible to mix at a fixed RPM. When mixing at a fixed RPM the load on the motor increases as the product is frozen. This increase in load requires the controller to send increasingly larger PWM values to the motor for it to maintain constant speed. The PWM value and the difference in PWM value throughout the freezing cycle are better correlated to ice cream final temperature as compared to mixing motor current.

Determining when to stop the mixing process and dispense the product is challenging. Some machines use timed cycles, where products are dispensed after a set mixing time (which varies from product to product). Some machines use torque measurements of the drive motor (e.g., drive motor 116) to determine when the product has sufficiently thickened. Some machines slow the drive motor to idle periodically and measure the deceleration of the mixing paddle (e.g., mixing paddle 250).

Typically, a more viscous product slows the mixing paddle faster, and compared to current/torque measurements, this rate of deceleration has been found to be more accurate to gauge product viscosity, which correlates with temperature. For example, in some machines (e.g., machine 100), the drive motor is controlled to “coast” for a sample interval of ˜100 mS during each second of the mixing/freezing process. During this sampling interval, software of the machine measures how much the drive motor decelerates from the starting steady state velocity based on rotational velocity measurements provided by an encoder of the machine. After the predefined sample interval completes, the drive motor resumes mixing at a fixed velocity until the next sample period. In some examples, the machine uses an algorithm with a mathematical formula to predict the temperature of the pod (e.g., pod 200 with mixing paddle 250) based on the collected velocity data for the most recent sample period and previous sample periods. Once the predicted temperature reaches the target temperature for the pod type, the machine begins the dispensing process to dispense the single serving of the cooled food or drink.

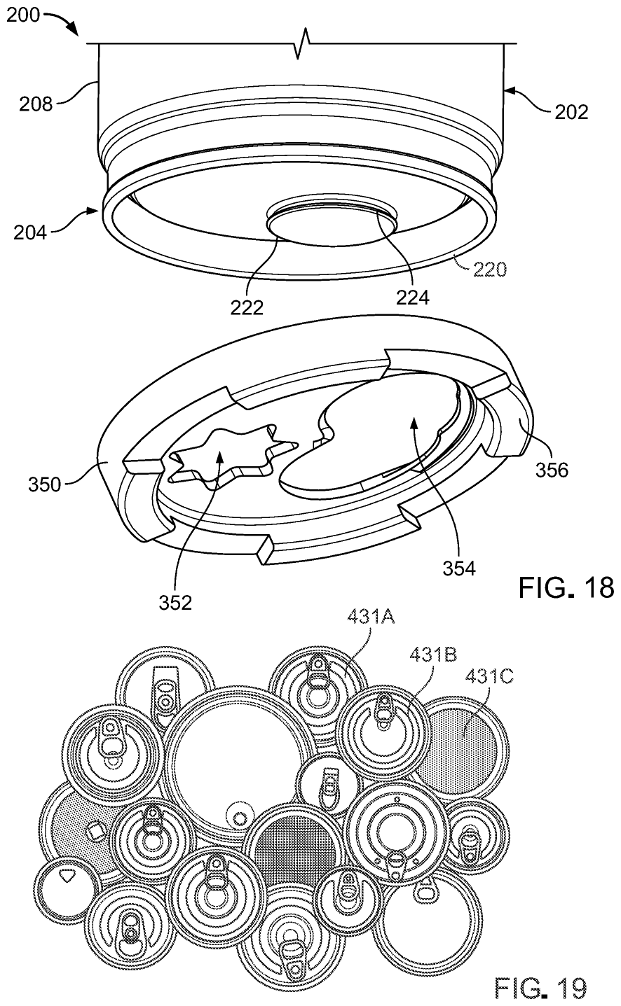

FIG. 18 is a view of a pod with a base or lid 220 attached to the first end 204 of the pod 200. The base 220 is metal (e.g., aluminum) and crimped onto the first end 204 of the pod 200 to form a fluid tight seal with the body 202 of the pod 200. The base 220 includes a removable protrusion 222 with a weakened score line 224. In this example, the removable protrusion 222 is integrally formed with the base 220. The protrusion 222 can be formed, for example, by stamping, deep drawing, or heading a sheet of aluminum being used to form the base 220. The scoring 224 can be a vertical score into the base of the aluminum sheet or a horizontal score into the wall of the protrusion 222. For example, the material can be scored from an initial thickness of 0.008 inches to 0.010 inches (e.g., the initial thickness can be 0.008 inches) to a post-scoring thickness of 0.001 inches-0.008 inches (e.g., the score thickness can be 0.002 inches). The weakened score line 224 is 0.006 inches deep into 0.008 inches thick aluminum base lid material. Other caps include a removable protrusion that is inserted into the base 220 after the base 220 is formed instead of being integrally formed with the base 220.

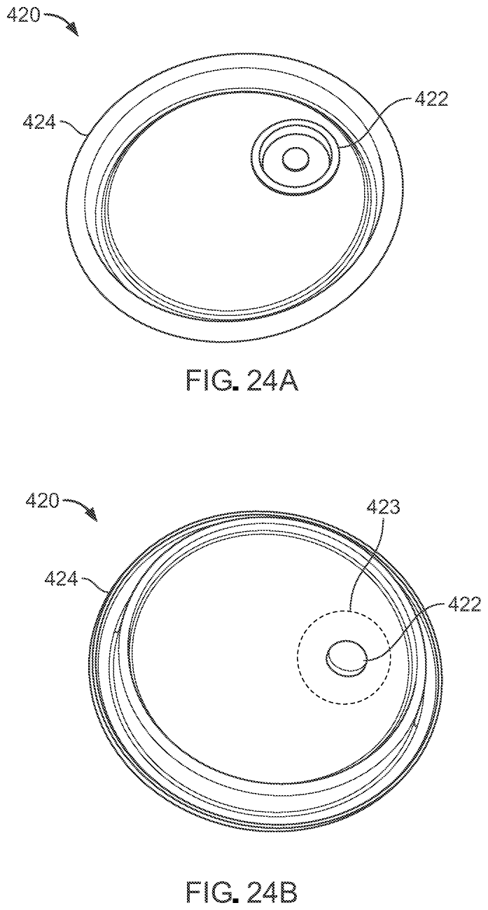

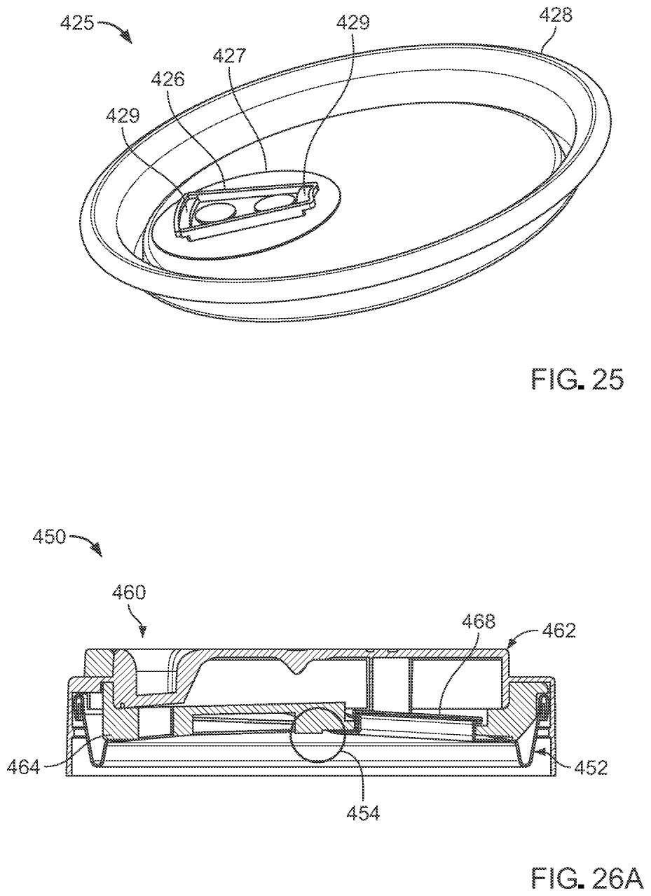

FIG. 19 is a view of example embossments of the lids described in this disclosure. For example, some lids include embossments formed in the lid to strengthen it and reduce the likelihood of doming. Some lids include embossments 431A, 431B, 431C, and/or any of the embodiments similar to the ones shown in FIG. 25.

A cap 350 is removably attached over the base 220 of the pod 200 after the base 220 is attached (for example, by crimping or seaming) to the body 202 of the pod 200. FIG. 18 shows the cap 350 spaced apart from the base 220 for ease of viewing. The machine 100 rotationally engages the cap 350 to rotate the cap 350. The cap 350 includes one or more drive lugs 356 (e.g., castellations, rooks) that axially extend from the body of the cap 350. Cap 350 has four drive lugs. The machine 100 engages with the drive lugs 356 to rotationally couple the machine to the cap 350 to rotate the cap 350 relative to the protrusion 222. The cap 350 engages with the removable protrusion 222 to shear it off of from the base 220 at the weakened score line 224 to form an opening or aperture 226 (at least partially shown in FIG. 19E) in the base 220 of the pod 200. The aperture 226 is exposed and extends through the base 220 when the protrusion 222 is removed. The machine 100 dispenses the produced food or drink from the pod 200 through the aperture 226.

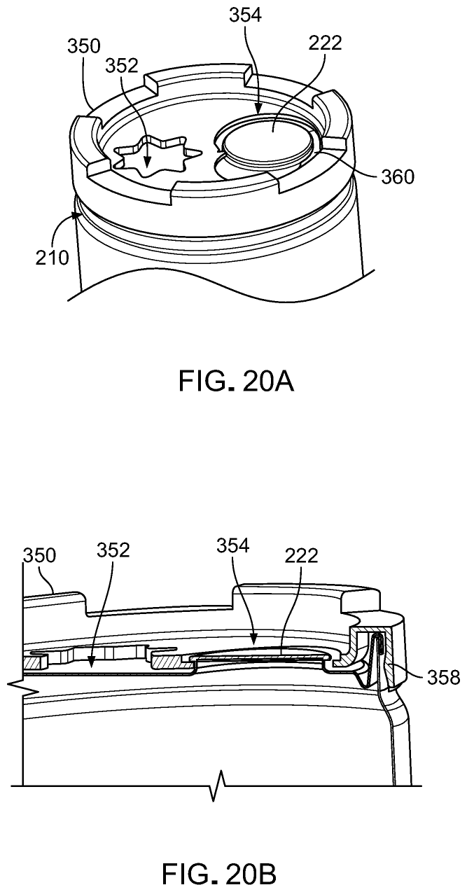

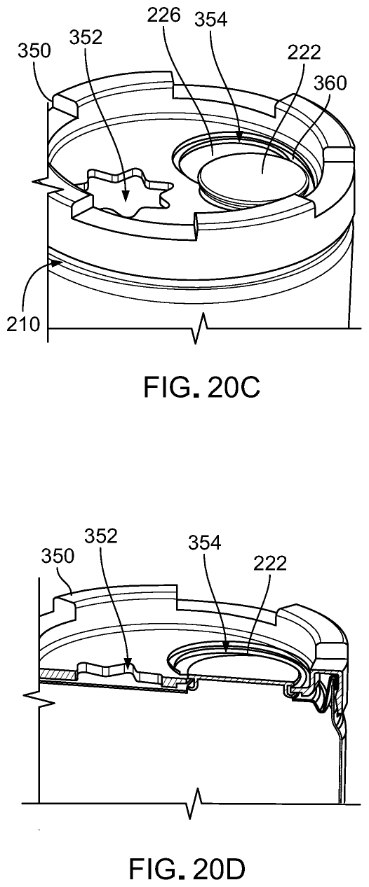

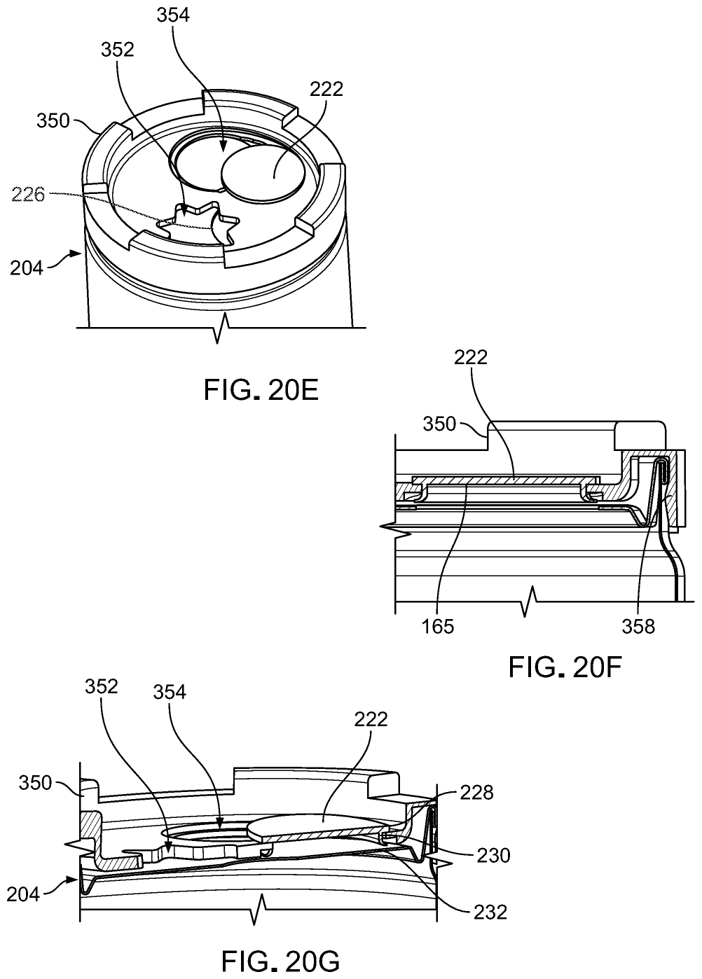

FIGS. 20A-20G are perspective views of the cap 350 attached to the base 220 of the pod 200. The cap 350 is attached to the base 220 by being retained by a radially extending inward lip 358 that circumscribes an inner surface of the cap 350. Axial movement of the cap 350 to remove the cap 350 from the pod 200 is resisted by engagement of the inward lip 358 with the pod 200.

FIGS. 20A-20G illustrate rotation of the cap 350 around the first end 204 of the pod 200 to cut and carry away protrusion 222 and expose aperture 226 extending through the base 220. In some cases, the protrusion 222 and corresponding aperture 226 when the protrusion 222 is sheared and carried away has a surface area between 5% to 30% of the overall pod end surface area.

The cap 350 has a first aperture 352 (dispensing aperture) and a second aperture 354 (shearing aperture). The first aperture 352 approximately matches the shape of the aperture 226. The second aperture 224 has a shape corresponding to two overlapping circles. One of the overlapping circles has a shape that corresponds to the shape of the protrusion 222 and the other of the overlapping circles is slightly smaller. A ramp 360 extends between the outer edges of the two overlapping circles. There is an additional 0.010 to 0.100 inches of material thickness at the top of the ramp transition (e.g., 0.070 inches). This extra height helps to lift and rupture the protrusion's head and open the aperture 226 during the rotation of the cap 350.

FIGS. 20A and 20B show the cap 350 initially attached to the base 220 with the protrusion 222 aligned with and extending through the larger of the overlapping circles of the second aperture 354. The machine 100 rotates the cap 350 relative to the pod 200 to cause the ramp 360 to slide under a lip of the protrusion 222 as shown in FIGS. 20C and 20D. Continued rotation of the cap 350 relative to the base 220 of the pod 200 applies a lifting force that separates the protrusion 222 from the remainder of the base 220 (see FIGS. 20E-20G) and then aligns the first aperture 352 of the cap 350 with the aperture 226 in the base 220 resulting from removal of the protrusion 222. Some caps have ramped features that provide a total lift height of approximately 0.075″. Some caps have ramped features that provide a total lift height in a range between approximately 0.05″ and 0.10″. In some machines, the process of removing the protrusion also removes product (frozen or not) that may accumulate within a recess of the end of the protrusion.

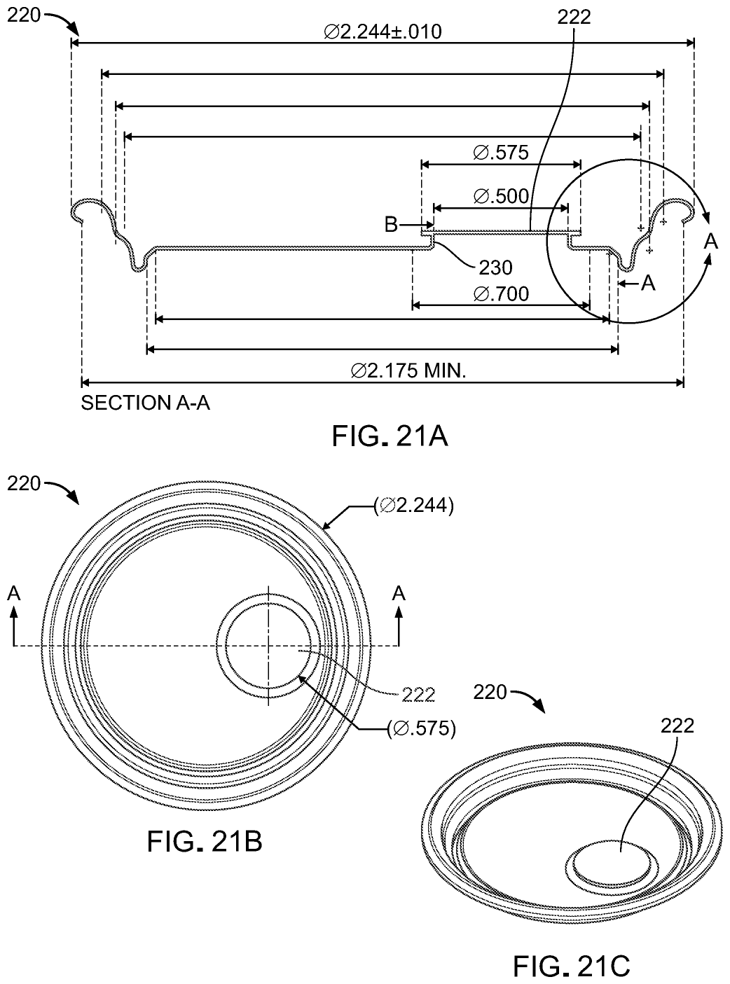

Some pods include a structure for retaining the protrusion 222 after the protrusion 222 is separated from the base 220. In the pod 200, the protrusion 222 has a head 228, a stem 230, and a foot 232 (best seen in FIGS. 20G and 21A). The stem 230 extends between the head 228 and the foot 232 and has a smaller cross-section than the head 228 and the foot 232. As rotation of the cap 350 separates the protrusion 222 from the remainder of the base 220, the cap 350 presses laterally against the stem 230 with the head 228 and the foot 232 bracketing the cap 350 along the edges of one of the overlapping circles of the second aperture 354. This configuration retains the protrusion 222 when the protrusion 222 is separated from the base 220. Such a configuration reduces the likelihood that the protrusion 222 falls into the waiting receptacle (e.g., bowl or cone) in the dispensing area 110 of the machine 100 when the protrusion 222 is removed from the base 220. After the mixing paddle 250 of the machine 100 spins and dispenses the produced food or drink through the aperture 226, a motor of the machine 100 rotates the cap 350 and closes the aperture 226 so that any residual product (e.g., left over ice cream) when melted does not leak out of the pod and contaminate the machine 100. The pods and machines described in this disclosure are designed to produce and dispense ice cream from the pod without residual product coming into contact with the machine. Machine 100 does not need to be cleaned after each use.

FIGS. 21A-21C are views of the base 220 with the integrally formed protrusion 222. In some cases, the diameter of the protrusion 222 is 0.375-0.850 inches (e.g., 0.575 inches in diameter). In some cases, an area of the protrusion 222 is 0.1-0.5 in² (e.g., 0.26 in²). In some cases, the area of the base 220 is 2.0-5.0 in² (e.g. 3.95 in²). The area of the protrusion 222 is a fraction of the total surface area of the base 220. In some cases, a diameter of the base 220 is 1.5-3.0 inches (e.g., 2.244 inches). In some cases, an area ratio of the protrusion 222 to the base 220 is 0.01-0.50 (e.g., 0.065).

In some cases, the protrusion 222 may be circular in shape, have a tear-drop, have a kidney shape, or be of any arbitrary shape. In some cases the protrusion 222 may be round but the scored shape can be either circular in shape, have a tear-drop, have a kidney shape, or be of any arbitrary shape. In some cases, there is no post-stamping scoring but rather the walls are intentionally thinned for ease of rupture. In another version, there is not variable wall thickness but rather the cap 350 combined with force of the machine dispensing mechanism engagement are enough to cut the 0.008 inches to 0.010 inches wall thickness on the protrusion 222. With the scoring, the protrusion 222 can be lifted and sheared off the base 220 with 5-75 pounds of force, for example between 15-40 pounds of force.

In some cases, the protrusion 222 is integrally formed on the base 220 using a mechanical press. This is sometimes difficult to do because it requires a high-load and high-capacity press and many sequential manufacturing operations. It also introduces cold work into the material (e.g., aluminum) which can make the material more brittle and sometimes unable to withstand the cyclical flexing caused by pressurization and de-pressurization of the pod during sterilization, transportation, and storage. Instead of an integrally-formed protrusion, some pods use a protrusion that is separately formed from the base of the pod and adhered (e.g., glued) to the base of the pod.

In some cases, a flange of the protrusion is adhered or glued to the underside of the base (e.g., the side toward the inside of the pod) and the top of the protrusion is formed in place after the glue has cured. This requires that the rivet be manufactured consistently every time and glued into the hole consistently. Additionally, the score surrounding the rivet is preferably formed with a consistent depth, which can be challenging to produce consistently.

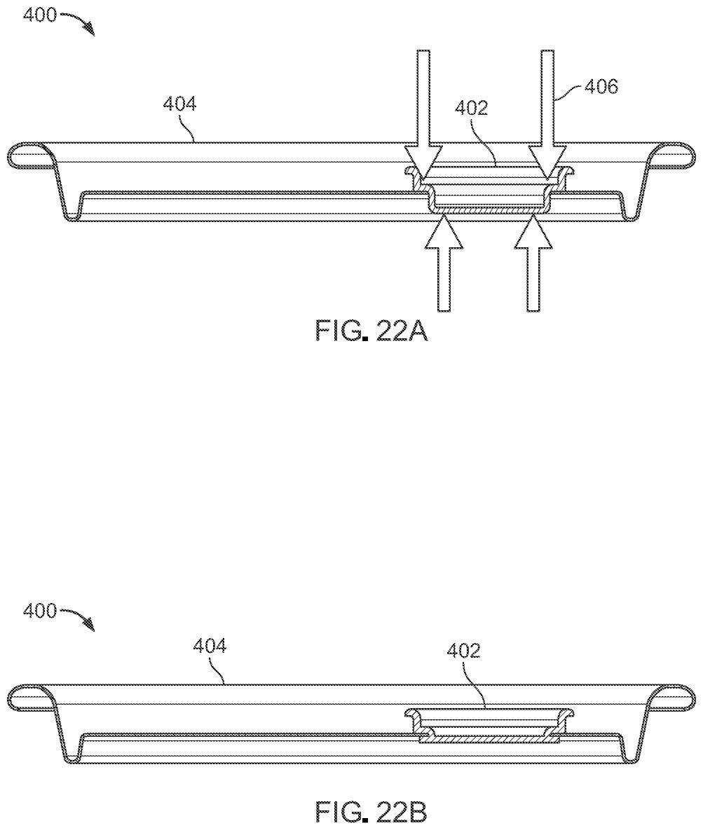

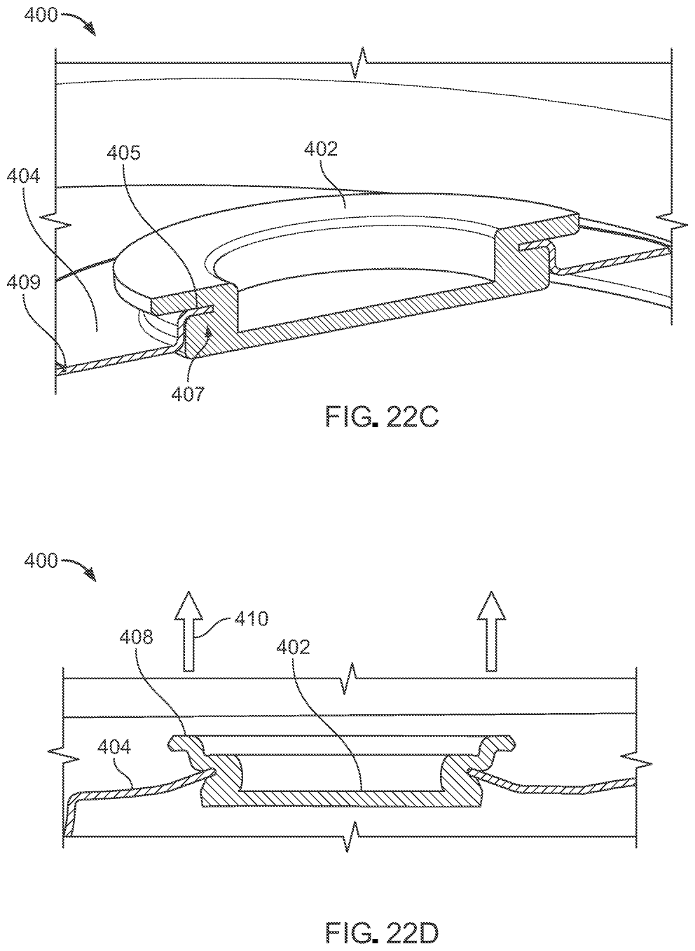

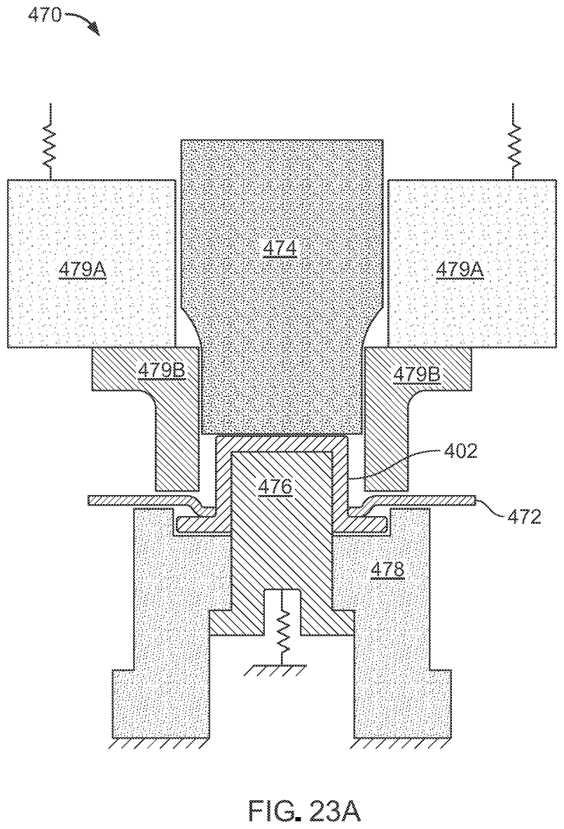

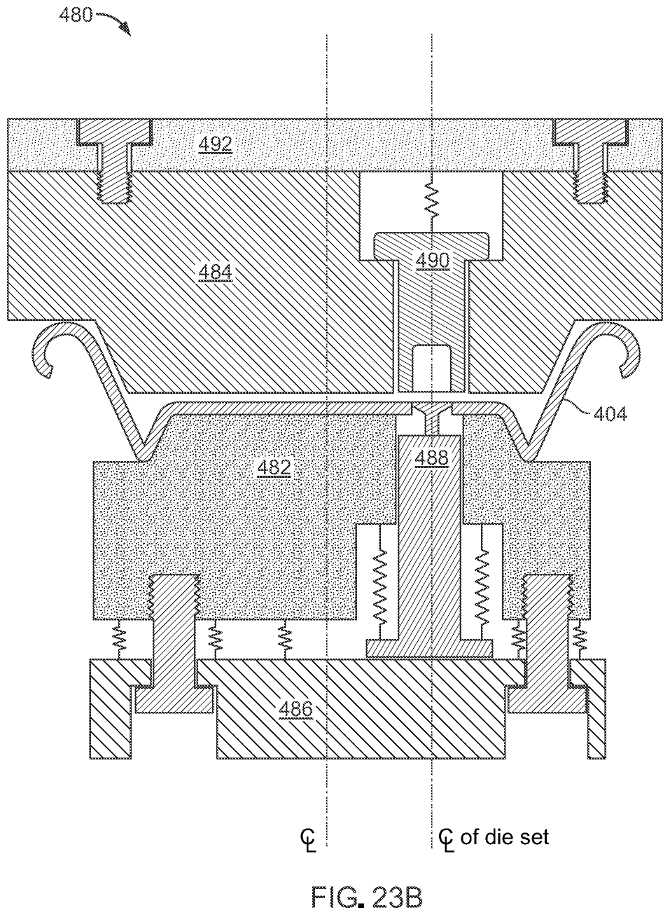

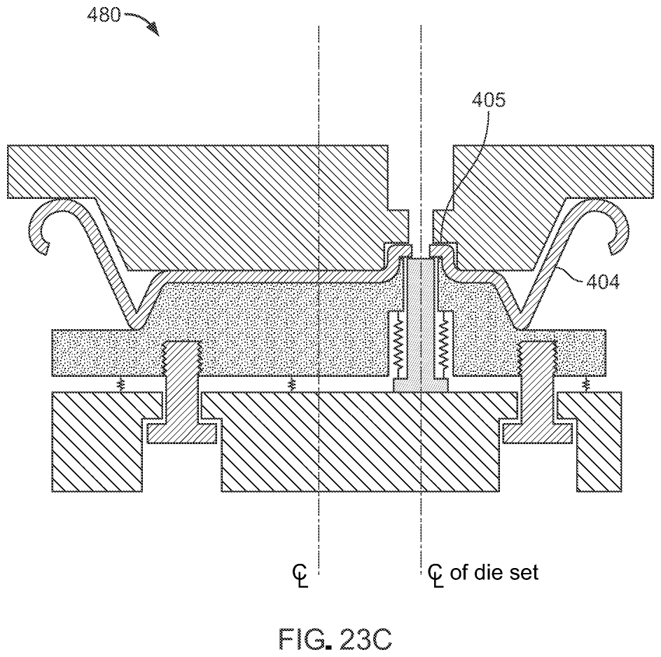

FIGS. 22A-22D are views of a clinched protrusion design 400 that is used in lieu of gluing a protrusion to a base of the pod. This design uses a mechanical pressing operation (denoted by arrows 406) to press a protrusion 402 into a lid 404 sufficiently to form a hermetic seal with the lid without using an adhesive. Further details about the forming operation as described with reference to FIGS. 23A-23C. The lid 404 is then attached to the first end 204 of the pod 200 to form the base of the pod 200 instead of base 220. FIG. 22A shows the protrusion 402 before being pressed into the lid 404 and FIG. 22B shows the protrusion 402 after being pressed into the lid 404.

FIGS. 22C and 22D are cross-section views of the lid 404 with the protrusion 402 pressed into place. In these views, the inside of the pod is towards the bottom of the figures. The lid 404 includes a weakened score line 409 that is substantially similar to weakened score line 224. The weakened score line 224 is outside the radius of the protrusion 402 and surrounds a raised surface 405 in the lid 404. In some examples, the raised surface 405 is not present and instead the lid 404 is substantially flat.

The raised surface 405 is integrally formed with the lid 404 before the protrusion 402 is pressed into place. The raised surface 405 defines a recess 407 for receiving a portion of the protrusion 402 so that the protrusion 402 is biased further away from the body of pod 200. This allows the protrusion 402 to be positioned in a similar position as protrusion 222 so that protrusion 402 can be interchanged with protrusion 222 and no change to the machine itself needs to be made. A more secure mechanical lock is formed between the lid 404 and the protrusion 402 using the raised surface 405 because a portion of the protrusion 402 is received in the recess 407 of the lid 404. In some cases, the weakened score line 224 is radially offset from the base of the raised surface 405 to increase the diameter of the aperture.

During use, when the machine 100 rotates the cap 350 relative to the lid 404, an upper lip 408 of the protrusion 402 engages the ramps 360 of the cap 350 to lift the lip 408 upward (e.g., in the direction of arrows 410) to remove the protrusion 402 and the raised surface 405 portion of the lid 404 to form an aperture for dispensing produced food or drink. In this way, protrusion 402 functions similarly as protrusion 222. A difference between protrusion 402 and protrusion 222 is that it is much easier to manufacture lid 404 and protrusion 402 reliably compared to base 220 with protrusion 222 integrally formed. Additionally, the raised surface 405 provides such a secure grip on the protrusion 402 that an adhesive (or glue) is not necessary to ensure that the protrusion 402 remains coupled to the lid 404. In comparison to the integrally formed protrusion 222, protrusion 402 may be formed of thicker stock material since it is formed independently of the lid 404 and does not rely upon stretching and thinning of the existing lid material, improving the mechanical integrity of the protrusion 402. In other examples, the protrusion 402 is pulled out of the raised surface 405 of the lid 404 instead of being torn off via the weakened score line 409.

FIG. 23A is a schematic view of a forming operation 470 of the clinched protrusion 402 and a lid 472. The lid 472 does not have a raised surface. Instead, the lid 472 is substantially flat and/or includes a recessed surface instead of a raised surface. The protrusion 402 is inserted into the tool in the profile shape shown in FIG. 23A. A die 478 supports a flange of the protrusion 402 while the protrusion 402 is formed. Punch 474 presses the top of protrusion 402 causing the protrusion 402 to move downward and simultaneously expanding outward towards tool 479B, which constrains its lateral expansion. Pin 476 is free to move downward with compression of the protrusion 402. Punch 474 is limited in its downward motion due to a diametrical expansion at taper 474A, and defines the height of the protrusion. Various other tools 479A, 479B support the punch 474 and the lid 472 during the forming operation.

FIGS. 23B and 23C are schematic views of a forming operation 480 for forming a raised surface of the lid. FIG. 23B represents the start of the forming operation and FIG. 23C represents the end of the forming operation. When formed, the lid 404 includes the raised surface 405 described with reference to FIG. 22C. The lid 404 is substantially flat in the initial stage shown in FIG. 23A. Once the raised surface 405 is formed, the protrusion 402 is clinched using the forming operation 470 described with reference to FIG. 23A. A pair of dies 482, 484 sandwich the lid 404. A lower tool 486 remains fixed in place while the pair of dies 482, 484 move downward so that the raised surface 405 is formed on the pin 488. As the portion of the lid 404 deforms, the punch 490 forms the shape of the portion of the lid 404 into the raised surface 405. An upper tool 492 supports the upper die 484.

FIGS. 24A and 24B are perspective views of a riveted protrusion design 420 where a protrusion 422 is riveted into place. As with the clinched protrusion design 400, the riveted protrusion design 420 is much easier to form than the integrally-formed protrusion 222 and is much less complicated than gluing a protrusion in place on the lid. A weakened score line 423 (schematically shown) surrounds the protrusion 422. During use, the machine 100 rotates the cap 350 so the ramps 360 engage a lip of the riveted protrusion 422 in a similar manner as protrusions 222 and 402. This engagement causes the riveted protrusion 422 and a portion of the lid 424 inside the area of the weakened score line 423 to detach from the lid 424 leaving an opening for cooled food and drink to be dispensed from the pod 200. In some cases, the protrusion 422 is a pre-formed rivet.

The clinched protrusion design 400 and the riveted protrusion design 420 have numerous advantages compared to an integrally-formed protrusion (e.g., protrusion 222). First, the protrusions are formed in a separate manufacturing operation which allows them to be designed with more complicated sizes and shapes. For example, the protrusion does not need to be round, which benefits registering and aligning the protrusion in the shear mechanism. In some cases, the protrusion is shaped as a ski-type feature for increased lift. Example ski-type features as described with reference to FIG. 25. Second, since the base itself does not need to undergo a large cold-work press operation, the material of the base preserves strength and integrity. Third, the manufacturing operations for forming the protrusion separately and then performing a riveting operation are considerably simpler.

FIG. 25 is a perspective view of a ski-type protrusion design 425 where a protrusion 426 is coupled to the surface of a lid 428 of a pod (e.g., pod 200). In some examples, the protrusion 426 is coupled to the lid 428 via pressing, clinching, riveting, or adhering. A weakened score line 427 surrounds the protrusion 426. During use, the machine 100 rotates a cap (e.g., cap 350) so the ramps 360 of the cap 350 engage each of two lips 429 of the ski-type protrusion 426 in a similar manner as protrusions 222 and 402. This engagement causes the ski-type protrusion 426 and a portion of the lid 428 inside the area of the weakened score line 427 to detach from the remainder of the lid 428 leaving an opening for cooled food and drink to be dispensed from the pod 200.

A difference of the ski-type protrusion 426 compared to protrusions 222, 402, and 422, is that the lips 429 are shaped to match the curvature of the ramps 360 of the cap 350. For example, the lips 429 are arced to match the ramps 360 and increase the contact area between the protrusion 426 and the ramps 360. This increases reliability of the shearing process. The ski-type protrusion 426 is also an example of a non-circular protrusion. Specifically, the ski-type protrusion 426 is shaped as a truncated wedge.

Some pods include other protrusion designs and other approaches for separating the protrusion from the base of the pod. For example, in some pods, the base has a rotatable cutting mechanism riveted to the base. The rotatable cutting mechanism has a shape similar to that described relative to cap but this secondary piece is riveted to and located within the perimeter of base rather than being mounted over and around base. When the refrigeration cycle is complete, the processor of the machine activates an arm of the machine to rotate the riveted cutting mechanism around a rivet. During rotation, the cutting mechanism engages, cuts, and carries away the protrusion, leaving the aperture of base in its place.

Some pods are pressurized to have an internal pressure of around 5-100 psi gauge pressure. In some examples, the pod is filled with between 10-20 psi of overpressure. For example, when the pod is filled, the pod is dosed with an inert gas (e.g., nitrogen) which pressurizes the pod and causes an outward bulge in the base of the pod. Due to these pressures, the base of the pod tends to bow outward after the pod is filled and pressurized. This can cause an engagement issue with the ramped features of the cap and can potentially lead to the protrusion being removed prematurely or not being removed at all.

To complicate the issue, the pod further undergoes a sterilization process that subjects the pods to high temperatures and additional cyclical pressure changes in a retort chamber due to differential pressures between the pod interior and the surrounding retort environment. In some cases, this results in additional outward bowing of the base. When the pod is then inserted into the machine 100 and the drive shaft engages the drive head of the mixing paddle, a seal of the pod is broken and the pressurized nitrogen gas contained within the pod escapes from the pod, at least partially relaxing the base. Differences in curvature between a curved base and a flat shearing cap can present a mismatch/misalignment that can interfere with the protrusion being sheared properly.

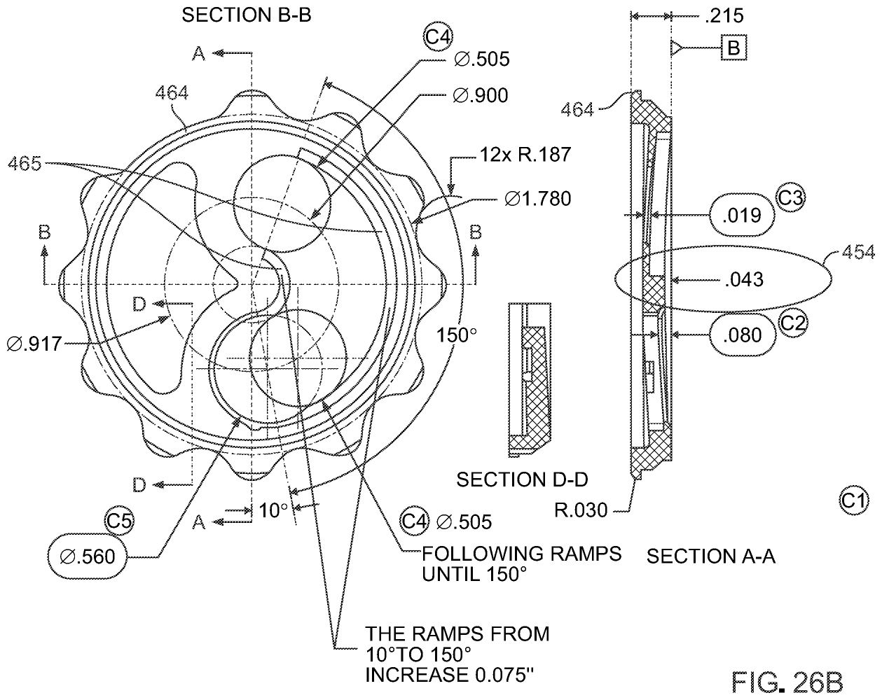

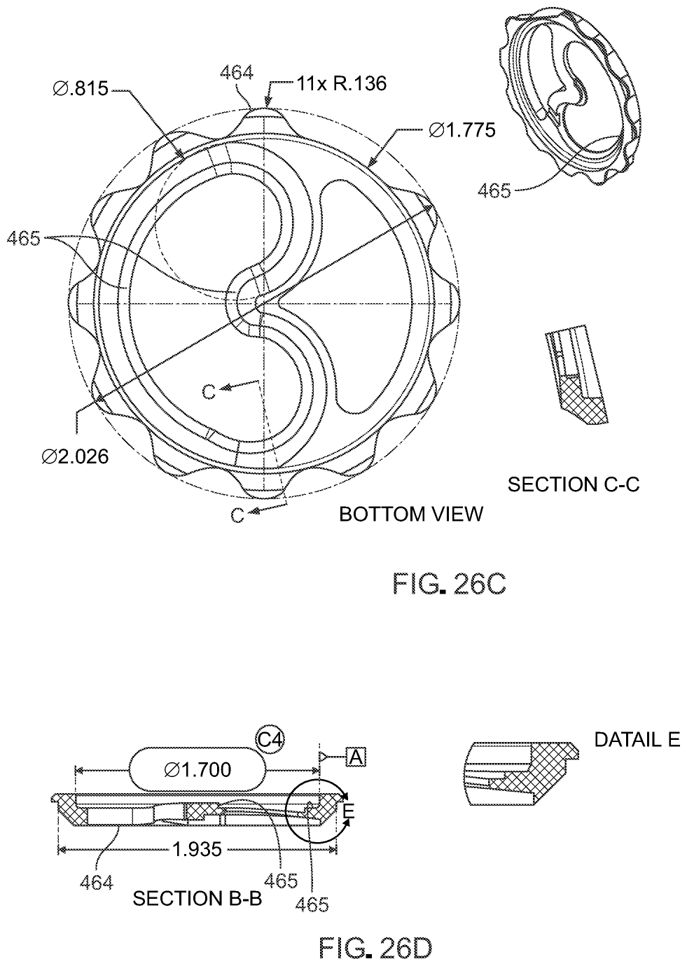

FIGS. 26A-26D are views of a domed cap assembly 450. The domed cap assembly 450 includes a shearing cap 460. The cap 460 includes a body 462 and a domed insert 464 rotationally coupled to the body 462 of the cap 460. The domed insert 464 includes a domed ramp 465 that is sized to engage the protrusion of the base of the pod when the base is domed into a similar shape as the domed insert 464.

The domed insert 464 is manufactured with a domed shape representing an expected dome shape of the base of the pod after the pod is pressurized by nitrogen (e.g., after liquid nitrogen is dosed into the pod and the pod is sealed). For example, initially the base 452 of a pod (e.g., substantially the same as base 220 of pod 200) is substantially flat or planar. When the pod is dosed with liquid nitrogen and the base is attached to the body of the pod (e.g., by crimping) to seal the contents of the pod, the pod becomes internally pressurized by an expansion of the nitrogen as it warms to room temperature. When the domed shearing cap 460 is used, the base 452 bows from its initial flat shape to a final bowed shape that approximately matches the pre-domed shape of the domed insert 464. As a result, when the base 452 and domed insert 464 are in contact with each other as shown in FIG. 26A, the perhaps angled and/or deformed protrusion 468 engages the domed ramps 465 of the domed insert 464 which provides a better and more reliable engagement than if a flat cap and ramps were used instead of the domed shearing cap 460.

FIG. 26A shows the base 452 before it is attached to a pod (e.g., the body of a pod is not shown in FIG. 26A) and while it is in contact with the domed insert 464 of the domed shearing cap 460. FIGS. 26B-26D are engineering drawings of the domed insert 464. The central region 454 of the domed insert 464 is domed by about 0.043 inches (e.g., between 0.040 and 0.045 inches) but can be domed to other dimensions to match the bowed base 452 depending on the pressurization level of the pod. The insert 464 is formed of metal (e.g., Aluminum 6061-T6 alloy) and, in some cases, is anodized (e.g., MIL-STD-8625 Type II clear coating).

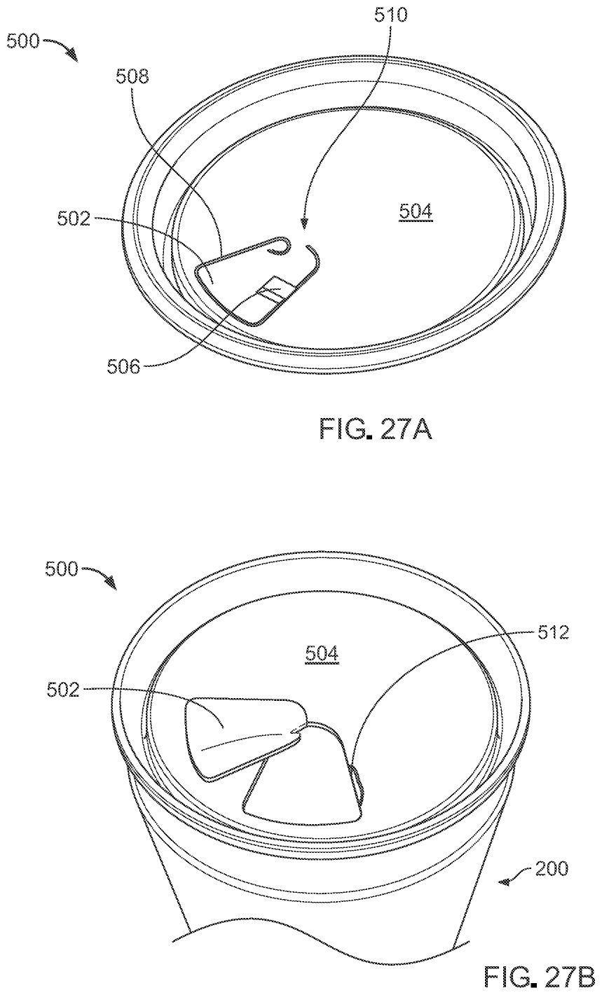

FIGS. 27A-27E are views of peel-back lid design 500 that includes a surface 502 (or tab) that is “peeled-back” instead of a protrusion that is sheared off completely. The surface 502 is integrally formed on a lid 504 for the pod 200. The surface 502 is substantially flat except for a raised protrusion 506 located on one side of the surface 502. The surface 502 is at least 75% surrounded by a weakened score line 508. A small non-scored region 510 keeps the surface 502 attached to the lid 504 and retains the surface 502 on the lid 504 so the surface 502 does not completely detach from the lid 504 and fall into the pod or into the dispensed product. The surface 502 is biased to one side of the lid 504.

FIG. 27B is a view of a pod 200 with the lid 504 attached to the end of the pod 200. The surface 502 is shown in the peeled-back state to define an aperture 512 for dispensing produced food or drink from the pod 200. The surface 502 is bent and resides on the outside of the pod 200. This is in contrast to traditional beverage cans where a tab is pushed into the can—not out of the can.

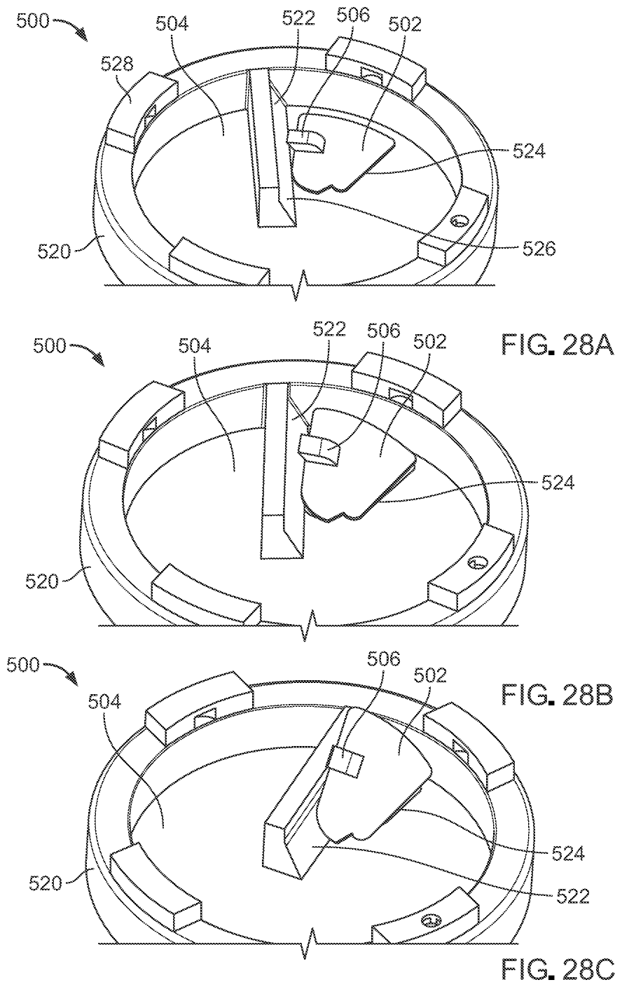

FIGS. 28A-28C are a sequence of views showing a cap 520 attached to the pod 200 that has the lid 504 attached. The cap 520 is substantially similar to cap 350 except that instead of having ramps 360 that engage the protrusion 222 to shear it off, cap 520 includes a raking surface 522 that engages the raised protrusion 506 to peel it back. The raking surface 522 is integrally formed with the body of the cap 520. The raking surface 522 is angled at a 60 degree angle relative to the plane of the lid 504. Some caps have a raking surface that is angled between 45 degrees and 80 degrees relative to the plane of the lid 504. The machine 100 rotates the cap 520 relative to the lid 504 to cause the raking surface 522 to engage the raised protrusion 506. The raking surface 522 includes a sharp edge 526 on the bottom that rides along the lid 504. The sharp edge 526 is a knife edge to assist in breaking or slicing the weakened score line 508 as the cap 520 rotates relative to the lid 504.

FIGS. 28A-28C each represent a different angular orientation of the cap 520 relative to the lid 504. FIG. 28A shows the surface 502 in its initial position where it seals the pod and there is no opening on the lid 504. FIG. 28B shows the raking surface 522 engaging the raised protrusion 506 to lift the surface 502 into a first intermediate position where the pod is partially open. The surface 502 pivots open on an axis 524 located on the side opposite to the raised protrusion 506. FIG. 28C shows the raking surface 522 engaging a portion of the surface 502 to further lift the surface 502 into a second intermediate position. The cap 520 continues to rotate relative to the lid 504 until the surface 502 is completely folded back on the lid 504 like the position shown in FIG. 27B.

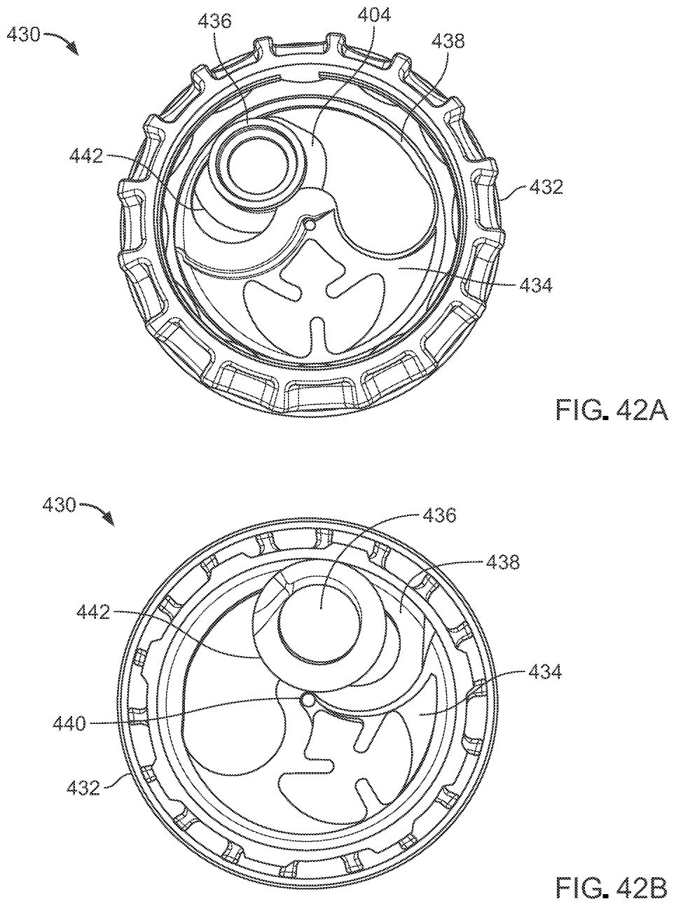

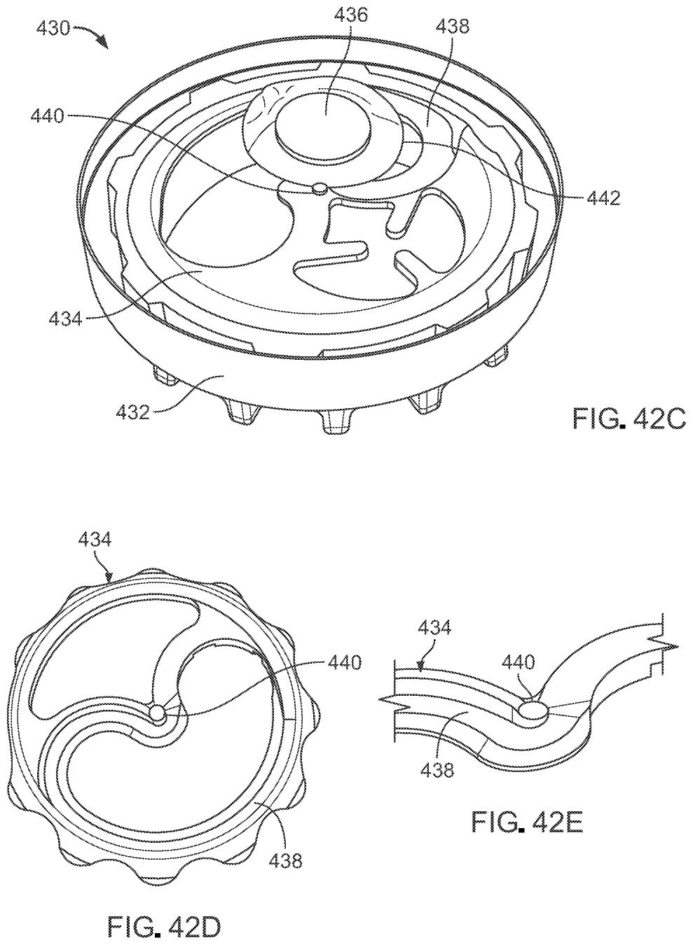

While the cap 520 is shown with four 528 drive lugs, some caps compatible with the peel-back lid design 500 include a castellation design similar to the design of cap assembly 430 shown in FIGS. 42A-42E. Cap 520 is shown without a dispensing port for illustrative purposes. Some caps compatible with the peel-back lid design 500 include dispensing port like cap 350.

Some pods have caps with a raking surface that moves linearly across the lid (e.g., slides diametrically straight across the lid) to remove the protrusion like the protrusion 222 and/or a surface like the surface 502. The raking surface slides across the lid to separate, remove, and collect the protrusion and/or surface. Some machines include a raking surface in the machine instead of the cap. Some caps include a raking surface that is mounted as a secondary piece within cap of the pod (e.g., like the insert 434) and not integrally formed with the body of the cap. Some lids include a raking surface that is integrally formed with the lid.

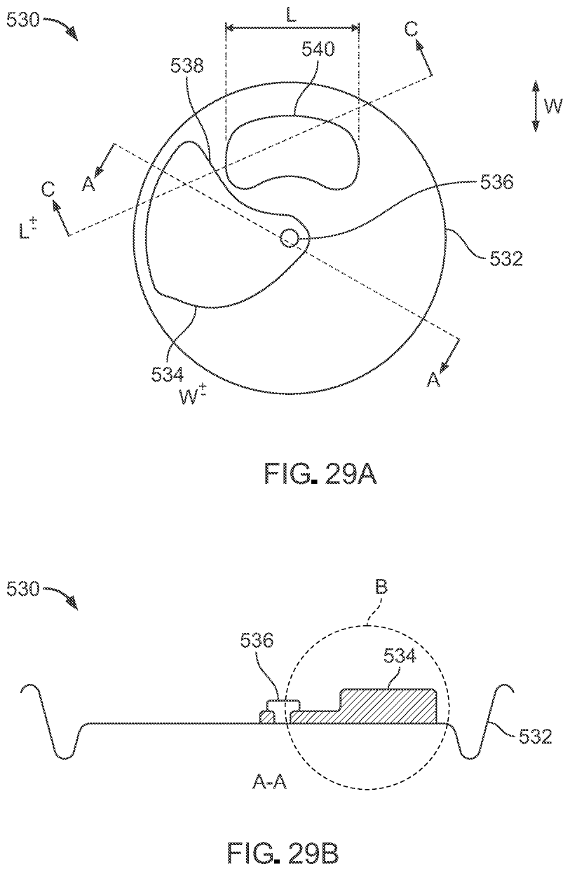

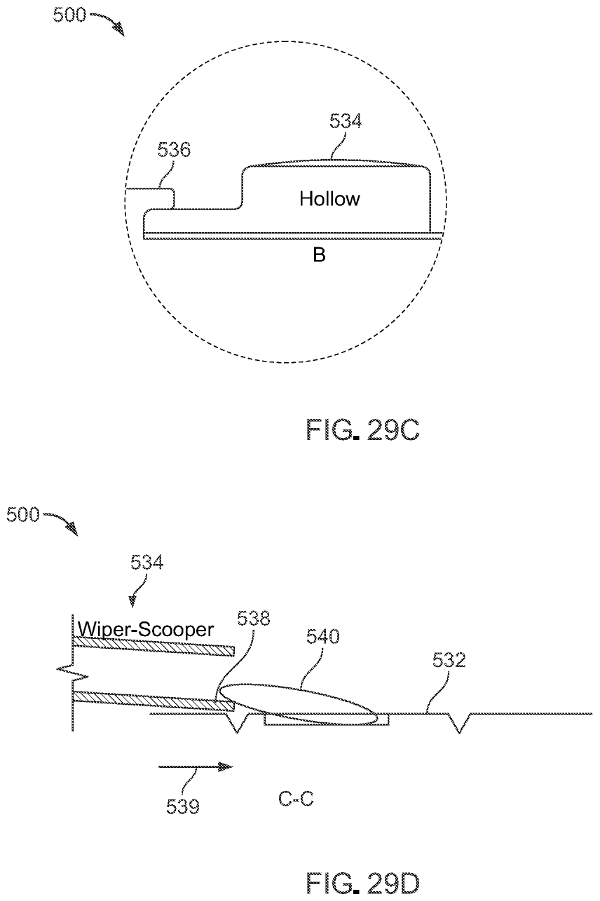

FIGS. 29A-29D are schematic views of a peel back lid design 530 with a raking surface that includes a cavity. The peel back lid assembly 530 includes a lid 532 that is substantially similar to lid 504. However, instead of using a cap 520 with a raking surface 522 to engage a protrusion, the lid 532 includes a part 534 that is pinned to the center of the lid 532 (via pin 536). Part 534 includes a raking surface 538 that engages a protrusion 540 of the lid 532. Part 534 includes a cavity that captures the peeled back protrusion 540 (“hanging chad”) in a cavity (e.g., between a lower and upper portion) as the part 534 rotates relative to the lid 532 (e.g., as the part 534 moves in the direction of arrow 539 with respect to the lid 532). Some machines include a motor coupled to the part 534 to cause it to rotate.

An advantage of the peel back lid design 530 is that a shearing cap is not required. Another advantage of the peel back lid design 530 is that by capturing the peeled back protrusion 540 in the cavity, interaction with dispensing ice cream is reduced. In some examples, the hidden peeled back protrusion 540 avoids it from cutting the dispensed ice cream and/or capturing the residual food or drink. In some examples, the peeled back protrusion 540 does not come into contact with the cooled food or drink.

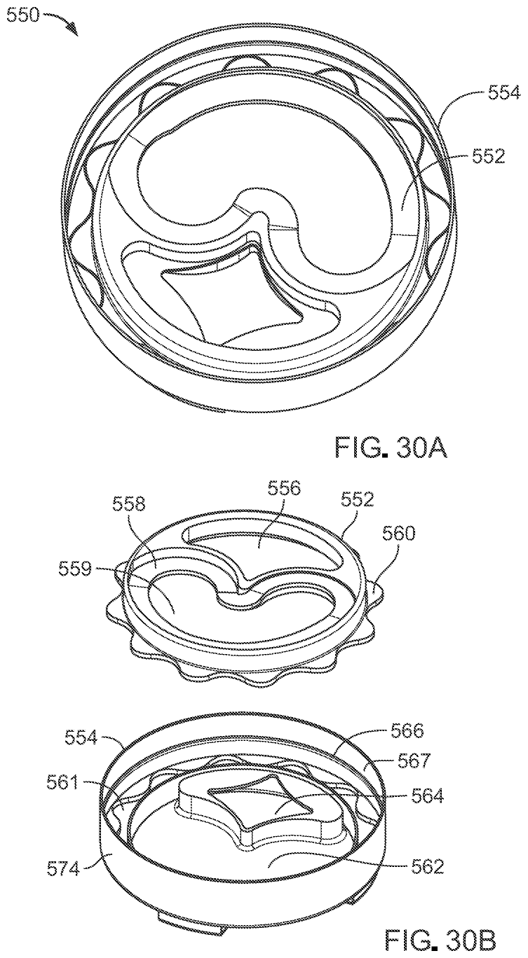

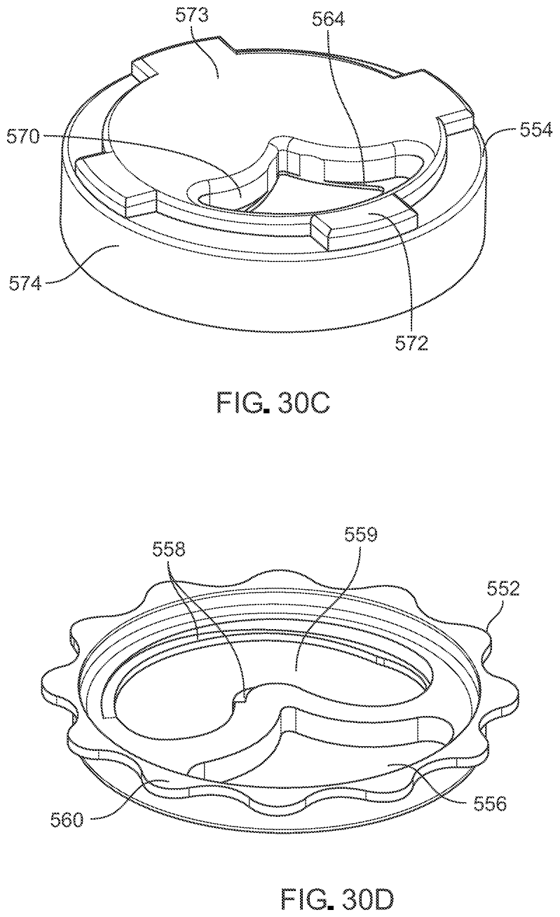

FIGS. 30A-30D are perspective views of an alternate two-piece shearing cap 550 for a pod. The two-piece shearing cap 550 includes a body 554 (e.g., a plastic drip tray) and a shearing ramp insert 552. Insert 552 is substantially flat and planar and is removably attachable to the cap body 554. Insert 552 attaches to the cap body 554 into the assembled position shown in FIG. 30A.

The insert 552 includes mating features 560 arranged on an outside diameter of the insert 552 for mating the insert 552 to the cap body 554. The mating features 560 include one or more faces that engage the cap body 554 to transfer torque between the cap body 554 and the insert 552. The mating features 560 of the insert 552 include a wavy (or cyclical/undulating) pattern of radially outward protrusions that circumscribe the insert 552. In some examples, the mating features 560 include 12 equally-spaced radially outward protrusions representing peaks with troughs between each respective peak. Other shapes are possible, such as squares, rectangles, or triangles, so long as they allow torque transfer between the cap body 554 and the insert 552. The cap body 554 includes a recess 561 having a wall with a corresponding pattern of the mating features 560. When the insert 552 is inserted into the cap body 554, the insert 552 is rotationally coupled to the cap body 554 due to an engagement between the mating features 560 of the insert 552 and the walls of the recess 561.

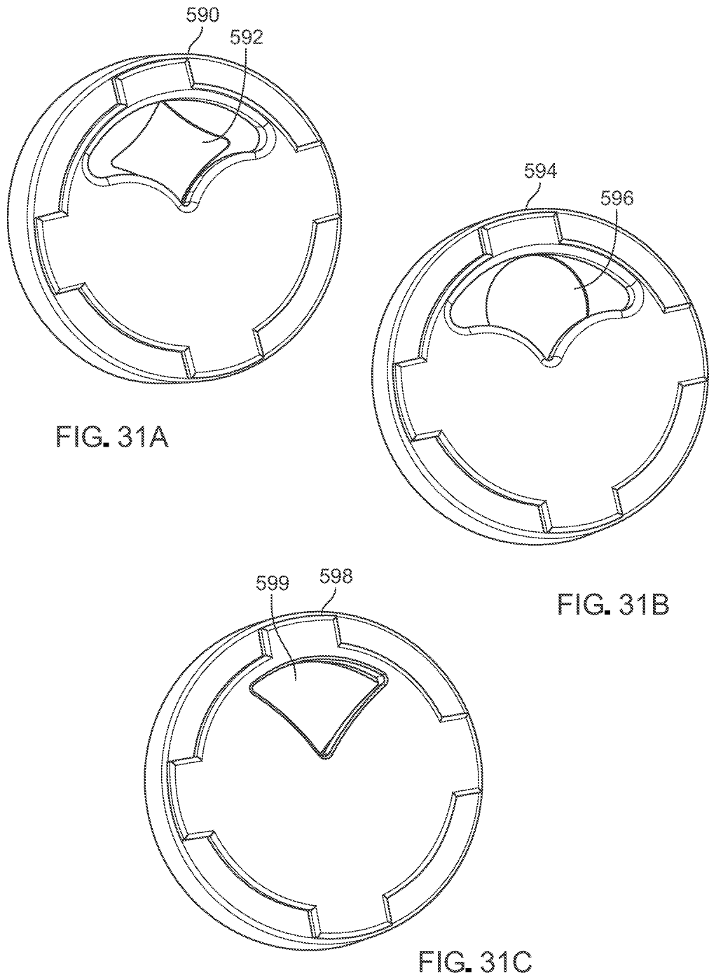

The insert 552 includes two apertures. A first aperture is a wide mouth aperture 556 that allows product to pass through when dispensing it from the pod. The first aperture 556 is sufficiently large that it accommodates various dispensing orifices (e.g., orifice 564) so that a single design of the insert 552 is compatible with various shapes of dispensing orifices (e.g., square, tri-lobe, penta-lobe, star, elliptical, circular, etc.) and sizes of dispensing orifices. Example shapes and sizes of dispensing orifices are shown in FIGS. 31A-31C.

The insert 552 includes a ramped surface 558 for removing the protrusion to open the pod. For example, the ramped surface 558 includes a protrusion shearing ramp to remove a protrusion from a pod in a similar manner as ramps 360 of cap 350. Shearing cap 550 includes a lower profile ramped surface 558 than cap 350. The ramped surface 558 surrounds a second aperture 559 of the insert 552. In some examples, the insert 552 is metal (e.g., stamped metal such as stamped aluminum, machined aluminum, cast aluminum, etc.) and the cap body 554 is plastic (e.g., injection molded plastic). In some cases, the insert 552 is axially retained in the cap body 554 using a press fit (e.g., an interference fit) between the mating features 560 of the insert 552 and the recess 561 of the cap body 554. Some caps use other retention features (e.g., snap ring, adhesive, etc.). In some cases, manufacturing the insert 552 with the second aperture 559 can be cheaper and/or easier than other solutions (e.g., blind holes, recesses, etc.).

Some shearing caps include a recess instead of the aperture 559. For example, a recess works because an insert just needs to clear the protrusion (e.g., protrusion 222) from the pod as the protrusion head rides along the ramped surface 558.

The cap body 554 includes a recess 562 (e.g., a drip reservoir) to capture melting residual product left in the pod after the machine dispenses the majority of the product from the pod. The recess 562 is integrally formed with the cap body 554. The cap body 554 includes an orifice 564 defining a pass-through for product to pass as the product dispenses from a pod. In this example, the orifice 564 is square-star shaped but other shapes can also be used as described with reference to FIGS. 31A-31C.

The cap body 554 includes a ridge feature 566 that retains the shearing cap 550 in position on the rim of a pod. The ridge feature 566 is a radially-inward extending protrusion that is located on an inner surface 567 of the cap body 554. For example, when the shearing cap 550 is installed onto an end of the pod (e.g., in a factory during an assembly process or by a consumer), the ridge feature 566 engages the rim of the pod and, upon sufficient force applied by the user, the rim snaps past the ridge feature 566. This snap fit holds the shearing cap 550 onto the pod but allows a user to remove the shearing cap 550 from the pod if needed. In some examples, the size of the ridge feature 566 is sufficient to retain the insert 552 in the cap body 554 (e.g., so the insert 552 does not fall out of the cap body 554 during handling of the cap 550 before the cap 550 is installed on the rim of the pod).

The cap body 554 includes a recess 570 that includes the orifice 564. The cap body 554 includes four drive lugs 572 (or drive protrusions) that engage a cap shearing mechanism of the machine 100 to rotate the shearing cap 550 with respect to the pod to shear off the protrusion of the pod and form an opening.

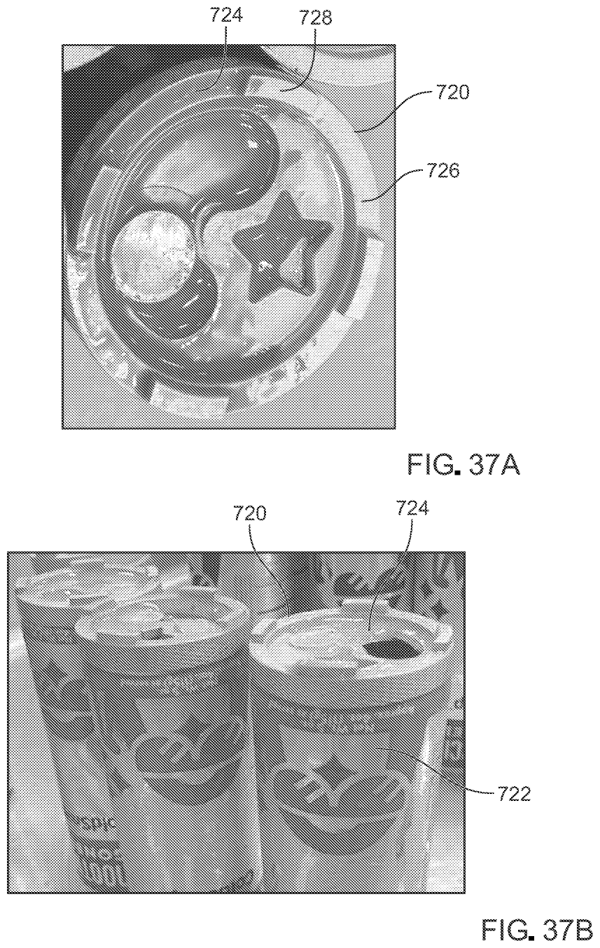

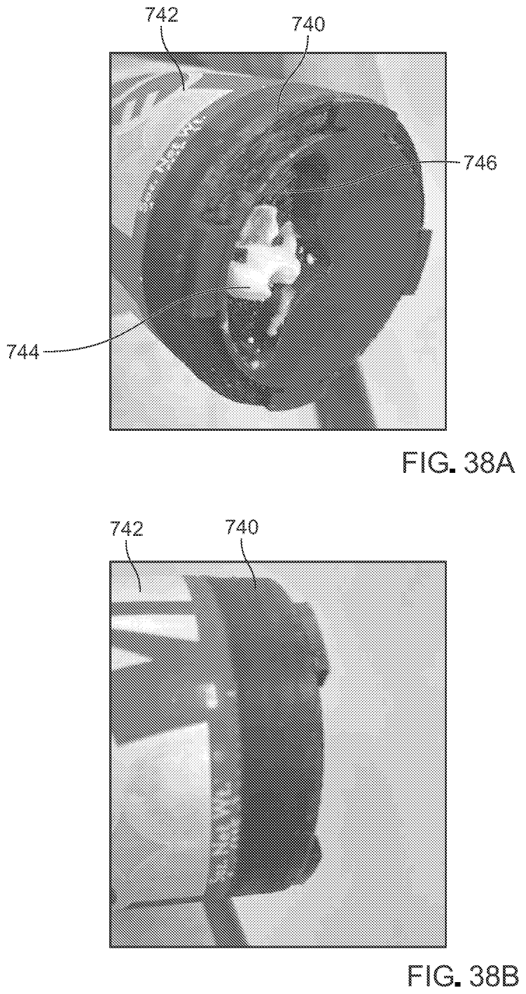

The drive lugs 572 axially protrude from the cap body 554 up to a surface 573. This surface 573 is also the same surface that defines the recess 570 and is the furthest-most surface away from the pod. This feature is advantageous because the chances of residual product leaking from the shearing cap 550 onto the drive mechanism, evaporator, or other parts of the machine is reduced when the shearing cap 550 includes a cap body 554 having an end surface of the drive lugs 572 and the surface defining the recess 570 share the same plane. Examples of this advantage are shown and described with reference to FIGS. 37A-38B.

The cap body 554 includes an aesthetic sealing skirt 574 that further protects the machine 100 from coming into contact with the residual product of the pod. The skirt 574 is a cylindrical surface that extends along a longitudinal direction of the cap body 554 and covers the first end 204 of the pod 200 when installed on the pod 200. The ridge feature 566 is located on an inner surface 567 of the skirt 574 to snap over the rim of the pod for retention and sealing against the pod. In some examples, the skirt 574 serves as a secondary catch if the protrusion of the pod is not retained by the cap 550. This reduces the chances of a completely detached protrusion ending up in the product being dispensed.

FIGS. 31A-31C are perspective views of a shearing cap for a pod with various size orifices. FIG. 31A is a view of a shearing cap 590 with a square-star orifice 592, FIG. 31B is a view of a shearing cap 594 with a droplet orifice 596, and FIG. 31C is a view of a shearing cap 598 with triangle orifice 599. Some shearing caps include other orifices (e.g., circular, elliptical, diamond, trapezoidal, star, pentagon, etc.).

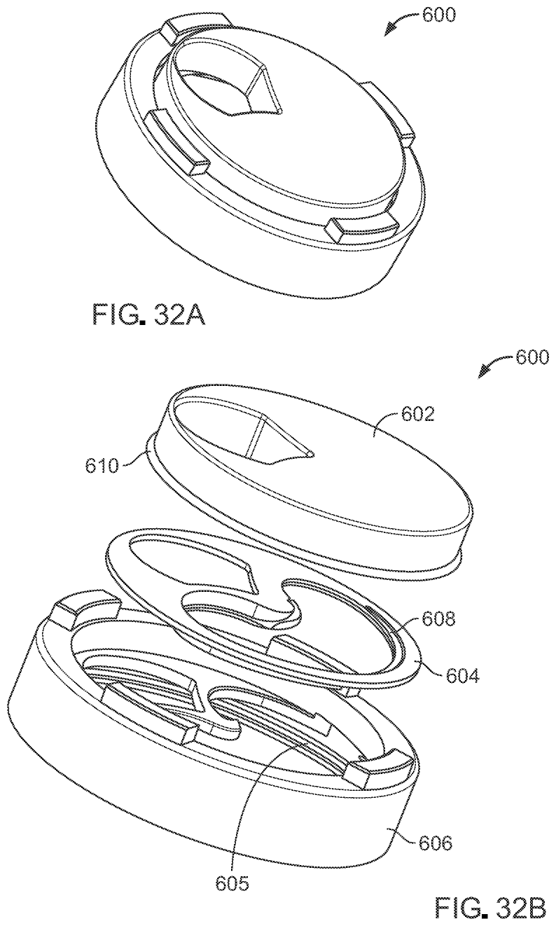

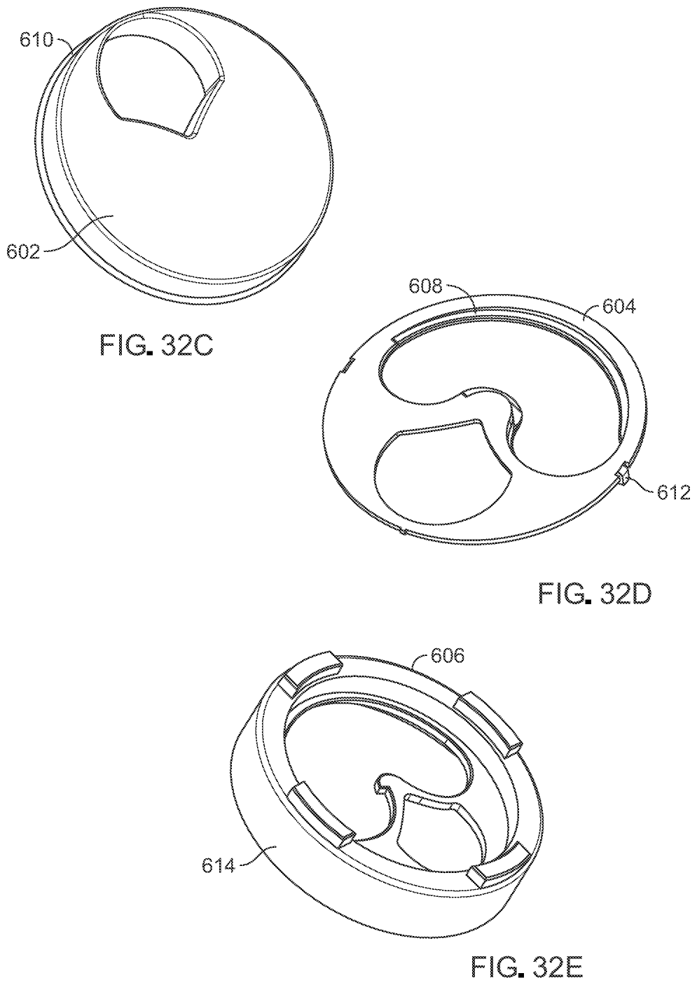

FIGS. 32A-32E are perspective views of a three-piece shearing cap 600 for a pod. The shearing cap 600 includes a drip tray 602, a shearing insert 604, and a cap body 606 (base sealing skirt). In some examples, the drip tray 602 and/or the cap body 606 is/are plastic (e.g., injection molded plastic). In some examples, the insert 604 is metal (e.g., stamped, machined, or cast aluminum). In some examples, the insert 604 is substantially flat and thin.

The insert 604 includes a ramped surface 608 (e.g., a shearing surface) like insert 552. The insert 604 is insertable within the cap body 606. The drip tray 602 includes a circumferential seal 610 that slides into the cap body 606 and seals (or substantially seals) the shearing cap 600 to the pod to retain/capture the drips of residual product as the product is dispensed and after the product has melted after dispensing. An advantage of the three-piece shearing cap 600 is that the shearing ramp 608 can be formed using a stamping process which reduces the cost of manufacturing the insert 604.

In some examples, the circumferential seal 610 is over-molded onto a body of the drip tray 602. The drip tray 602 is removable from the cap body 606 and can be exchanged as needed. The insert 604 includes a pair of snap features 612 (e.g., as shown in FIG. 32D) that engage an inner recess of the cap body 606 to releasably hold the insert 604 to the cap body 606. Some inserts include a pair of snap features, as shown, or more than two (e.g., 3-10 snap features equally spaced around the circumference of the insert.

The cap body 606 includes a cylindrical surface 614 to prevent (or reduce) product from leaking from the lateral sides of the pod during and after dispensing. The cap body 606 includes a sealing/retention ridge 605 located on an inside of the cap body 606 and integrally formed with the cap body 606. The sealing/retention ridge 605 seals the cap body 606 to the pod and snaps over rim at the first end 204 of the pod 200 to secure the cap body 606 onto the pod 200.

FIGS. 33A and 33B are perspective views of an alternate two-piece shearing cap 630 for a pod. The shearing cap 630 includes a cap body 632 and a seal insert 634. The cap body 632 includes a large opening 636 to accommodate the seal insert 634. In some examples, the seal insert 634 is resilient and made of an elastomer (e.g., rubber, nitrile, silicone, etc.). In some examples, the seal insert 634 is made of plastic (e.g., polypropylene). The insert 634 is preferably removable from the cap body 632 only by sufficient force to reduce the risk of a choking hazard. In some examples, the insert 634 is adhered to the cap body 632 or snaps into place using an interference fit.

The seal insert 634 includes dispensing port 638 in the form of a star orifice. The star orifice defines a passageway for product to flow out of the pod. While a star orifice 638 is explicitly shown, some shearing caps include other orifice sizes (e.g., circular, elliptical, diamond, trapezoidal, star, pentagon, etc.). The seal insert 634 is a cost effective way to use different sized orifices with different pods and eliminate product from squirting laterally from the cap body 632 when the product is dispensed from the machine 100. This helps to avoid situations where residual product contacts the machine 100 during mixing and/or dispensing.

When the seal insert 634 is attached to the cap body 632 (e.g., as shown in FIG. 33A) and installed on the first end 204 of the pod 200, the seal insert 634 seals tightly against a base 220 of the pod 200 and occupies the large opening 636 in the shearing cap 630. This tight seal is advantageous because the seal prevents (or substantially prevents) product from squirting laterally as the product is dispensed.

The cap body 632 includes a knurled skirt 639 that increases the frictional engagement with a shearing mechanism of the machine 100 to rotate the shearing cap 630 with respect to the base of the pod to remove the protrusion of the pod. While shearing cap 630 includes a knurled skirt 639, other shearing caps include a scored skirt or otherwise a skirt with a rough surface finish to facilitate engagement with a shearing mechanism.

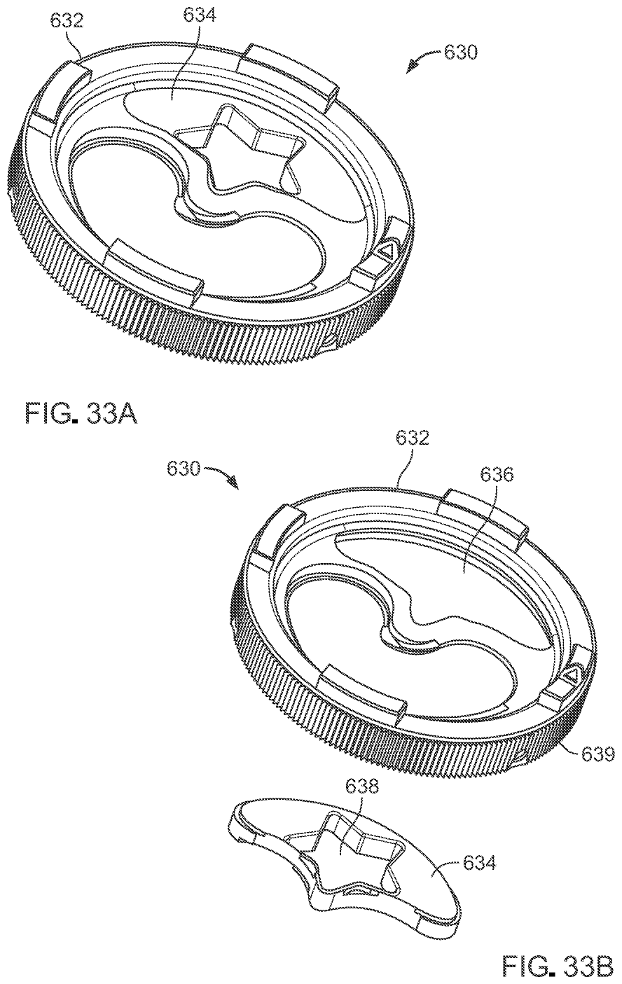

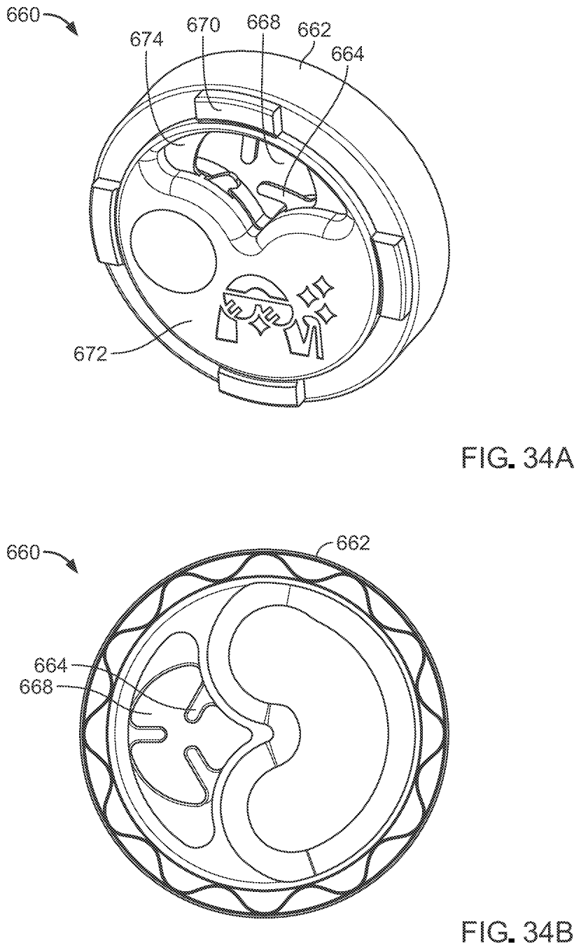

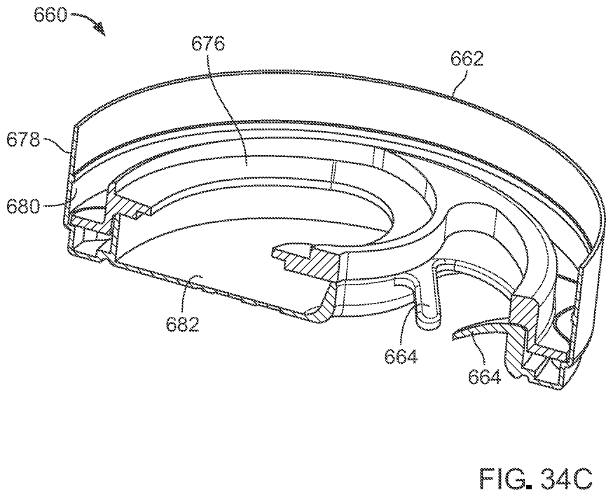

FIGS. 34A-34C are views of an alternate two-piece shearing cap 660 for a pod. The shearing cap 660 is substantially similar to shearing cap 550 except for the following differences. The shearing cap 660 includes a cap body 662 (drip tray) with a tri-port aperture 668. The cap body 662 includes three equally-spaced tangs 664 (e.g., spaced approximately 120 degrees apart) that are integrally formed on the cap body 662 radially extend into the center of the aperture 668 and are biased in an axial direction away from the pod. The tangs 664 serve as a safety feature that prevents consumers from sticking their fingers through the aperture 668 and potentially injuring themselves on sharp edges surrounding the aperture on the base of the pod or coming into contact with a rotating mixing paddle or impeller. In some cases, less than three or more than three tangs 664 are used. For example, some shearing caps include two tangs and some shearing caps include four tangs. Other shearing caps can include more than four tangs (e.g., five tangs, six tangs, etc.). The tangs 664 are specifically shaped to create a particular pattern of the product stream as the product is dispensed from the machine 100.

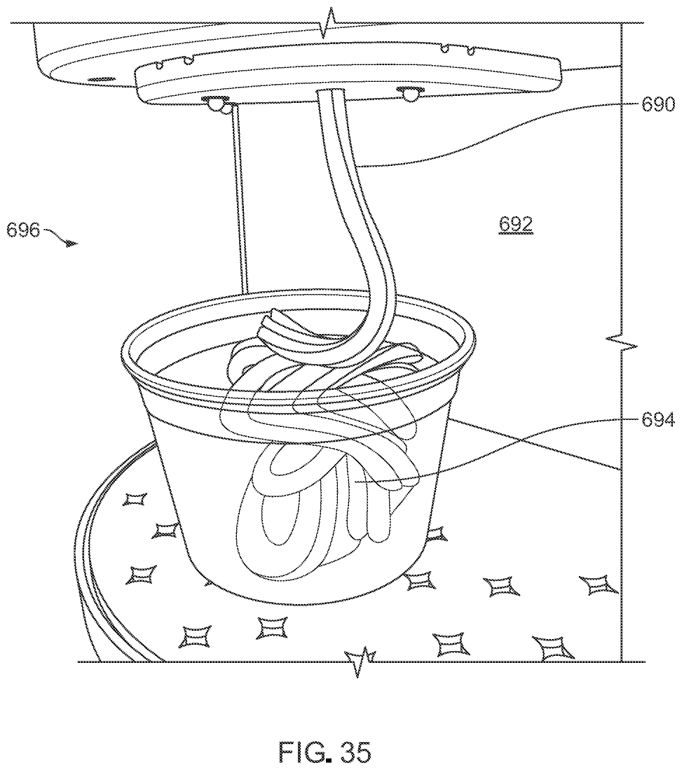

FIG. 35 is an image of product 690 being dispensed from a machine 692 through the shearing cap 660. The machine 692 is the same as, or substantially similar to machine 100. The machine 692 is operable to dispense product 690 (in this example, a frozen confection such as ice cream) having a particular texture (or pattern) because the product 690 passes through the three tangs 664 of the tri-port aperture 668 of shearing cap 660. In this example, the three tangs 664 produce a tri-lobe texture. In other examples, other variations of tangs produce other textures. For example, a five tang design produces a penta-lobe texture. The product 690 is being dispensed into a cup 694 that is resting in the dispensing area 696 of the machine 692. The dispensing area 696 of machine 692 is similar to the dispensing area 110 of machine 100. After the machine 692 completes the dispensing process, a user removes the cup 694 from a base of the machine 692 and consumes the product 690 using a spoon.

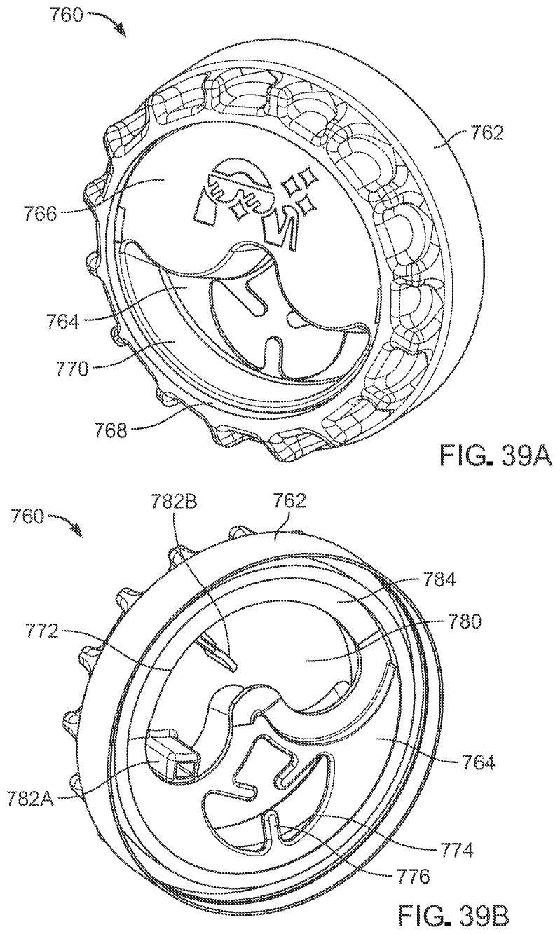

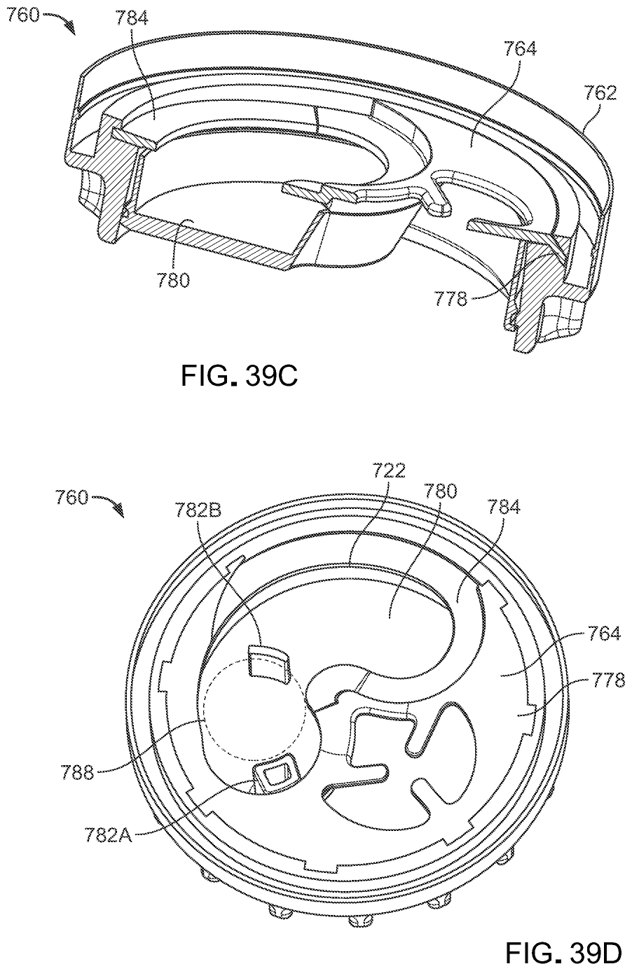

Referring to FIGS. 34A-34C, the cap body 662 includes four drive lugs 670 that protrude from an annular surface 672. While shearing cap 550 includes drive lugs 572 that includes an end surface that shares the surface 573 with the recess 570, shearing cap 660 does not have this property. Instead, the drive lugs 670 protrude a distance less than the furthest-most surface 672. The advantage of reducing the chances of product escaping from the shearing cap 660 onto the drive mechanism and/or other parts of the machine 100 is still achieved because there is essentially no space for residual product to escape from the recess 674 that defines the tri-lobed aperture 668 when the pod is installed into the machine 100. While the cap body 662 includes the drive lugs 670, some caps include a plurality of axially extending protrusions and recesses like cap assembly 760 shown in FIGS. 39A-39C or cap assembly 430 shown in FIGS. 42A-42E. Some versions of cap 550 have drive lugs that include an end surface that shares the surface such that the drive lugs 670 protrude a distance equal to the furthest-most surface.

FIG. 34C is a cross-section perspective view of the shearing cap 660. The shearing cap 660 includes an insert 676 that is substantially similar to insert 552. An annular space between the skirt 678 of the cap body 662 and the insert 676 defines a radial labyrinth channel 680. The radial labyrinth channel 680 prevents product from escaping to the sidewall of the pod. The cap body 662 includes a recess 682 (e.g., a drip tray or reservoir) substantially the same as the recess 562 of cap 550. Together, the recess 682 and the labyrinth channel 680 help reduce product from escaping from an interior of the shearing cap 660 when the product is being dispensed from the machine 100. This improves cleanliness of the dispensing process and also reduces the chances of product contaminating parts of the machine 100.

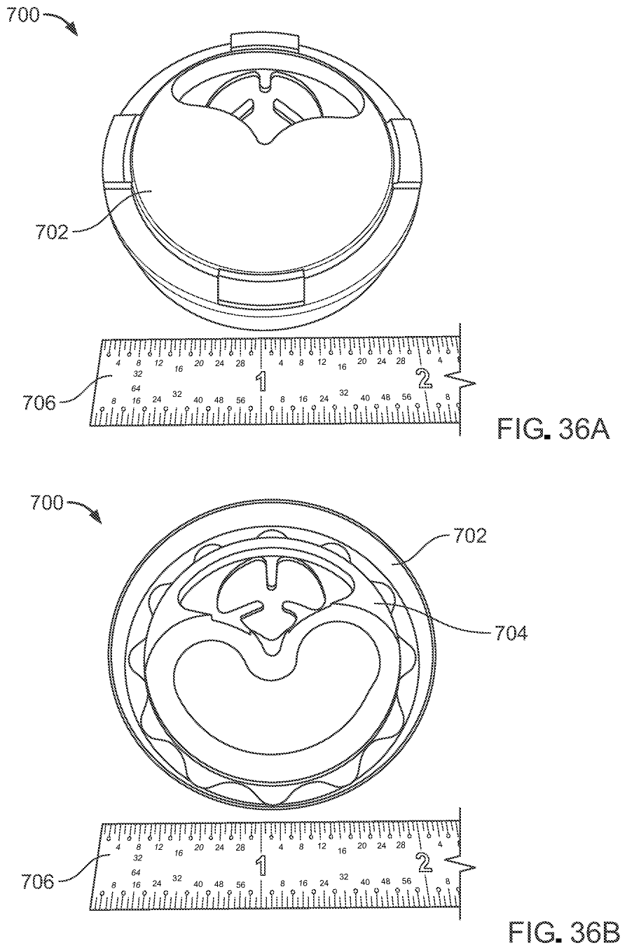

FIGS. 36A and 36B are images of a prototype two-piece shearing cap 700. The shearing cap 700 is substantially similar to shearing cap 660. The shearing cap 700 includes a cap body 702 (or drip tray) made of plastic and printed using a 3D printer. The shearing cap 700 includes an insert 704 made of aluminum metal and machined using a CNC machine. A ruler 706 depicts the physical size of the shearing cap 700. For example, the shearing cap 700 is about 2 inches (5.08 cm) in diameter.

FIGS. 37A and 37B are perspective views of a pod 722 with a shearing cap 720 installed on an end of the pod 722. The shearing cap 720 is substantially the same as shearing cap 350 and the pod 722 is substantially the same as pod 200. FIGS. 37A and 37B represent a state after the product has been dispensed from the pod 722 and the pod 722 has been removed from the machine 100. For example, it is possible for residual product 724 to escape from the shearing cap 720. In some cases, product 724 reaches a recessed surface 726 between the drive lugs 728. In some cases, product 724 goes beyond this recessed surface 726 and reaches the outer sides of the skirt of the shearing cap 720. When this happens, product 724 may contaminate the shearing mechanism and/or other parts of the machine which is not desired.

FIGS. 38A and 38B are perspective views of a pod 742 with the shearing cap 740 installed. The shearing cap 740 is substantially the same as shearing caps 660 and 700 and the pod 742 is substantially the same as pod 200. Much less product 744 escapes from the shearing cap 740 (e.g., compared to the shearing cap 720) when product is dispensed from the machine 100. FIGS. 38A and 38B represent a state after the product 744 has been dispensed from the pod 742 and the pod 742 has been removed from the machine 100. Much less product 744 escapes from the shearing cap 740 at least in part due to the product being confined to the recess 746 of the shearing cap 740. In addition, having a radial labyrinth channel (e.g., channel 680) and a drip reservoir (e.g., recess 682) helps reduce the chances of product 744 escaping from the interior of the shearing cap 740.

FIGS. 39A-39D are perspective views of a three-piece over-molded shearing cap 760 for a pod. Shearing cap 760 includes a cap body 762 (or drip tray or shear tray), an insert 764 over-molded with the cap body 762, and a cover 766 located within a recess 768 of the shear tray and at least partially covering the insert 764. The cover 766 has a wall 770 that contacts the inner surface of the recess 768 to concentrically position the cover 766 within the cap body 762.

The insert 764 includes a first aperture 772 and a second aperture 774, and the first aperture 772 includes ramp features 784 to engage the protrusion of the pod. One or more tangs 776 are integrally formed on the insert 764 instead of the tangs being on the cap body. Shearing cap 760 includes three tangs that are directed radially inward and are equally spaced around the circumference of the second aperture 774. The second aperture 774 is used as a dispensing port 774 and is radially offset from the center of the insert 764. Because the insert 764 rotates with respect to the pod, the dispensing port 774 moves circumferentially around the cap 760 when the machine 100 rotates the cap 760 relative to the base of the pod. The dispensing port 774 moves to a position where it is axially aligned with the opening of the base.

The insert 764 is over-molded with the cap body 762 at one or more locations around the circumference of the insert 764. The insert 764 includes one or more mating features 778 that are over-molded with the cap body 762 to rotationally couple the insert 764 to the cap body 762. The mating features 778 include protrusions that extend radially outward and are angled relative to the plane of the insert 764.

The cover 766 includes a drip reservoir 780 (drip tray) to capture dripping product (e.g., melted food or drink) during and after the food or drink is dispensed from the machine. In some cases, the drip reservoir 780 acts as a backup to retain the protrusion of the pod in situations where the protrusion is inadvertently freed from engagement with the ramp features 784. Usually the protrusion is retained by the ramp features 784 and is not released after it is sheared off from the pod so it does not fall into the dispensed product. The drip reservoir 780 is an enlarged recessed area sized to completely cover the first aperture 772 so there is little risk that residual product seeps beyond the cover 766 once the protrusion has been sheared off from the pod.

The cover 766 includes alignment features 782A, 782B to assist in locating the protrusion of the pod with respect to the cap 760 when the cap 760 is installed on the rim at the first end 204 of the pod 200. This helps to ensure that the protrusion of the pod is in the proper position relative to the ramp features 784 of the insert 764 before the machine 100 begins to rotate the cap 760 to shear the protrusion during the dispensing process. The alignment features 782A, 782B are axially extending protrusions that extend toward the pod from a bottom surface of the drip reservoir 780. When the cap 760 is installed on a pod having a protrusion, the protrusion would be located within the circled region 788 between the two alignment features 782A, 782B. Alignment feature 782A makes sure that the protrusion is far enough up the ramp 784 to engage the ramp 784 and not slip out. Alignment feature 782B keeps the protrusion from going too far up the ramp 784. Alignment feature 782B is bendable so that it provides a “soft” stop when assembling, but will bend out of the way during the shearing process.

In some examples, the cap body 762 and the cover 766 are formed of plastic (e.g., polypropylene). In some examples, the insert 764 is formed of metal (e.g., aluminum). Some caps use a removable insert instead of an over-molded insert to facilitate easier removal of the insert from the cap body so the insert can be recycled. In some examples, the removable insert is installed using snap-fit features, a screw-on design (e.g., one or more threads), and/or pins/stakes. Some caps use an aluminum body 762 so that the body 762 and the insert 764 can be easily recycled together without requiring them to be separated. Some caps further use an aluminum cover 766 so that the aluminum cap body 762, the aluminum insert 764, and the aluminum cover 766 can be recycled together without requiring them to be separated.

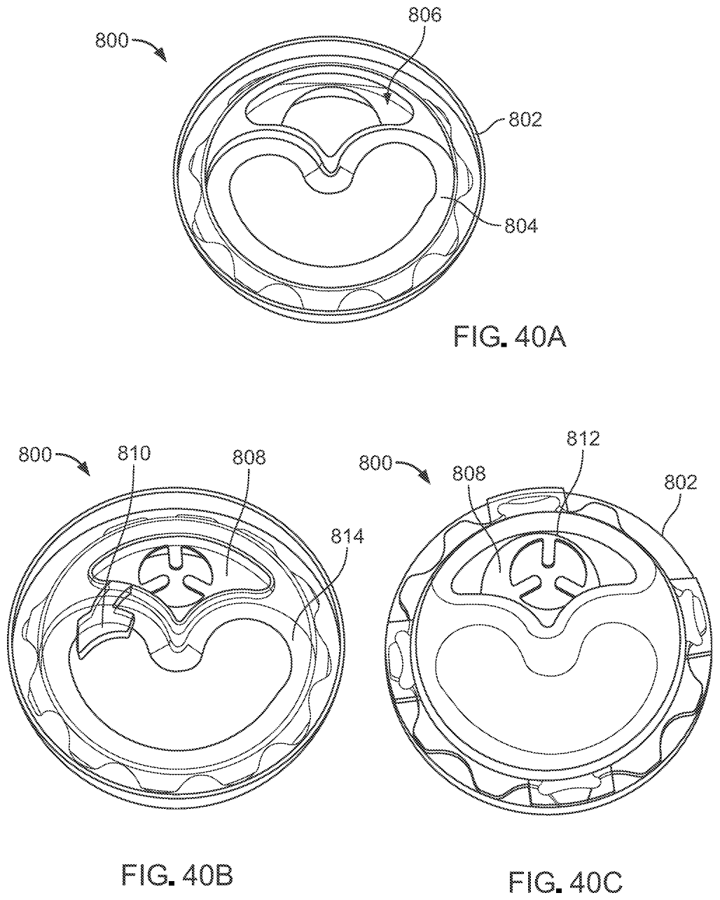

FIGS. 40A-40C are perspective views of a prototype shearing cap 800 that is similar to shearing cap 660 but the tang features 664 are formed on an insert that is disposed on the inside of the cap. Cap 800 includes a cap body 802 (or drip tray or shear tray), a first insert 804 rotationally coupled to the cap body 802, and a second insert 808 located within a recess 806 of the cap body 802 and an opening in the first insert 804. FIG. 30C shows the second insert 808 visible through an opening 812 in the cap body 802. The second insert 808 includes a protrusion stop 810 that extends into the region of the ramped surface 814. The protrusion stop 810 ensures that the protrusion of the pod (e.g., protrusion 222 of pod 200) is far enough up the ramp 814 for engagement and not slip out. In this way, protrusion stop 810 serves the same function and purpose as alignment feature 782A of cap 760.

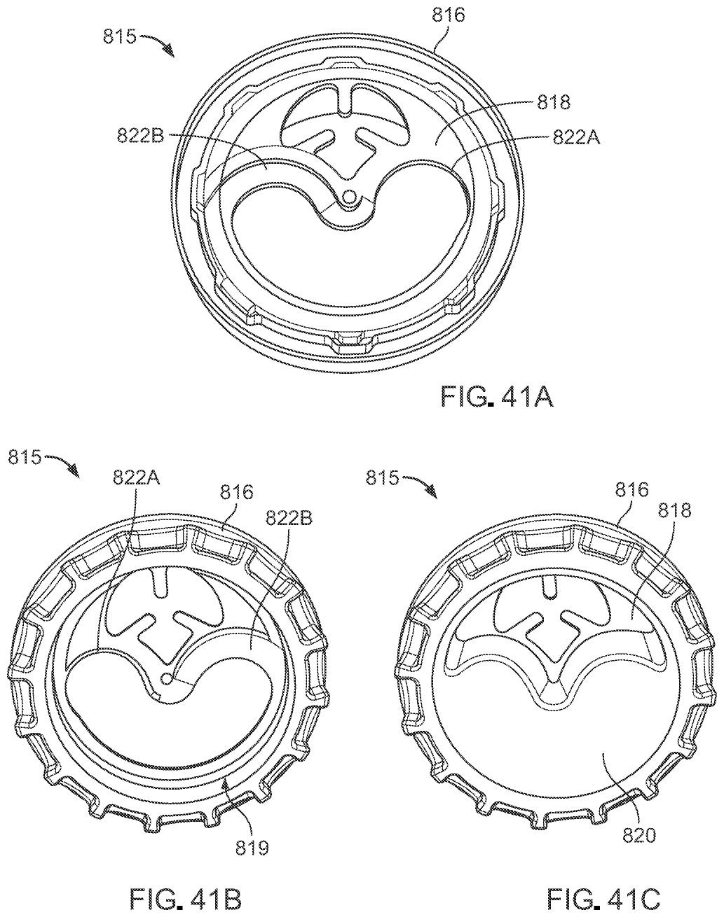

FIGS. 41A-41C are perspective views of a prototype shearing cap 815 that is similar to the three-piece over-molded shearing cap 760 but includes a different ramped surface that engages the protrusion of the pod. Cap 815 includes a cap body 816 (or drip tray or shear tray), a first insert 818 rotationally coupled to the cap body 816 via overmolding, and a second insert 820 located within a recess 819 of the cap body 816. As shown in FIG. 41A, the ramped feature is coincident with the plane of the insert 818 at side 822A and gradually extends out of the plane of the insert 818 in the direction away from the pod (if the cap were inserted on the pod) at side 822B. FIG. 41B shows the opposite view as FIG. 41A. As shown in FIG. 41B, side 822B of the ramped feature protrudes in the direction out of the page (e.g., toward a viewer viewing FIG. 41B on the page). In some cases, caps with ramped features that protrude out of the plane of the insert 818 as shown in FIGS. 41A and 41B more reliability shear off the protrusion of the pod than caps without such a feature.

FIGS. 42A-42E are perspective views of a prototype cap assembly 430. Cap assembly 430 includes a shearing cap 432 and a shear drive insert 434. A protrusion 436 (which has already been detached from a base of a pod) is shown engaged with the shearing ramps 438 of the insert 434. The insert 434 includes a dimple 440 located in the center of the insert 434. An end surface of the dimple 440 contacts the base of the pod and provides a downward force on the base of the pod as the insert 434 is rotated. This force prevents the base of the pod from lifting up together with the protrusion 436. This allows a weakened score line 442 surrounding the protrusion 436 to fracture more effectively. The dimple 440 pushes down on the base immediately adjacent to the weakened score line 442 to increase the shearing stress at the weakened score line 442. While insert 434 includes one dimple 440 some inserts include more than one dimple (e.g., 2-10 dimples).

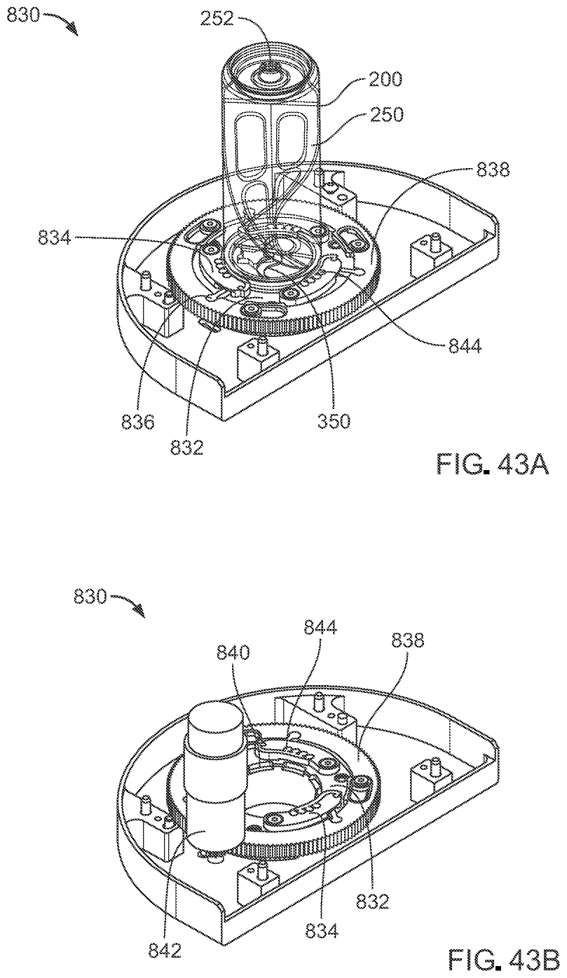

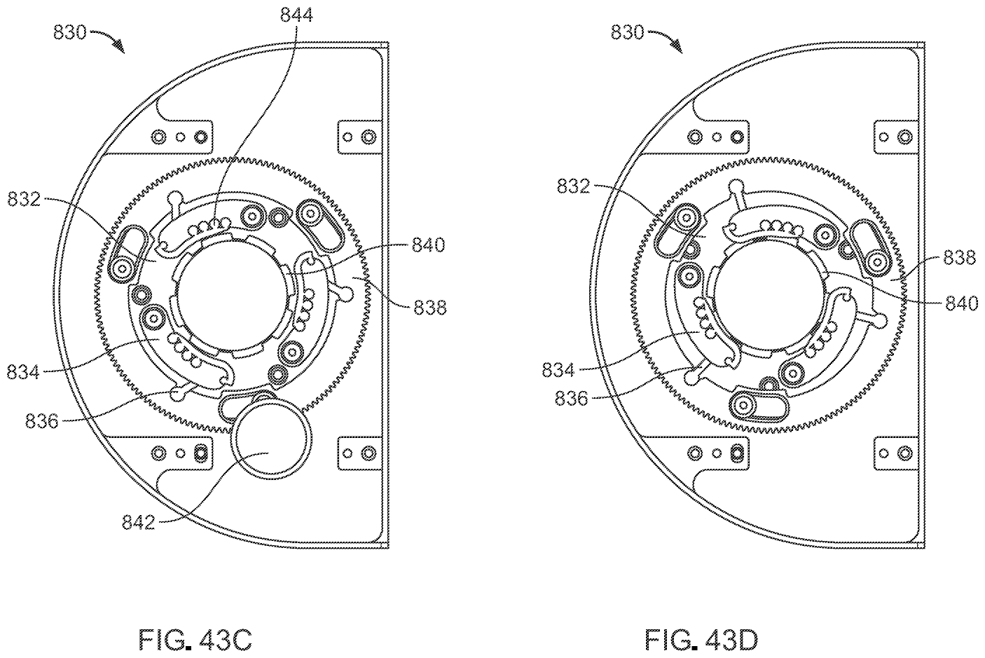

FIGS. 43A-43D show a cap shearing system 830 that is part of the machine 100. The cap shearing system 830 is part of a machine-pod interface and dispensing system of the machine 100. In the position shown in FIG. 43A, the pod 200 is inserted into the machine 100 and is in contact with the cap shearing system 830. The evaporator 154 surrounds the pod 200 (e.g., as shown in FIG. 10A) but is not shown for clarity. The pod 200 includes a mixing paddle 250 and a drive head 252 as described with reference to FIG. 2.

Shearing cap 350 is installed on the first end of the pod 200 and is in engagement with the cap shearing system 830. In this example, the drive lugs of the shearing cap 350 are received in recesses 840 of an annular member 832 (rivet shear hub) of the cap shearing system 830 when the pod 200 is inserted into the machine 100 in the position shown in FIG. 43A. Engagement between the drive lugs of the shearing cap 350 and the annular member 832 rotationally couple the shearing cap 350 to the machine 100.

FIG. 43B shows the cap shearing system 830 without a pod inserted into the machine 100. Three iris fingers 834 (pawls) are positioned radially around the circumference of annular member 832 and located relative to the annular member 832 by pivot pins and bearings. The pivot pins and bearings create a lever arm 836. The ends of the iris fingers opposite the levers 836 are connected to a spur gear 838 via links, creating a kinematic linkage. As spur gear 838 rotates, the corresponding motion of the links causes the iris fingers 834 to rotate radially inward toward the center of the annular member 832, generating a torsional force on the shearing cap 350 as the iris fingers 834 come into contact with it. The spur gear 838 has a rotational degree of freedom with respect to the annular member 832 which allows it to rotate freely a fixed distance to permit iris fingers 834 to actuate and engage the shearing cap.

The body of pod 200 is clamped in evaporator 154 (e.g., by a compressional squeezing force applied by the evaporator 154 when it closes). A shearing motor 842 is rotationally coupled to the annular member 832 to cause it to rotate. The torsional force exerted by the cap shearing system 830 causes the shearing cap 350 to rotate relative to the body of the pod 200 to separate the protrusion (e.g., protrusion 222) from the pod 200 to reveal an aperture for dispensing the cooled food or drink.

The annular member 832 is mounted in a one-way clutch mechanism that permits freedom of movement in the counterclockwise rotational direction but inhibits movement of the annular member 832 in the clockwise rotational direction. When spur gear 838 is rotated in the clockwise direction by the shearing motor 842, the annular member 832 remains stationary relative to the spur gear 838. As spur gear 838 rotates, the links pull the iris fingers 834 open to release the grip on the shearing cap so the empty pod can be removed from the machine. The iris fingers 834 include a rubber insert 844 that contacts the shearing cap 350 to increase the frictional grip on the shearing cap 350. The shearing motor 842 is not shown in FIGS. 43A and 43D for clarity.

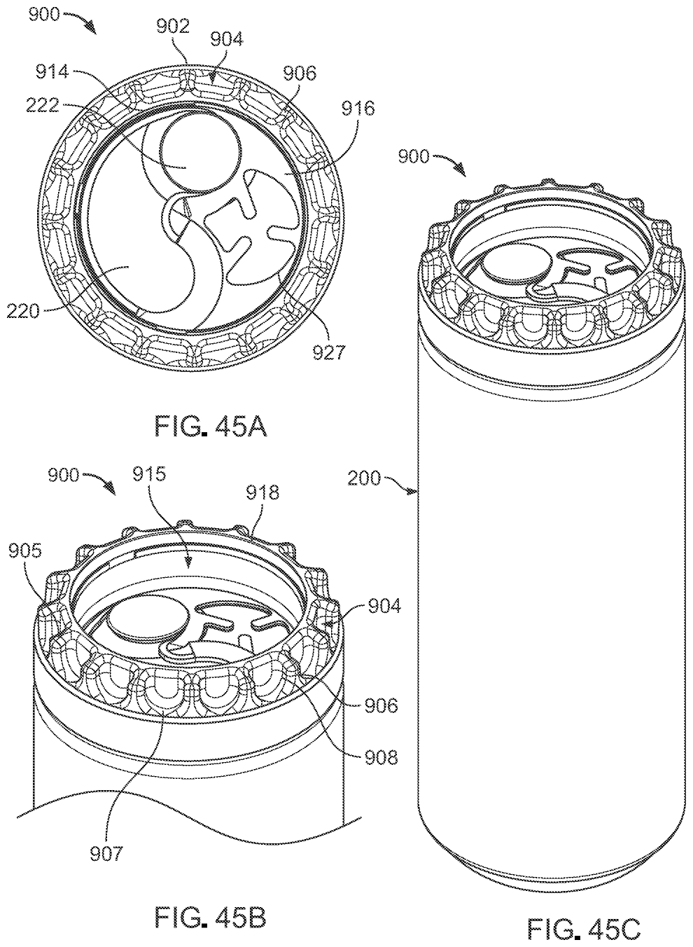

Some annular members have protrusions that engage recesses of the shearing cap instead of recesses that receive drive lugs of the shearing cap. For example, some annular members include four radially inward extending protrusions or axially extending protrusions. Some annular members include protrusions as part of a self-seating system as described with reference to FIGS. 45A-50B.

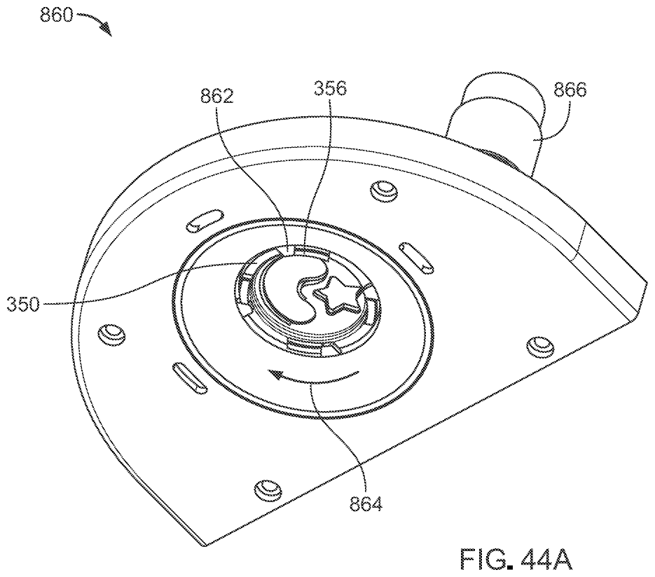

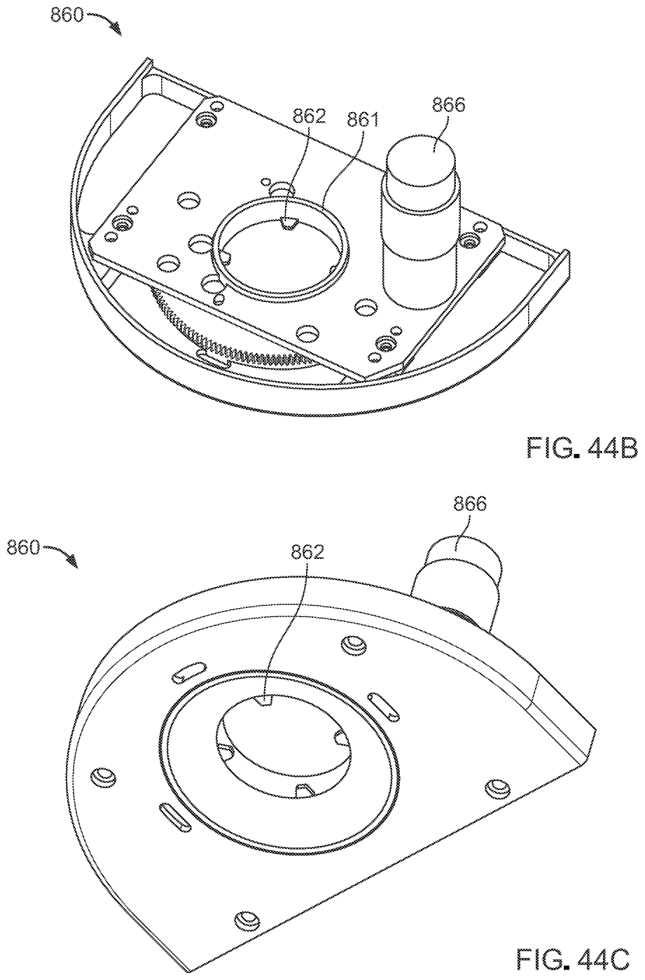

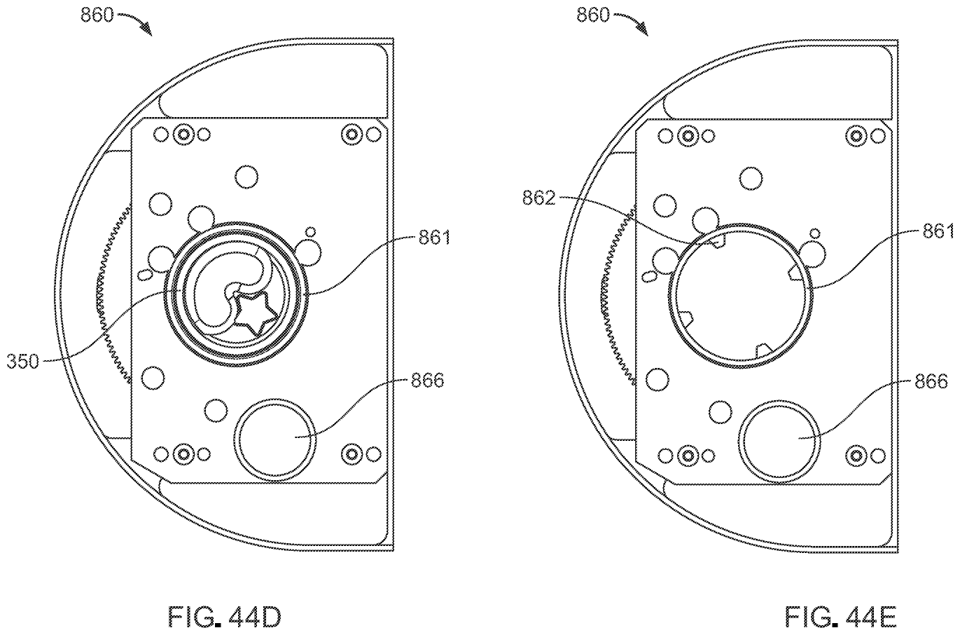

FIGS. 44A-44E are plan and perspective views of a drive mechanism 860 for the machine 100. The drive mechanism 860 includes an annular member 861 with four drive features 862 (e.g., radially-inward extending protrusions) that engage with drive lugs of a shearing cap. In this example, the pod 200 includes shearing cap 350, but other shearing caps can be used with drive mechanism 860.

FIG. 44A is an isometric bottom view of the drive mechanism 860 with the shearing cap 350 in position within the drive mechanism 860. FIG. 44B is an isometric top view of the drive mechanism 860. FIG. 44C is an isometric bottom view of the drive mechanism 860. FIG. 44D is a top view of the drive mechanism 860 showing a shearing cap 350 in place. FIG. 44E is the same view as shown in FIG. 44A except a shearing cap is not shown.

The drive mechanism 860 includes drive features 862 located on an inner diameter surface of the annular member 861 that rotationally engage corresponding drive lugs 356 of cap 350 (or walls of recesses of cap 760, for example). In this example, the drive mechanism 860 includes four equally spaced drive features 862 that engage a respective number of drive lugs 356. Each of the four drive features 862 span a small (e.g., less than 20 degree) portion of the circumference around the annular member 861 to reduce the chances of the drive lugs 356 landing directly on top of the drive features 862. Other drive mechanisms include more than four drive feature (e.g., 5-10) and other drive mechanisms includes less than four drive features (e.g., 1-3).

As a user inserts a pod with a shearing cap into the machine 100, the pod slides through the opening of the evaporator 154 with a first amount of friction between the sidewall of the pod and the sidewall of the evaporator 154. In some examples, this first amount of friction is caused by the close proximity of the sidewall of the pod and the sidewall of the evaporator 154. In some examples, this close proximity is a gap of between 0.01″ and 0.035.″ In some examples, this close proximity is a gap of between 0.005″ and 0.05.″

After the user inserts the pod into the opening of the evaporator, the machine 100 controls the shearing motor 866 to cause the drive features 862 to rotate in a clockwise direction 864 (e.g., via one or more gears). The drive features 862 rotate with respect to the pod because the sidewall of the pod is frictionally engaged with the sidewall of the evaporator (e.g., by the first amount of friction). The first amount of friction is sufficient to restrict a rotation of the pod while the shearing motor 866 rotates the drive features 862 underneath the drive lugs 356. For example, if a user inserts the pod so that the drive lugs 356 land directly on top of the drive features 862, then the machine 100 rotates the shearing motor 866 to rotate the drive features 862 circumferentially away from the drive lugs 356 with the body of the pod stationary (or substantially stationary). Once the drive features 862 are rotated away from the drive lugs 356, the pod can be completely inserted into the machine 100 by the weight of the product within the pod, by the drive shaft of the machine pushing down on the pod (e.g., via engagement with the drive head of the mixing paddle), or, by the user. In the completely inserted position, the drive lugs 356 are located in the same plane as the drive features 862.

In some examples, the weight of the product inside the pod provides sufficient force to overcome the first amount of friction and allow the pod to slide through the opening of the evaporator without needing to be pressed into the machine 100 by the user. In some examples, the user can press the pod into the opening of the evaporator to overcome the first amount of friction and assist the pod into the machine 100. In some examples, the user must press the pod into the opening of the evaporator to overcome the first amount of friction.

In some examples, the pod drops into the completely inserted position automatically (e.g., under the weight of the product within the pod without user assistance), and the drive lugs 356 are appropriately located in the same plane as the drive features 862. In some examples, a user inserts the pod into the machine 100 and, even if the drive lugs 356 land directly on top of the drive features 862, the machine 100 controls the drive features 862 to rotate away from the drive lugs 356 and then the pod automatically drops into the fully inserted position. This process allows the user to insert the pod into the evaporator of the machine in any angular orientation (e.g., without regard to whether the shearing cap drive lugs 356 or walls of the recesses of cap 760 are in the proper seated position with respect to the drive features 862) and without additional user intervention. In some cases, the substantial lack of friction between the drive lugs 356 and the drive features 862 can be advantageous to ensure the pod does not rotate with respect to the evaporator 154 during this process.

Once the pod has been completely inserted into the machine 100, the machine 100 continues to control the shearing motor 866 to cause the drive features 862 to rotate in the clockwise direction 864 (e.g., using the cap shearing system 830). This rotation causes a further rotation of the drive features 862 with respect to the body of the pod so that the drive features 862 engage the drive lugs 356. In some examples, this amount of rotation is a quarter-turn, a half-turn, and/or a full-turn. In some examples, this amount of rotation can be up to a full-turn, e.g., between 0 and 360 degrees. This rotation causes each of the drive lugs 356 to become circumferentially engaged with the corresponding drive features 862 (e.g., in the position shown in FIG. 44A). In some examples, this rotation continues even after the drive lugs 356 are circumferentially engaged with corresponding drive features 862. In this case, the shearing cap 350 and the body of the pod both rotate with respect to the evaporator and the first amount of friction is overcome by the rotation of the shearing motor 866.

Prior to (and/or during) the freezing process, the machine 100 controls the evaporator 154 to clamp down on the pod. This clamping improves thermal conductivity between the pod and the evaporator and increases the amount of friction between the pod and the evaporator from the first amount to a second, increased, amount. While the first amount of friction still allows the machine 100 to rotate the pod within the evaporator (as described in the immediately preceding paragraph), the increased amount of friction is sufficient to prevent a rotation of the pod with respect to the evaporator 154 during the protrusion shearing process to remove the protrusion from the base of the pod to form an aperture to dispense the cooled food or drink.

The machine 100 performs the protrusion shearing process during dispensing. In particular, the machine 100 controls the shearing motor 866 to rotate the drive features 862 further. This further rotation causes the shearing cap 350 to rotate with respect to the body of the pod because the body of the pod is rotationally constrained within the evaporator by the second amount of friction. This rotation of the shearing cap 350 with respect to the pod causes the protrusion of the pod to ride along the ramp shearing features of the shearing cap 350. This action serves to cut off the protrusion from the base of the pod and open an aperture for dispensing the product from the pod.

The shearing motor 866 can apply up to 1,000 ozf-inches of torque to lift and shear off the protrusion of the pod. In some machines, the shearing motor 866 slows down during the protrusion shearing process, and then speeds up during the dispensing process. In this case, it is advantageous for the driveshaft to rotate without stopping or reversing through the mixing, shearing, and dispensing cycle in order to reduce the likelihood of the shearing motor 866 stalling.

Some pods have a dispensing mechanism that includes a pop top that can be engaged and released by the machine. When the refrigeration cycle is complete, an arm of the machine engages and lifts a tab of the pod, thereby pressing and puncturing the base and creating an aperture in the base. Chilled or frozen product is dispensed through the aperture. The punctured surface of the base remains hinged to base and is retained inside the pod during dispensing. The mixing avoids or rotates over the punctured surface so that the mixing paddle continues to rotate without obstruction. In some pop tops, the arm of the machine separates the punctured surface from the base.

FIGS. 45A-45C are views of a pod 200 with a self-seating cap 900 attached to an end of the pod 200. The self-seating cap 900 includes a body 902 with a plurality of recesses 904 arranged circumferentially around the body 902. Cap 900 is substantially similar to cap 760.

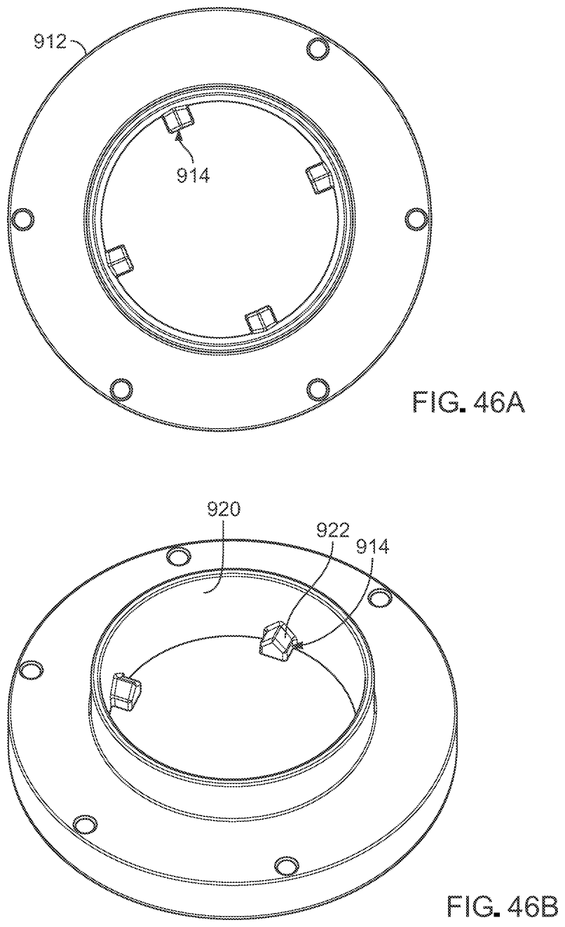

FIGS. 46A and 46B are views of an annular member 912 for the machine 100 with drive features 914 (e.g., guide pins) that are received within the recesses 904 of the self-seating cap 900 to seat the pod 200 within the machine 100 and rotationally couple the self-seating cap 900 to the machine 100. In some examples, the self-seating cap design significantly reduces the chances of the pod 200 being inserted with the top surfaces 905 of the drive lugs of the caps being located gingerly on the drive features 914 of the annular member 912. It also reduces the chances of requiring a user to intervene to fully seat the pod 200 within the machine 100.

The cap 900 extends over at least part of the base 220 of the pod 200 and is rotatable relative to the base 220. The cap 900 has a plurality of axially extending protrusions 906 defining the plurality of recesses 904. The cap 900 includes a circumferentially extending wall 918. In some examples, the axially extending protrusions 906 are also defined by a plurality of radially extending walls 906 that extend radially outward from the circumferentially extending wall 918. The circumferentially extending wall 918 and the plurality of radially extending walls 906 further define the plurality of recesses 904 of the self-seating cap 900.

The axially extending protrusions 906 have a thickness that varies along an axial direction of the pod 200. The axially extending protrusions 906 have curved surfaces 908 that face into the plurality of recesses 904 of the cap 900. The axially extending protrusions 906 have a height (along the axial direction) that varies along a circumferential direction due to one or more radiussed or bevelled surfaces of the axially extending protrusions 906. The axial extending protrusions 906 are characterized by radiussed or bevelled sidewalls when projected in a radial direction. The height of the axially extending protrusions 906 varies along a radial direction. For example, the top surfaces 905 (“tops”) of the axially extending protrusions 906 are tapered such that the height is larger toward the center of the pod 200 and decreases in the outward radial direction.

Thickness of the top surfaces 905 of the axially extending protrusions 906 is less than spacing between the respective top surfaces 905 of the axially extending protrusions 906. An axially-projected surface area of the recesses 904 is greater than an axially-projected surface area of the axially extending protrusions 906. Each axially extending protrusion 906 has substantially the same profile when projected in a radial direction. The spacing between the each respective axially extending protrusion 906 is substantially the same. The recesses 904 of the cap 900 are substantially the same shape and size.

The cap 900 has an aperture 915 (or opening) that extends axially through the cap 900. The opening 915 is located centrally on the cap 900 and radially inward of the axially extending protrusions 906. The opening 915 is at least partially defined by an interior radial surface of the circumferentially extending wall 918. The cap 900 includes an insert 916 located within the opening 915 and attached to the body 902 of the cap 900. In some examples, the insert 916 is substantially the same as insert 764 of cap 760. In some examples, the cap 900 further includes the cover 766 of cap 760. The protrusion 222 of the base 220 of the pod 200 is located in its home position within the aperture of the insert 916.

In some examples, the body 902 of the cap 900 is formed of plastic (e.g., injection molded plastic) and the insert 916 is formed of metal (e.g., aluminum). In other examples, the body 902 and the insert 916 are both formed of metal (e.g., aluminum).

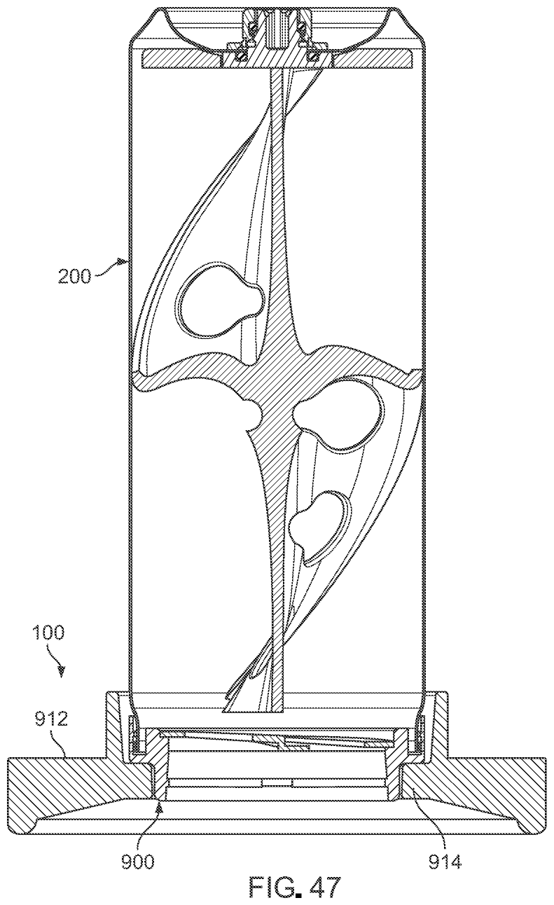

FIG. 47 is a cross-section view of the pod 200 with the cap 900 fully seated in the machine 100. The annular member 912 is rotatable relative to a longitudinal axis of the pod 200 when the pod 200 is received in the recess of the machine 100. For example, the annular member 912 is rotatable via the cap shearing system 830 or the drive mechanism 860.

The annular member 912 includes a plurality of radially-extending pins 914 sized and shaped to be inserted into at least a subset of the recesses 904 of the cap 900 when the pod 200 is received in the recess of the evaporator 154 of the machine 100 to rotationally couple the cap 900 to the annular member 912. Each radially-extending pin 914 extends in a radially inward direction from an inner cylindrical surface 920 of the annular member 912. Each radially-extending pin 914 has at least one angled surface 922. In some examples, each angled surface 922 contacts at least a subset of axially extending protrusions 906 to cause the cap 900 to rotate relative to the annular member 912 as the pod 200 is received in the recess of the evaporator 154 of the machine 100.

The annular member 912 includes four equally spaced radially-extending pins 914. In some examples, other annular members include more than four pins (e.g., 5-20 pins). In some cases, other annular members include less than four pins (e.g., 2 or 3). However, four pins 914 strike a good balance between being able to transmit the torque evenly to the cap and design complexity. In some cases, decreasing the number of pins also decreases the probability that the cap might sit on top of the pins such that the cap (and pod) wouldn't seat itself into place.

FIGS. 48A-48C are views of a prototype machine 100 and a pod 200 for use with the self-seating system. Some machines control a motor (e.g., shearing motors 842 or 866) to rotate the annular member 912 to assist in receiving the radially-extending pins 914 within at least the subset of the recesses 904 of the cap 900. For example, in the off chance that the surfaces 905 of the axial extending protrusions 906 land gingerly on the radially-extending pins 914, the machine 100 rotates the annular member 912 to cause the recesses 904 to align with the pins 914 so the pod 200 can be automatically seated in the machine 100 (e.g., under the weight of the contents of the pod without additional user assistance). In some examples, the alignment approach described with reference to the drive mechanism 860 is also used with the self-seating pod system.

FIGS. 48B and 48C are views from the bottom of the annular member 912. In FIG. 48B, the cap 900 is fully seated in the machine 100. Four radially-extending pins 914 are received in four of the sixteen recesses 904 of the cap 900. The radially-extending pins 914 are pentagon-shaped (e.g., have five sides). Some machines have other shaped pins. For example, some machines have a triangular-shaped pin, a diamond-shaped pin, a square-shaped pin, elliptical-shaped pins, or cylindrical pins. The pins 914 are integrally formed with the annular member 912 and cannot move relative to the annular member 912.

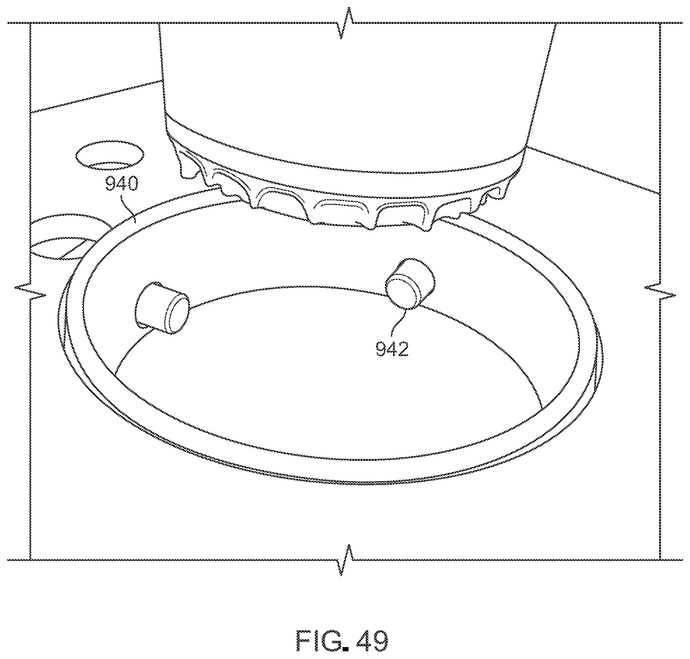

FIG. 49 is a perspective view of a prototype machine and pod for use with the self-seating system. The machine includes an annular member 940 with cylindrical pins 942 instead of pentagon-shaped pins 914. Each cylindrical pin 942 is rotatable along a respective longitudinal axis of the cylindrical pin 942. Four radially-extending pins 942 are substantially equally spaced around the circumference of the annular member 940. Each radially-extending pin has at least one curved surface.

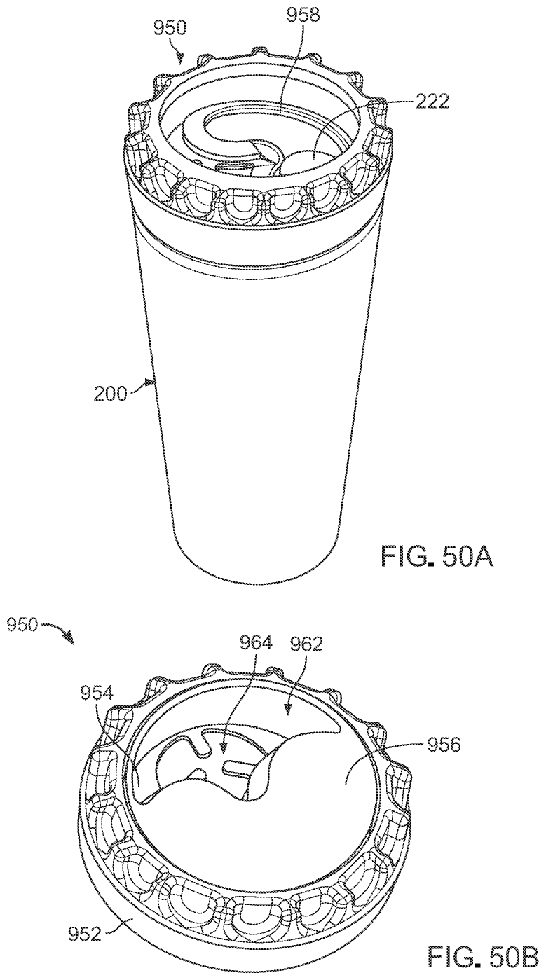

FIGS. 50A and 50B are perspective views of a pod 200 with a prototype cap 950 installed on an end of the pod 200. The cap 950 includes a cap body 952 (shear tray), an insert 954 (shear drive), and a cover 956. FIG. 50A shows the cap 950 with the cover 956 removed to show the protrusion 222 of the pod 200 and the ramp features 958 of the aperture that engages the protrusion 222 to remove the protrusion 222. FIG. 50B shows the cap 950 with the cover 956 installed to show that the protrusion 222 of the pod 200 and aperture with the ramped surfaces 958 are hidden from view. The cover 956 has an aperture 962 that aligns with the dispensing port 964.

Methods for using the self-seating system include one or more of the following features. A user inserts a pod 200 into a recess of the machine 100. In some examples, this recess is defined by the evaporator 154 of the refrigeration system of the machine 100. In some examples, the pod contains ingredients for producing a single serving of a cooled food or drink.

The pod includes a cap 900 attached to a base of the pod 200 and rotatable relative to the base of the pod 200. In some cases, inserting the pod 200 into the recess of the machine 100 causes a plurality of radially-extending pins 922 of an annular member 912 of the machine to contact at least a subset of the plurality of recesses 904 in the cap 900 to seat the pod 200 into the machine 100 and rotationally couple the cap 900 to the annular member 912. In some examples, seating the pod 200 into the machine 100 is performed without user assistance. In some examples, inserting the pod 200 into the recess of the machine 100 includes contacting the plurality of the radially-extending pins 914 with at least a subset of top surfaces 905 of the plurality of axially-extending protrusions 906 of the cap 900.

In some examples, after contacting the plurality of radially-extending pins 914 with at least the subset of the tops 905 of the plurality of axially-extending protrusions 906, the machine 100 rotates the cap 900 relative to the annular member 912 without user assistance. In some examples, inserting the pod 200 into the recess of the machine 100 includes contacting bottom surfaces 907 of the subset of the plurality of recesses 904 of the cap 900 with the plurality of radially-extending pins 914. In some examples, after contacting the plurality of radially-extending pins 914 with at least the subset of the tops 905 of the plurality of axially-extending protrusions 906, the profiles of the tops 905 of the plurality of axially-extending protrusions 906 and/or the weight of the product within the pod causes the bottom surfaces 907 of the subset of the plurality of recesses 904 of the cap 900 to contact the plurality of radially-extending pins 914.

Some machines rotate an insert 916 of the cap 900 relative to a base of the pod 200 to form or expose an opening in the base of the pod 200. In some examples, rotating the insert 916 of the cap 900 relative to the base of the pod 200 includes moving a dispensing port 927 of the insert 916 relative to the base of the pod 200. For example, the machine controls the shearing motor to rotate the cap 900 which rotates the insert 916 relative to the base of the pod 200. Some machines dispense the produced single serving of the cooled food or drink through the opening of the base of the pod 200 and the dispensing port 927 of the insert 916 of the cap 900.

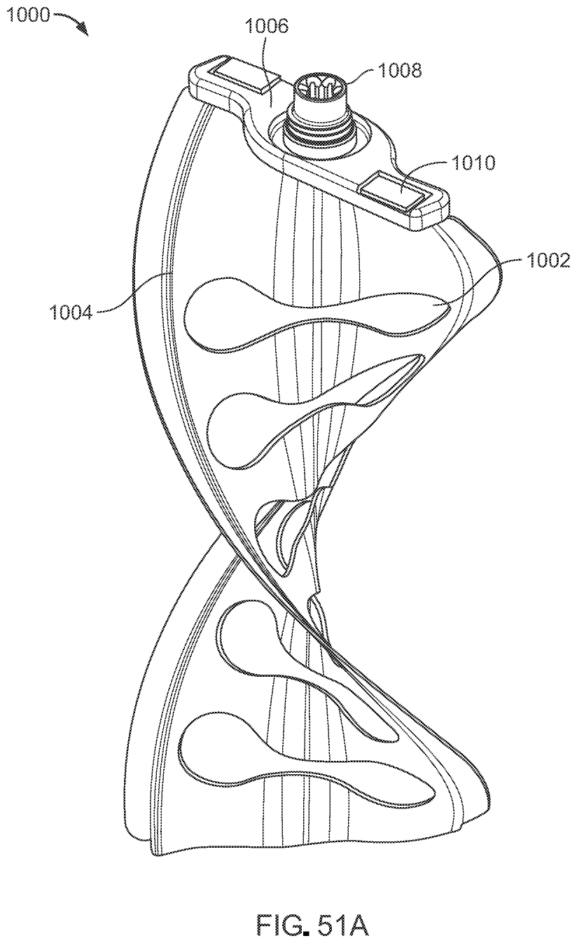

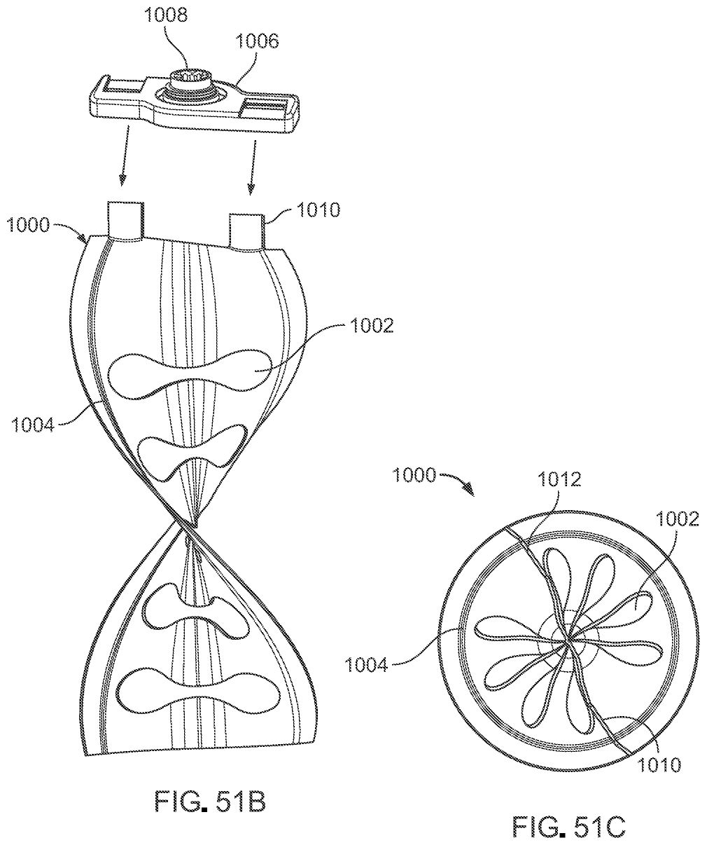

FIGS. 51A-51C are perspective views of a mixing paddle 1000 for a pod 200. The mixing paddle 1000 is concentrically positioned within the pod 200 (the pod is not shown in FIGS. 41A-51C). The mixing paddle 1000 is molded or otherwise formed into a structure with hourglass openings 1002.

In some examples, the hourglass pattern allows/facilitates stamping the geometry of the mixing paddle 1000 without the body of the mixing paddle buckling. In some examples, mixing paddle 1000 is formed in a sequential stamping operation. Mixing paddle 1000 is formed such that the helical structure has a constant pitch. In some examples, the constant pitch between 40 and 60 degrees/in (e.g., 52 degrees/inch). Some mixing paddles have varying pitch. The mixing paddle 1000 is stamped with hourglass cutout openings 1002. The hourglass cutouts 1002 provide rigidity and prevent the structure from buckling during stamping. Some mixing paddles have different numbers and spatial distributions of the cutouts 1002. These paddles can also be formed with the cutouts of different shapes, for example, like the mixing paddles described in filed Mar. 19, 2020, both of which are incorporated herein by reference in their entirety. In some cases, side ribs 1004 are added for rigidity.

The mixing paddle 1000 is attached to a drive head 1006 that includes a keyed female receptacle 1008 for receiving a drive shaft of the machine and rotationally coupling a drive motor of the machine to the mixing paddle 1000. The mixing paddle 1000 is attached to the drive head 1006 via two axially-extending tabs 1010 by bending the sheet metal on the end of a mixing paddle 1000. The tabs 1010 are integrally formed with the body of the mixing paddle 1000 and are bendable. In some cases, the drive head 1006 is integrally formed with the mixing paddle 1000, i.e., a unibody construction.

FIG. 51C is a top view of the mixing paddle 1000 without the drive head 1006 attached showing the cross-section 1012 of the mixing paddle 1000. The cross-section 1012 is perpendicular to a longitudinal axis of the mixing paddle 1000 and has at least one curved, non-linear, or angled section. Mixing paddles with at least one curved, non-linear, or angled section provide multiple advantages over a mixing paddle that does not include at least one curved, non-linear, or angled section. In some examples, the resiliency provided by a curved, non-linear, or angled section allows the mixing paddle to maintain direct contact with the inner surface of the sidewall of the pod as the mixing paddle 1000 rotates within the pod. This improves mixing of the ingredients while the machine 100 produces the frozen confection. In some examples, the cross-section has a larger bending, torsional, and flexural stiffness that reduces the flexing of the mixing paddle 1000 during the mixing cycle. For example, as the ingredients cool they become more viscous. This increased viscosity combined with high rotational rates of the mixing paddle (e.g., over 200 RPM) can cause significant forces and stress on the mixing paddle. The outer edges of the mixing paddle in particular bear the brunt of the high stresses where the linear velocity of the mixing paddle is the largest. A cross-section with at least one curved, non-linear, or angled section provides increased stiffness to counter this effect and reduce deflection at the outer edges of the mixing paddle.

FIGS. 52A-52C are perspective views of a mixing paddle 1030 with circular cutouts 1032, a circular region 1034 for engaging a drive head, and a cross-section 1036 with a non-linear shape. Mixing paddle 1030 is substantially similar to mixing paddle 250 shown in FIG. 2. The cross-section 1036 is taken perpendicular to a longitudinal axis of the mixing paddle 1030. At least a portion of the cross-section 1036 is curved, non-linear, angled, wavy, periodic, and/or undulating. In particular, the cross-section 1036 defines an “S” shape that spans the entire cross-section 1036 (e.g., from a first end 1042A to an opposite second end 1042B). In some examples, “S”-shape means that a mid-plane of the cross-section rotates through an “S” pattern as the mid-plane transverses from the first end 1042A to the second end 1042B. In some examples, a portion of the S″-shape is a “C”-shape. For example, regions 1038A and 1038B are both “C”-shaped. The mixing paddle 1030 exhibits cyclic symmetry about the longitudinal axis.

The cross-section 1036 includes a pair of convex features 1038A, 1038B each spaced approximately equidistant from the longitudinal axis of the mixing paddle 1030. The convex features 1038 are convex with respect to a rotational direction 1040 of the mixing paddle 1030. The rotational direction 1040 is the particular rotational direction used to mix the ingredients disposed within the interior of the pod to produce the single serving of the cooled food or drink. The convex features 1038A, 1038B span a majority of the cross-section of the mixing paddle (e.g., greater than 50% of the entire span of the cross-section). The convex features 1038A, 1038B are “C”-shaped. The ends 1042A, 1042B of the cross-section 1036 are the ends of the convex features 1038A, 1038B and contact the inner surface of the pod (the inner surface of the pod sidewall is schematically shown by circle 1064).

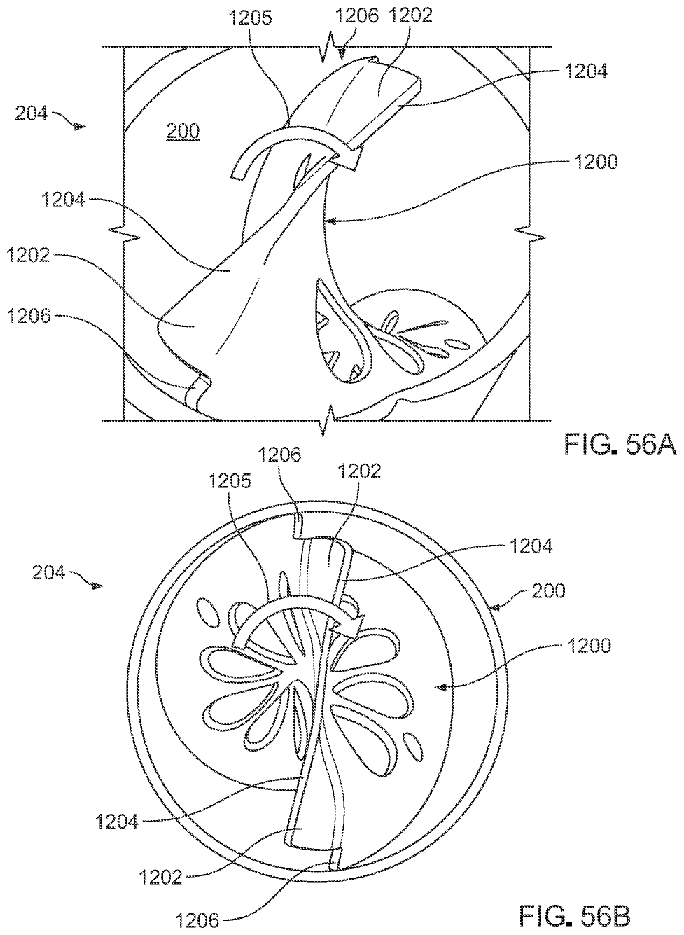

The mixing paddle 1030 includes two perpendicular surfaces (or “shoes”) 1033 that ride along the inside surface of the base of a pod (e.g., the base 220 of pod 200). The perpendicular surfaces 1033 function like a plow to scoop ingredients (e.g., free, stuck, or frozen ingredients) that are located on the base 220 of the pod 200 to aid in producing a uniform single serving of a cooled food or drink. Further details about the perpendicular surfaces 1033 are described with reference to FIGS. 56A and 56B.

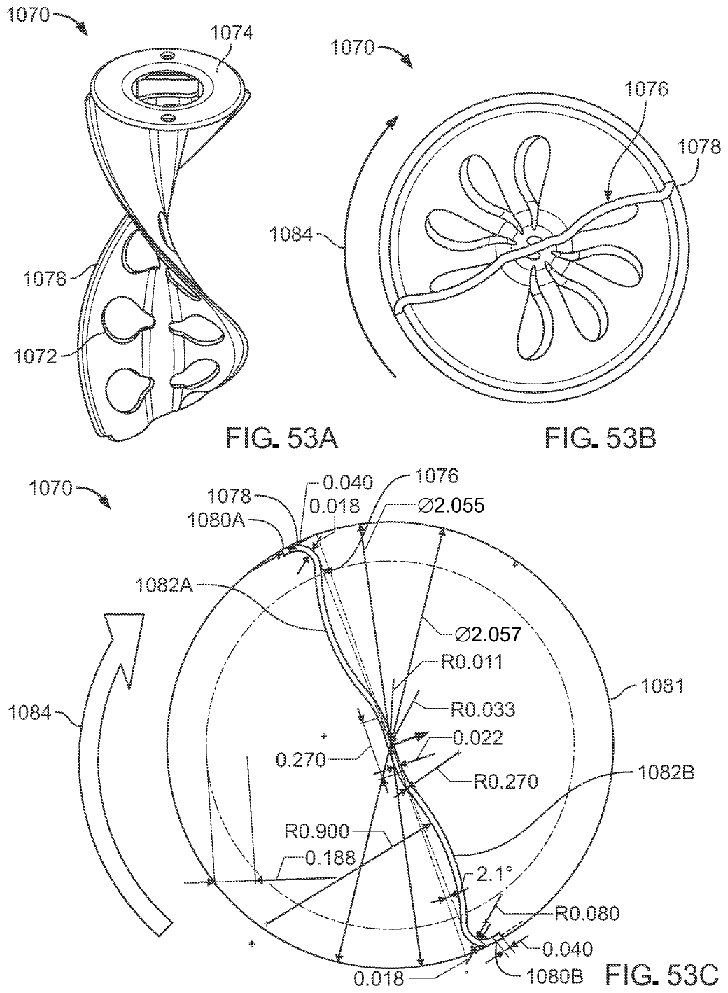

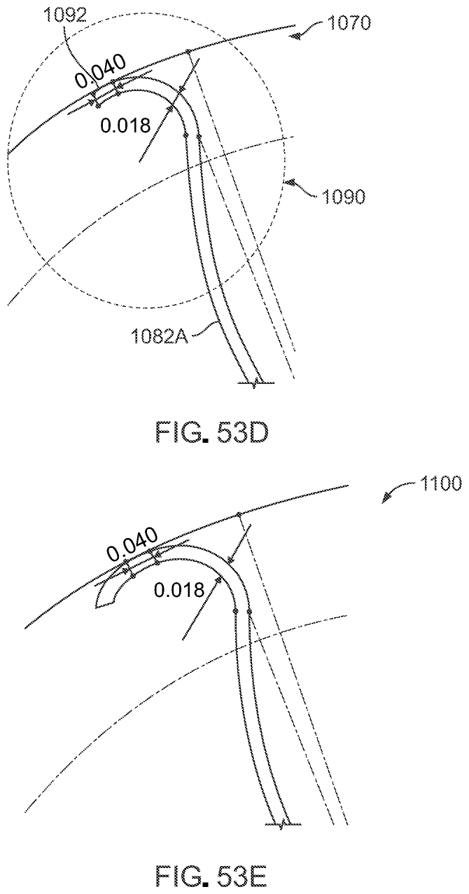

FIGS. 53A-53E are perspective views of a mixing paddle 1070 with tear-drop-sized cutouts 1072, a flanged region 1074 for engaging a drive head, and a cross-section 1076 with a non-linear shape. The distinct shape of mixing paddle 1070 is different from mixing paddle 1030. During testing, mixing paddle 1070 accounted for a 20-30 second reduction in freeze time compared to mixing paddle 1030. This reduction in freeze time is attributed to the mixing paddle 1070 having a concave shape 1082A, 1082B in the direction of travel, rather than a convex shape as described with reference to the mixing paddle 1030. The convex shape of mixing paddle 1030 allows mixing paddle 1030 to flex backwards and not apply as much pressure to the sidewall of the pod. The concave shape of mixing paddle 1070 keeps the edges 1080A, 1080B of the mixing paddle 1030 pressed up against the sidewall of the pod and allows the mixing paddle 1070 to “scoop” the ingredients within the pod.

The mixing paddle 1070 includes a curved edge profile 1078 at the pod sidewall (the inner surface of the pod sidewall is schematically represented by the circle 1081) providing a larger contact area with the inner surface of the pod. The curved edge profile 1078 allows for more ice to be scraped/removed from the pod sidewall than mixing paddle designs without a curved edge profile 1078. The curved edge profile 1078 allows the mixing paddle 1070 to be used with various pod geometries (e.g., diameter variations, shape variations, etc.).

The mixing paddle 1070 is concentrically disposed within the interior of the pod such that the longitudinal axis of the body of the pod is coincident with the longitudinal axis of the mixing paddle 1070. The cross-section 1076 is taken perpendicular to a longitudinal axis of the mixing paddle 1070. Like the mixing paddle 1030, at least a portion of the cross-section 1076 is curved, non-linear, wavy, periodic, and/or undulating. In particular, the cross-section 1076 defines an “S” shape that spans the entire cross-section 1076 (e.g., from a first end 1080A to an opposite second end 1080B). In some examples, a portion of the S″-shape is a “C”-shape. For example, regions 1082A and 1082B are both “C”-shaped (or “scoop-shaped”). The mixing paddle 1070 exhibits cyclic symmetry about the longitudinal axis.

The cross-section 1076 includes a pair of concave features 1082A, 1082B each spaced approximately equidistant from the longitudinal axis of the mixing paddle 1070. The concave features 1082A, 1082B are concave with respect to a rotational direction 1084 of the mixing paddle 1070 used for mixing the ingredients to produce a serving of the cooled food or drink. For example, the machine rotates the mixing paddle 1070 in the rotational direction 1084 to mix the ingredients while cooling the pod to produce the cooled food or drink. The concave features 1082A, 1082B span a majority of the length of the cross-section 1076.

A radius-to-thickness ratio of the concave (or convex) features is defined by the expression:

$$N = \frac{r}{t}$$

where N is the radius-to-thickness ratio; r is the radius of the concave features 1082A, 1082B (or the convex features 1038A, 1038B of mixing paddle 1030); and t is the thickness the cross-section 1076. Some mixing paddles have a radius r between 0.6 and 1.2 inches, some have a radius r between 0.8 and 1.0 inches, and some have a radius r of 0.90 inches. Some mixing paddles have a thickness t between 0.1 and 0.4 inches, some mixing paddles have a thickness t between 0.1 and 0.3 inches, and some mixing paddles have a thickness t of 0.16 or 0.22 inches.

Some mixing paddles have a radius-to-thickness N value between 1 and 10, some have a radius-to-thickness N value between 3 and 6, and some have a radius-to-thickness N value of 4.09 or 5.26. For example, with a thickness of 0.22, mixing paddle 1070 has concave features 1082A, 1082B that have a radius-to-thickness N value of 4.09. With a thickness of 0.16, a similar mixing paddle would have concave features with a radius-to-thickness N value of 5.26.

The cross-section 1076 has two radial end portions 1090 (shown in FIG. 53D) that are curved in an opposite direction relative to the concave features 1082A, 1082B. The first end 1080A has a radial end portion 1090 that is curved in an opposite direction relative to the concave feature 1082A and the second end 1080B has a radial end portion 1090 that is curved in an opposite direction relative to the concave feature 1082B. The two radial end portions 1090 contact the sidewall of the body of the pod at one or more rotational positions of the mixing paddle 1070 within the pod. For example, the two radial end portions 1090 continuously contact the sidewall of the body of the pod as the mixing paddle 1070 revolves 360 degrees relative to the sidewall of the pod. At least a portion of each of the two radial end portions 1090 is tangent to the inner surface of the sidewall of the pod at the one or more rotational positions of the mixing paddle within the pod. For example, at least portion 1092 is tangent to the sidewall of the pod at all rotational positions of the mixing paddle 1070 within the pod.

The mixing paddle 1070 has one or more windows 1072 passing through it. The mixing paddle 1070 has two windows horizontally (radially or side-by-side along the plane of the cross-section 1076) and a plurality of windows 1072 arranged vertically (along the axis of the mixing paddle 1070). The windows 1072 have mirror symmetry about the longitudinal axis of the mixing paddle 1070. The windows 1072 are tear-drop shaped but could be other shapes as well (e.g., circular, rectangular, etc.).

The mixing paddle 1070 is longitudinally helical along the longitudinal axis of the mixing paddle 1070. Some mixing paddles have a constant helical pitch between 40 and 60 degrees/inch. Some mixing paddles have a constant helical pitch of 52 degrees/inch. Some mixing paddles have a varying pitch that varies with axial position.

The mixing paddle 1070 and the sidewall of the pod are formed of a metallic alloy (e.g., aluminum). The mixing paddle 1070 is coated (e.g., electrostatically coated). The sidewall of some pods are coated with a layer of coating and the mixing paddle 1070 is sized to contact the layer of coating for one or more rotational positions of the mixing paddle 1070 within the pod. In some examples, the layer of coating is a layer of PET laminated coating. The layer of coating is sized such that the coating does not rub off during the cooling and mixing cycle of the pod. For example, tests have shown that the rounded edge profile 1090 reduces damage to the coating on the inside surface of the pod, improving the enamel rating (ER).

The drive shaft 122 of the machine 100 (as shown in FIGS. 6A-7B) lowers into a keyed recess of the drive head of the pod to rotationally couple a mixing motor to the mixing paddle 1070. The machine controls the mixing motor to spin the mixing paddle 1070 in rotational direction 1084 such that edges of the mixing paddle 1070 scrape an inner surface of the pod to remove built-up frozen ingredients located on the inner surface of the pod. The machine controls the mixing motor to rotate the mixing paddle 1070 to force the ingredients in an axial direction of the pod and through at least two windows 1072 of the mixing paddle 1070. The machine controls the mixing motor to rotate the mixing paddle 1070 to force the produced single serving of the cooled food or drink out of the pod after the pod is opened as part of the dispensing process.

Some mixing paddles include ribs or other features to increase torsional resistance. Some mixing paddles exhibit high torsional rigidity (e.g., greater than 15 ozf-in) and a high torque to failure limit (e.g., greater than 150 ozf-in). Some mixing paddles have a low surface roughness (e.g., less than 8-16 Ra micro-inches) to prevent product from sticking to the mixing paddle and to help remove product that sticks to the mixing paddle. With mixing paddles having a surface roughness between 8-16 Ra micro-inches, these machines evacuate at least 85% of the frozen confection in the pod and usually 95%. Some mixing paddles have a recess at the second end of the mixing paddle, allowing the mixing paddle to be turned to the center axis of the mixing paddle. During manufacturing, the twist of the mixing paddle at the bottom can be very large 100° to 150° which can be a problem for the stamping process which can tear the material of the mixing paddle. A cut notch (not shown) in the center of the bottom of the mixing paddle blades enables the mixing paddle to be formed without tearing the material.

Some devices for mixing food or drink include a body having a longitudinal mixing paddle. Some bodies have a cross-section along a direction perpendicular to the longitudinal axis of the body where at least a portion of the cross-section is S-shaped. For example, mixing paddles 1030 and 1070 have “S”-shaped cross-sections. Some bodies have at least two windows passing through the cross-section of the body. For example, mixing paddles 1030 and 1070 have a plurality of windows 1072.

Some bodies are sized and shaped such that, when the device is rotated within the pod while the pod is cooled: (i) edges of the device scrape an inner surface of the pod to remove built-up frozen ingredients located on the inner surface of the pod; (ii) the S-shaped portion of the body forces ingredients in an axial direction in the pod and through the at least two windows; and (iii) the device forces frozen confection out of the pod after the pod is opened. For example, mixing paddles 1030 and 1070 have all of these features.

FIG. 53D shows a modified version of the mixing paddle 1070 with a more pronounced “hook”-shape at the radial ends. The mixing paddle 1100 is otherwise the same as mixing paddle 1070. This “hook”-shape is advantageous because it allows the mixing paddle to accommodate larger pod diameter variations due to a “spring-like” behavior. As shown in FIG. 53E, the radial ends of the mixing paddle extend beyond the tangent point with the sidewall of the pod and curve back towards the longitudinal axis of the mixing paddle.

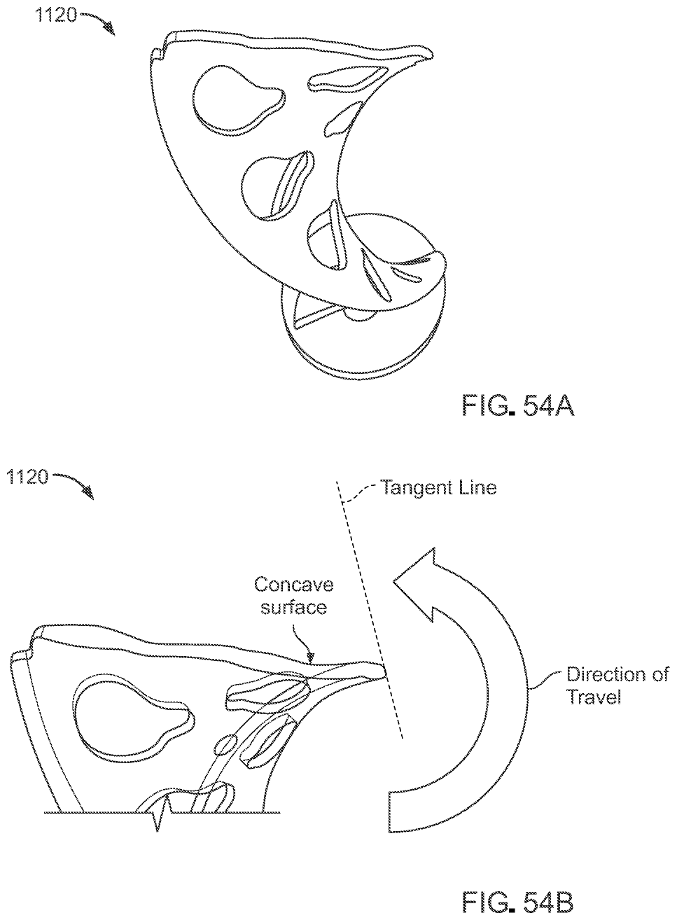

FIGS. 54A and 54B are perspective views of a prototype mixing paddle 1120 that substantially represents the mixing paddle 1070. FIGS. 54A and 54B show the bottom of the mixing paddle 1120, i.e., the end that would be adjacent to the base of a pod if the mixing paddle 1120 were inserted into the pod.

Some mixing paddles are over-molded with a polymer to squeegee frozen ice cream from the inside of the pod. In some examples, the mixing paddle is an aluminum paddle that is formed by stamping and/or is bent/twisted. In some examples, the mixing paddle is cast, forged, or machined. Ribs on the sides, top, and/or bottom of the mixing paddle provide extra stiffness to the thin areas of the mixing paddle. This extra stiffness is important since the thin areas of the mixing paddle are subject to large torques from the drive head during the mixing process and reduces deformation of the aluminum paddle under this applied torque. Some mixing paddles have edge molds that are molded (i.e., poured and cast) in place over each edge of the mixing paddle, respectively. This process is often referred to as “over-molding,” and can create a part with multiple materials. This over-molded edge can assist with squeegeeing the inner surface of the sidewall of the pod.

In some cases, dip coating of plastic is used to coat the mixing paddles to prevent them from directly contacting and rotating on a metal lid and/or pod walls. In some cases, a polyolefin coating is used.

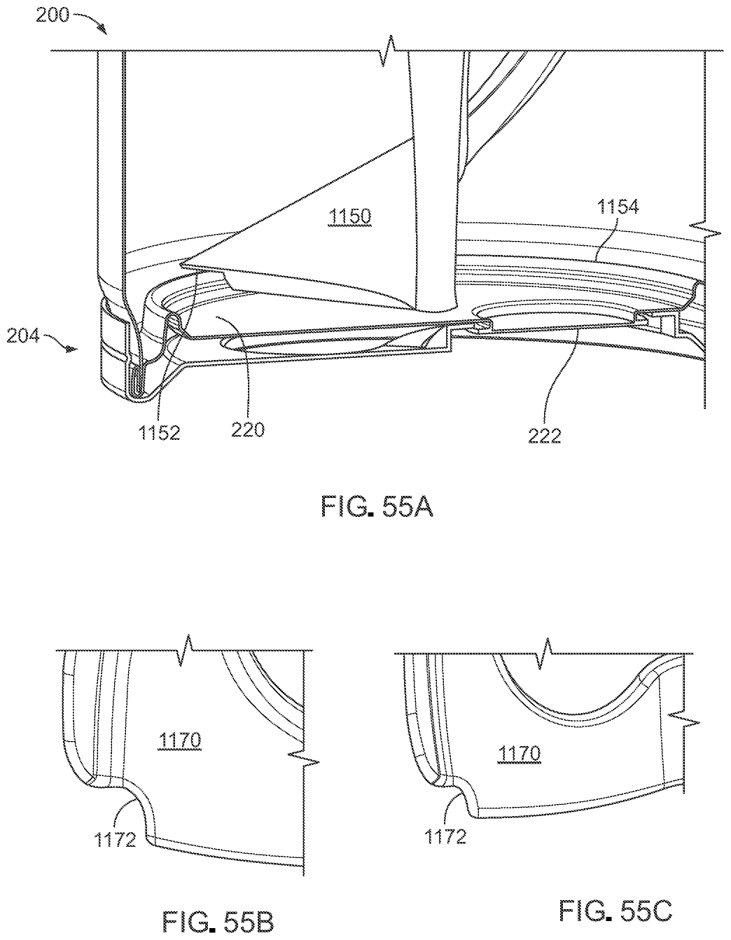

FIG. 55A shows a mixing paddle 1150 with a pair of notches 1152. Notches 1152 are sized such that they fit over a lip 1154 on the inside of the base 220 of the pod 200. Although shown on mixing paddle 1150, other mixing paddles can also include such notches. Once the mixing paddle is axially lowered to engage the lip 1154 (e.g., via a threaded engagement of the drive head of the mixing paddle with the pod 200), the mixing paddle 1150 rotates along the lip 1154 to help keep the mixing paddle 1150 concentrically positioned within the pod 200 and to help provide structural support to the mixing paddle 1150.

FIGS. 55B and 55C show a mixing paddle 1170 that is substantially the same as mixing paddle 1150 but the notch has a slightly different design. The notch 1172 has a curved profile and a radius instead of the hard edges and angles of mixing paddle 1150.

FIGS. 56A and 56B are perspective views of a mixing paddle 1200 that includes two perpendicular surfaces (or “shoes”) 1202 that ride along the inside surface of the base of a pod (e.g., the base 220 of pod 200). Mixing paddle 1200 is a prototype of mixing paddle 1030 and includes the same features of mixing paddle 1030. As noted above, the perpendicular surfaces 1202 function like a plow to scoop ingredients (e.g., free, stuck, or frozen ingredients) that are located on the base 220 of the pod 200 to aid in producing a uniform single serving of a cooled food or drink.

For example, in machine 100, the pod 200 is inserted such that the first end 204 of the pod 200 is face down and the ingredients are forced against the base 220 of the pod 200 due to gravity. During a mixing cycle, the machine 100 rotates the mixing paddle 1200 in the direction represented by arrow 1205 such that leading edges 1204 of the perpendicular surfaces 1202 contact the ingredients on the base 220 of the pod 200 and lift the ingredients off the base 220 (e.g., vertically against the force of gravity) to distribute the ingredients within the pod to produce an even mixture.

The perpendicular surfaces 1202 are integrally formed with the body of the mixing paddle 1200 and extend perpendicular (or approximately perpendicular) to the longitudinal axis of the mixing paddle 1200. The mixing paddle 1200 includes two perpendicular surfaces 1202 that are positioned diametrically opposite each other. Notches 1206 are located radially outward of the perpendicular surfaces 1202. The notches 1206 are substantially the same as notches 1172 described with reference to FIGS. 55B and 55C. For example, the notches 1206 engage the lip 1154 to help maintain concentricity of the mixing paddle 1200 with respect to the sidewall of the pod 200 as it revolves around within the pod 200.

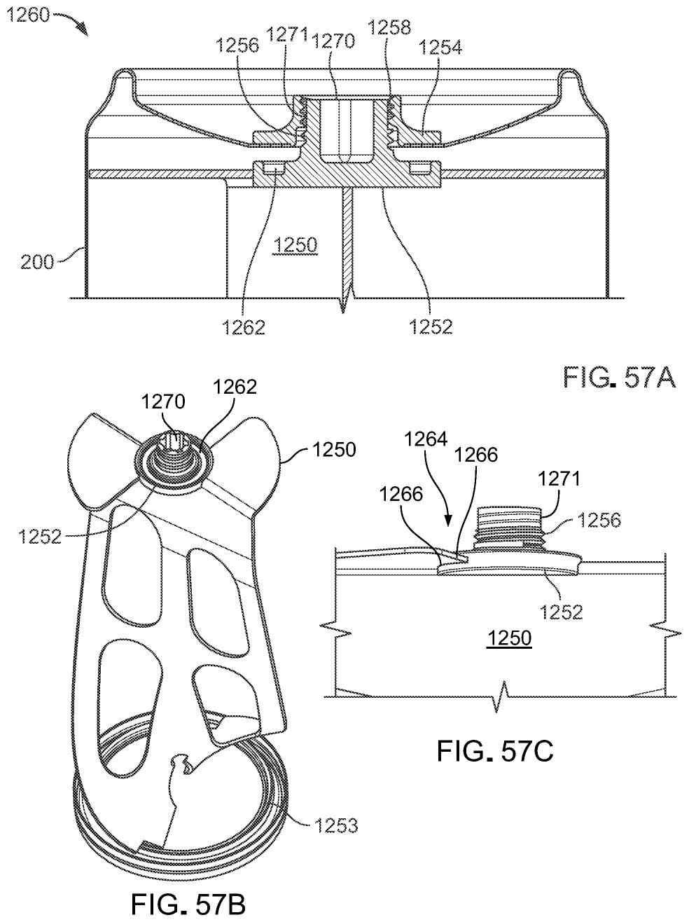

FIGS. 57A-57C are plan and perspective views of the mixing paddle 1250 of a pod 200 to form a mating drive assembly 1260. The mixing paddle 1250 is rotationally coupled to the mating drive head 1252 through a mechanical connection 1264 (best seen in FIG. 57C). The connection 1264 is preferably a welded connection, but other connections can be used. In some cases, the connection 1264 is a friction connection that is formed by engaging one or more grooves 1266 of the mating drive head 1252 onto complementary one or more edges of the mixing paddle 1250. In some cases, the connection 1264 is engaged by rotating the mating drive head 1252 relative to the mixing paddle 1250 90 degrees. In some cases, the connection 1264 is formed during the manufacturing process when the mating drive head 1252 is molded in the assembled position on the mixing paddle 1250 as shown in FIGS. 57A-57C. In some cases, the connection 1264 is adhered (e.g., glued). In some cases, the mechanical coupling is made with a fastener (e.g., a set screw).

A seal member 1254, which is substantially similar to seal member 1240, is adhered to the pod so it cannot move. Adhering the seal member 1254 can be performed with glue, rivets, or any process that would hold the seal member 1254 in place. In some cases, a UV curable glue is used. The seal member 1254 is shown on the outer surface of the pod 200, but in some pods, is on the interior of the pod. In some pods, the seal member 1254 spans the interior of the pod 200 to the exterior of the pod 200.

Exterior threads 1256 on a cylindrical outer surface of the mating drive head 1252 are configured to threadably engage with corresponding internal threads 1258 of the seal member 1254. During operation, the drive shaft 122 (not shown in FIGS. 57A-57C) of the machine 100 lowers into the receptacle 1270 of the mating drive head 1252. The receptacle 1270 is keyed (best seen in FIG. 57B) so that rotation is between the drive shaft 122 and the mating drive head 1252 is coupled. As the drive shaft 122 begins to rotate, the exterior threads 1256 begin to unscrew from the interior threads of the seal member 1254. This causes the mating drive head 1252 to lower itself into the pod 200. This lowering motion causes the mixing paddle 1250 to lower into the pod 200 as well, but the amount of lowering is preferably small by the using a small thread pitch of the threaded connection between the mating drive head 1252 and the seal member 1254. Once the external threads 1256 of the mating drive head 1252 lowers past the lower edge of the internal threads 1258 of the seal member 1254, the threaded connection disengages and the mating drive head 1252 (and the mixing paddle 1250) can freely spin within the pod 200 and the bottom of the mixing paddle 1250 lowers onto the lip 1253 of the pod 200. At this point during operation, the mixing paddle 1250 can spin under the control of the mixing motor of the machine 100.

The threaded connection between the exterior threads 1256 and the interior threads 1258 is reversible if the rotation of the mixing motor of the machine 100 is reversed. This allows the machine to reseal the pod 200.

The mating drive head 1252 also includes a cylindrical section 1271 that is configured to center the mating drive head 1252 and the mixing paddle 1250 in the pod 200 after the threaded connection between the exterior threads 1256 and the interior threads 1258 have disengaged. An outer diameter of the cylindrical section 1271 is slightly less than the internal diameter of the interior threads 1258 so that a rotational clearance is allowed but centering of the mixing paddle 1250 in the pod 200 is also possible.

The mating drive head 1252 also functions to seal the pod 200. Before the mating drive head 1252 is lowered into the position shown in FIG. 57A, an O-ring (not shown in FIGS. 57A-57C) which is located in a groove 1262 is pressed against the inside dome of the pod 200 forming a seal. This seal is complemented by the threaded connection between exterior threads 1256 and the interior threads 1258. These seals help to seal outside air from getting into the pod 200 so the pod 200 can remain hermetically sealed until it is ready for use in the machine 100.

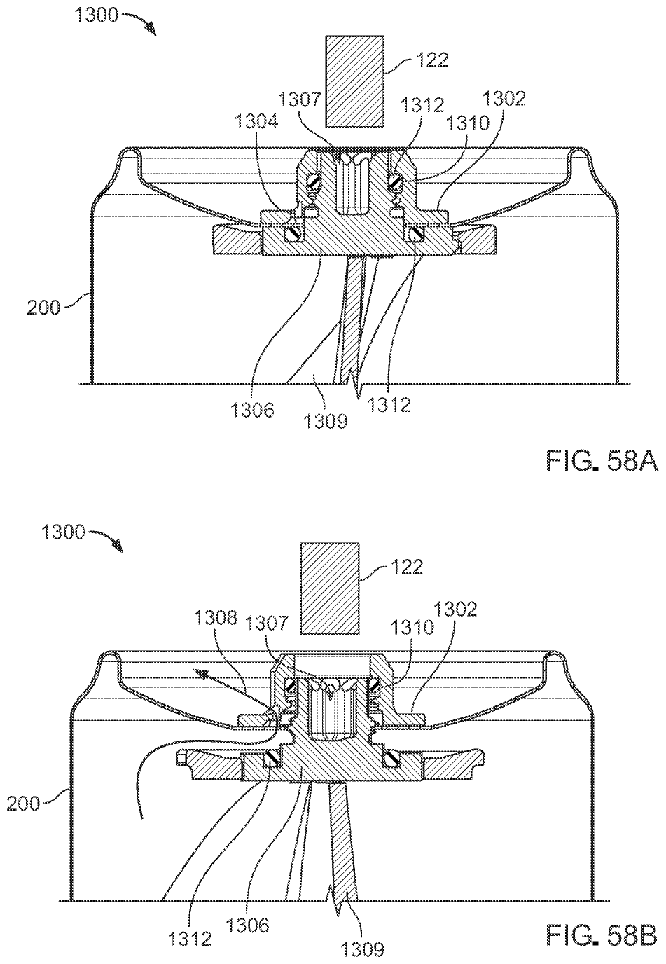

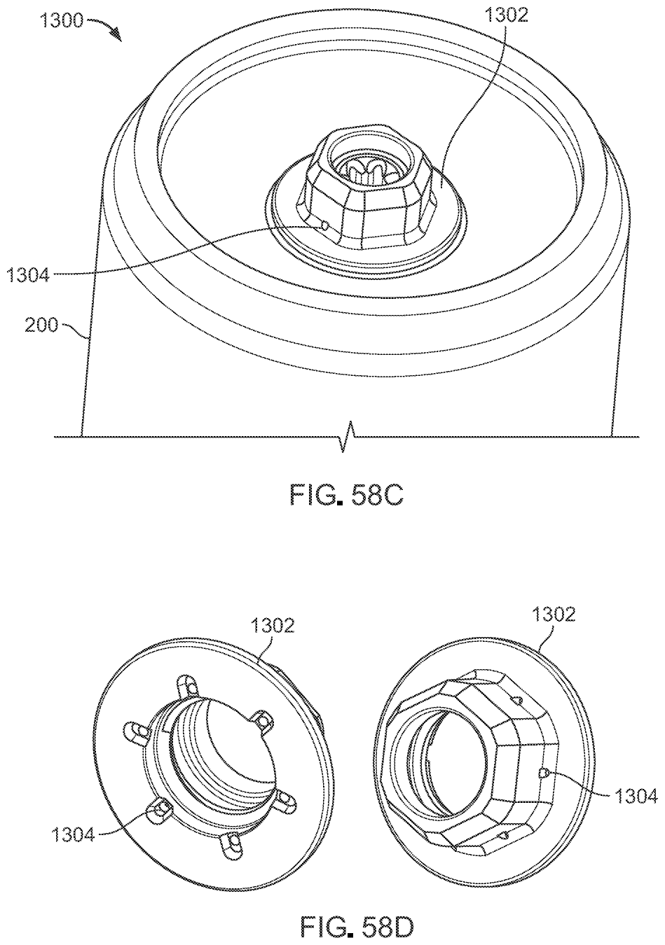

FIGS. 58A and 58B are cross-sectional views of a mating drive assembly 1300 in its closed position (FIG. 68A) and its open position (FIG. 58B). FIG. 58C is a perspective view of the mating drive assembly 1300. The mating drive assembly 1300 is substantially similar to mating drive assembly 1260 seen in FIGS. 58A-58C. However, the mating drive assembly 1300 includes additions to the functionality of seal member 1254, and additional sealing measures between the mating drive head 1252 and the seal member 1254.

A locking nut 1302 is adhered to the pod 200. The locking nut 1302 includes one or more vent holes 1304 to allow nitrogen to escape from the pod 200 when the mating drive head 1306 is unthreaded from the locking nut 1302. As the mating drive head 1252 is lowered into the pod 200, pressure of the sealed pod may cause the expulsion of nitrogen and ice cream mix between the threaded connection of mating drive head 1252 and seal member 1254, and onto the machine components. The vent holes 1304 of locking nut 1302 allow controlled release of the initial pressure along the pathway 1308 indicated in FIG. 58B, away from the drive shaft 122 of the machine 100. The locking nut 1302 has a single vent hole about the circumference. Some locking nuts have multiple vent holes (see, e.g., FIG. 58D). The locking nut may be formed using a cold heading process.

An O-ring, located in a groove 1310, is pressed between mating drive head 1306 and locking nut 1302 forming a seal. This seal complements the venting holes 1304 to help prevent nitrogen and ice-cream mix from escaping pod 200 through the threaded connection of the mating drive head 1252 and seal member 1254 to the drive shaft 122. Before the mating drive head 1252 is lowered into the position shown in FIG. 58B, an O-ring 1312 is pressed against the inside dome of the pod 200 forming a seal. This seal is complemented by the threaded connection between the exterior threads of the mating drive head 1306 and the interior threads of the locking nut 1302. These seals help to seal outside air from getting into the pod 200 so the pod 200 can remain hermetically sealed until it is ready for use in the machine 100. These seals also prevent the nitrogen from escaping (and thus maintaining pressurization) before the sealing shaft is unscrewed from the nut.

In some machines, alignment and engagement of the drive shaft 122 with the receptacle 1307 of the drive head 1306 is achieved by monitoring the axial position change of the drive shaft 122 simultaneously with the velocity of the drive motor 116 (See FIG. 5A). To accomplish this engagement, the drive shaft 122 is moved axially downward while the drive motor 116 is rotated at a low torque setting at low speed (e.g., between 1-30% of its maximum value and preferably between 5-15% of its maximum value). The machine's onboard controller (or processor) monitors velocity of the drive motor 116 until the velocity reaches zero (or stalls) for a set amount of time (e.g., for between 0.1-2.0 seconds and preferably between 0.5-1.0 seconds), indicating that the drive splines of the drive shaft 122 have engaged with the receptacle of the drive head 252. Once engagement is detected, the motors are briefly paused, and then the drive shaft 122 continues to move axially downward slowly (e.g., at 25-50% of the maximum speed) while the machine's onboard controller (or processor) monitors the change in position of the drive shaft 122 over time, until the position remains unchanged for a set amount of time (e.g., for between 0.1-2.0 seconds and preferably between 0.5-1.0 seconds), indicating that the drive shaft 122 is fully engaged with the receptacle of the drive head 1306. During this process, the drive motor is oscillated back and forth continuously (e.g., between +/−5-25% of a full rotation, or preferably between +/−5-10% of a full rotation) to ensure that the drive shaft 122 does not become improperly bound to the receptacle of the drive head 1306. In some examples, this process ensures that the drive shaft 122 seats properly into the receptacle of the drive head 1306.

After achieving full engagement of the drive shaft 122, drive motor 116 is activated to unscrew the drive head 1306 from the pod 200. The drive shaft 122 then continues to move axially downward slowly (e.g., at 25-50% of the maximum speed) while the machine's onboard controller (or processor) monitors the change in position of the drive shaft 122 over time, until the position remains unchanged for a set amount of time (e.g., for between 0.1-2.0 seconds and more preferably between 0.5-1.0 seconds), indicating that the drive shaft 122 has pushed the bottom of the mixing paddle 1309 against base 220 of pod 200 (see FIG. 55A).

In some machines, the onboard controller (or processor) determines if a pod 200 is present (or not) by monitoring for engagement of the drive shaft 122 with the receptacle 1307 of the drive head 1306. If the onboard controller (or processor) determines that the engagement has not occurred before the drive shaft 122 travels half of a pre-determined or pre-calibrated range of motion, or before a certain amount of time has elapsed (e.g., between 2-10 seconds, or preferably between 4-6 seconds) then the onboard controller (or processor) determines that there is no pod present in the machine and the mixing cycle is aborted. Some machines abort the mixing cycle if the engagement has not occurred before the drive shaft 122 travels one-quarter or one-third of a pre-determined or pre-calibrated range of motion.

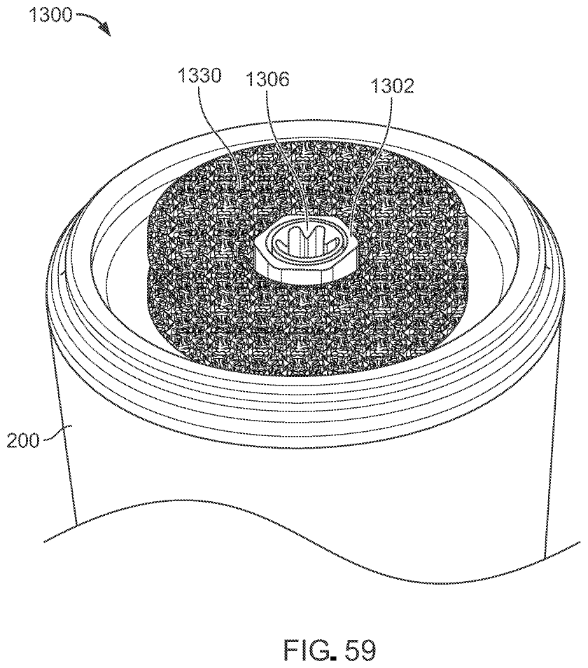

FIG. 59 shows a prototype pod 200 with the mating drive head 1252 and seal member 1254 described in FIGS. 58A-58D. The prototype pod 200 further includes a foam structure 1330 to diffuse the gas and liquid spray coming from the venting holes 1304, reducing the possibility of getting liquid onto the machine components. In some cases, the foam 1330 is placed on the outside the pod 200. In some cases, the foam is placed inside the pod 200. Some pods use other absorbent or porous materials instead of foam. Alternatively or additionally, a structure with a labyrinth pattern may be inserted to capture or reduce the ejection pressure of the gas/liquid spray and prevent it from getting onto the machine components. In some cases, the foam is a metallic foam (e.g., aluminum foam).

The electronic controller (or processor) of the machine 100 is in electronic communication with the drive motor 116, the plunger motor 124, the evaporator motor 166, and shearing motor (e.g., shearing motor 842 or shearing motor 866). The processor controls operation of each of these motors. Some machines include torque sensors that monitor the torques provided by the shafts of each of these motors. Some machines include a lid closure sensor to monitor whether the sliding lid 102 is in the closed configuration. The processor of the machine communicates with all of these sensors and motors. The processor is also electrically connected to the user interface 108. The processor is programmed to execute one or more operations of the machine 100 to produce a single serving of a cooled food or drink from a shelf-stable pod and dispense the produced food or drink in a user's bowl or cone within a few minutes (e.g., less than 2 or 3 minutes) for consumption.

A number of systems and methods have been described. Nevertheless, it will be understood that various modifications may be made without departing from the spirit and scope of this disclosure. For example, although the evaporators have been generally illustrated as being in vertical orientation during use, some machines have evaporators that are oriented horizontally or an angle to gravity during use. Accordingly, other embodiments are within the scope of the following claims.

1. A pod comprising:
a body having a sidewall that extends from a first end of the body to a second end of the body to define an interior of the pod;
ingredients disposed within the interior of the pod for producing a single serving of a cooled food or drink; and
a mixing paddle disposed within the interior of the pod and rotatable relative to the body along a longitudinal axis of the body, a cross-section of the mixing paddle taken perpendicular to a longitudinal axis of the mixing paddle having at least one curved or non-linear section.

2. The pod of claim 1, wherein the at least one curved or non-linear section defines a C-shape, an S-shape, a wavy-shape, or an undulating-shape.

3. The pod of claim 1, wherein the at least one curved or non-linear section defines a scoop-shaped section for scooping the ingredients within the pod when the mixing paddle rotates relative to the body of the pod.

4. The pod of claim 1, wherein the cross-section has a pair of concave features each spaced approximately equidistant from the longitudinal axis of the mixing paddle, the concave features being concave with respect to a rotational direction of the mixing paddle used to mix the ingredients disposed within the interior of the pod to produce the single serving of the cooled food or drink.

5. The pod of claim 4, wherein the concave features span a majority of the cross-section of the mixing paddle.

6. The pod of claim 4, wherein the cross-section has two radial end portions that are curved in an opposite direction relative to the concave features.

7. The pod of claim 6, wherein the two radial end portions contact the sidewall of the body of the pod at one or more rotational positions of the mixing paddle within the pod.

8. The pod of claim 7, wherein at least a portion of each of the two radial end portions is tangent to an inner surface of the sidewall of the pod at the one or more rotational positions of the mixing paddle within the pod.

9. The pod of claim 4, wherein a radius of the concave features is between 0.6 and 1.2 inches.

10. The pod of claim 4, wherein a radius-to-thickness ratio defined by a radius of the concave features of the mixing paddle divided by a thickness the cross-section of the mixing paddle is between 1.0 and 10.0.

11. The pod of claim 1, wherein the at least one curved or non-linear section provides an increased bending, flexural, or torsional stiffness to the mixing paddle to resist deflection of the mixing paddle as the mixing paddle rotates within the pod.

12. The pod of claim 1, wherein the mixing paddle is concentrically disposed within the interior of the pod such that the longitudinal axis of the body of the pod is coincident with the longitudinal axis of the mixing paddle.

13. A device located in a hermetically-sealed pod containing liquid food or drink ingredients, the device comprising:
a body having a longitudinal mixing paddle;
the body having a cross-section along a direction perpendicular to a longitudinal axis of the body, at least a portion of the cross-section being S-shaped;
the body having at least two windows passing through the cross-section of the body;
the body being sized and shaped such that, when the device is rotated within the pod while the pod is cooled:
(i) edges of the device scrape an inner surface of the pod to remove built-up frozen ingredients located on the inner surface of the pod;
(ii) the S-shaped portion of the body forces ingredients in an axial direction in the pod; and
(iii) the device forces frozen confection out of the pod after the pod is opened.

14. The device of claim 13, wherein the mixing paddle has a helical-shape.

15. The device of claim 14, wherein the helical-shape has a constant pitch between 40 and 60 degrees/inch.

16. The device of claim 13, wherein the edges are in contact with a sidewall of the pod for a majority of angular orientations of the device within the pod.

17. The device of claim 13, wherein the at least two windows are positioned radially along the S-shaped section of the body.

18. The device of claim 13, wherein the cross-section has a pair of concave features each spaced approximately equidistant from a longitudinal axis of the body, the concave features being concave with respect to the direction in which the device is rotated within the pod while the pod is cooled.

19. The device of claim 13, wherein the S-shaped portion of the cross-section spans a majority of the cross-section of the body.

20. The device of claim 13, wherein the cross-section provides an increased bending, flexural, or torsional stiffness to the body to resist deflection of the body as the body rotates within the pod.

21. A system comprising:
a pod comprising:
a body having a sidewall that extends from a first end of the body to a second end of the body, the body having an interior that contains ingredients for producing a single serving of a cooled food or drink; and
a mixing paddle disposed within the body and rotatable relative to the body along a longitudinal axis of the body, a cross-section of the mixing paddle taken perpendicular to a longitudinal axis of the mixing paddle having at least one curved or non-linear section; and
a machine having a recess sized to receive the pod, the machine comprising:
a refrigeration system operable to cool the ingredients within the pod when the pod is inserted into the recess of the machine; and
a mixing motor operable to rotate the mixing paddle to mix the ingredients within the pod while the ingredients are being cooled to produce the single serving of the cooled food or drink.

22. The system of claim 21, wherein the at least one curved or non-linear section defines a C-shape or an S-shape.

23. The system of claim 21, wherein the mixing paddle cross-section defines a wavy or undulating shape.

24. The system of claim 21, wherein the mixing paddle cross-section has a pair of concave features each spaced approximately equidistant from the longitudinal axis of the mixing paddle, the concave features being concave with respect to the direction in which the mixing motor rotates the mixing paddle to mix the ingredients within the interior of the pod to produce the single serving of the cooled food or drink.

25. The system of claim 24, wherein the mixing paddle cross-section has two radial end portions that are curved in an opposite direction relative to the concave features.

26. The system of claim 21, wherein the machine is operable to rotate the mixing paddle such that edges of the mixing paddle scrape an inner surface of the pod to remove built-up frozen ingredients located on the inner surface of the pod.

27. The system of claim 21, wherein the machine is operable to rotate the mixing paddle to force the ingredients in an axial direction of the pod and through at least two windows of the mixing paddle.

28. The system of claim 21, wherein the machine is operable to rotate the mixing paddle to force the produced single serving of the cooled food or drink out of the pod after the pod is opened.

29. The system of claim 21, wherein the at least one curved or non-linear section provides an increased bending, flexural, or torsional stiffness to the body to resist deflection of the mixing paddle as the mixing paddle rotates within the pod.

30. The system of claim 21, wherein the sidewall of the pod is coated with a layer of coating and the mixing paddle contacts the layer of coating as the mixing paddle is rotated within the pod.

31-81. (canceled)

82. The device of claim 13, wherein the body is sized and shaped such that, when the device is rotated within the pod while the pod is cooled, the S-shaped portion of the body forces ingredients through the at least two windows.
